(19) United States
(12) Patent Application Publication
(10) Pub. No.: US 2016/0300392 A1
(43) Pub. Date: Oct. 13, 2016

(54) SYSTEMS, MEDIA, AND METHODS FOR PROVIDING IMPROVED VIRTUAL REALITY TOURS AND ASSOCIATED ANALYTICS

(71) Applicant: VR Global, Inc., New York, NY (US)

(72) Inventors: Andrzej Jakub Jonczyk, Wroclaw (PL); Alexander Adam Gredysa, Forest Hills, NY (US); Leslaw Jozef Gredysa, Southampton, NY (US)

(21) Appl. No.: 15/094,836

(22) Filed: Apr. 8, 2016

Related U.S. Application Data
(60) Provisional application No. 62/145,941, filed on Apr. 10, 2015.

(51) Int. Cl. G06T 19/00; G06T 15/20; G06T 7/00; G06F 3/01

(52) U.S. Cl. CPC G06T 19/006; G06T 19/003; G06F 3/011; G06T 15/20; G06T 7/0061; G06F 3/013; G06T 2219/024; G06T 2207/10028

(57) ABSTRACT

Platforms, systems, media, and methods for providing virtual reality (VR) tour builder and editor applications, multi-modal VR tour applications, and VR tour analytics applications useful in real estate sales and marketing, advertising, entertainment, education, healthcare scenarios.

### CROSS-REFERENCE TO RELATED APPLICATIONS

This application claims the benefit of U.S. Patent Application No. 62/145,941, filed Apr. 10, 2015, the entire disclosure of which is hereby incorporated herein by reference.

### BACKGROUND OF THE INVENTION

Virtual reality (VR) is a computer-simulated reality that replicates a real or imagined environment. Users in VR environments are immersed in an array of multimedia stimuli, allowing the users to interact with the environment and engage in sensory experiences, including sight, touch, hearing, and smell. VR devices are becoming more popular and accessible to the general public, allowing for a wider audience to benefit from this lifelike experience.

### SUMMARY OF THE INVENTION

Virtual reality (VR) is an immersive and engaging platform for experiencing computer simulated environments. The environment venues are displayed on a computer screen or through a wearable device, such as a head-mounted display (HMD). The current standards for digital visualization of environment venues are standard 2D images and virtual walkthroughs through web browser applications and mobile applications. Some recent applications allow for the display of 3D 360-degree content through the presentation of the environment in an HMD.

Despite the interactive and engaging user experience of current VR platforms, they are limited in several aspects. First, many VR platforms are developed for a piece of specific hardware associated with that platform. This limits both user accessibility and developer accessibility, as both users and developers are limited in their abilities to explore a wide array of VR platform options. Second, VR content is memory intensive, requiring fast Internet speeds to transmit content, leading to slow load times. Third, VR content is generally observable only to the user engaging in that content, precluding others from participating or observing that experience. Finally, VR content is generally fixed and not adaptable to user preferences as the user is interacting with the environment.

The platforms, systems, media, and methods disclosed herein are hardware agonistic. This platform is a complex solution that offers users all the necessary tools to create and engage in VR tours using a HMD or similar device. The subject matter described herein includes a content management system (CMS) which provides users the graphical tools for both automatic and semi-automatic VR content creation from user-uploaded assets, which comprise 2D photographs, 3D models, 360-degree photographs, 360-degree videos, and other graphical images. The tools provide the user the ability to preview and conduct VR tours on both a web-based non-VR machine such as a personal computer or a mobile device, as well as on an HMD device. The CMS further allows the user to generate a floor plan of the VR environment and select multiple vantage points within that environment, allowing participants of the VR environment to view the environment from a plurality of vantage points. The subject matter described herein further provides algorithms for lossless compression of VR content data, allowing for enhanced VR content display performance on VR content devices. The subject matter described herein further allows for the sharing of a user's VR experience to other users, who observe the user's experience and optionally participates in that experience. During the VR experience, the subject matter described herein identifies user focus and provides for focus-driven interactions in the VR environment. Finally, the subject matter described herein uses the frequency and intensity of user interactions in the VR environment to generate a heat map that is optionally used for data analytics.

In one aspect, disclosed herein are computer-implemented systems comprising: a digital processing device comprising: at least one processor, an operating system configured to perform executable instructions, a memory, and a computer program including instructions executable by the digital processing device to create a virtual reality (VR) tour builder and editor application comprising: a software module presenting an interface allowing a user to upload a 2D floorplan and VR content items; a software module presenting an interface allowing the user to select one or more vantage points on the 2D floorplan, each vantage point having coordinates, and associate one or more VR content items with each vantage point; a software module generating a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and a software module presenting an interface allowing the user to place VR objects in the VR tour. In some embodiments, the application further comprises a software module allowing the user to curate uploaded VR content. In some embodiments, the application further comprises a software module automatically recognizing VR content. In some embodiments, the VR content comprises one or more 3D models, one or more 360 photographs, one or more 360 videos, one or more 360 (binaural) audio files, or a combination thereof. In further embodiments, the software module presenting an interface allowing a user to upload a 2D floorplan and VR content items further allows a user to upload standard content in the form of photographs, videos, sound files, text, or a combination thereof. In some embodiments, the application further comprises a software module allowing the user to preview the tour in VR and in non-VR formats. In some embodiments, the application further comprises a software module allowing the user to curate generated VR tours. In some embodiments, the application further comprises a software module allowing the user to manage users, user types, and user devices. In some embodiments, the application further comprises a software module compressing the generated VR tour by: removing left eye and right eye VR texture similarities, removing non-equi-rectangular pixels, modifying the level of detail based on distance to a vantage point, applying gradient compression based on likelihood that an area will be viewed, removing data based on likelihood that content not in angle of view, or a combination thereof. In some embodiments, the application further comprises a software module allowing the user to edit hotspots, wherein the editing comprises moving, ordering, adding, and removing hotspots. In some embodiments, the software module allowing the user to place VR objects allows the user to configure properties of the placed VR objects. In some embodiments, the software module allowing the user to place VR objects allows the user to configure actions triggered by user interactions with the placed VR objects. In some embodiments, the software module presenting an interface allowing the user to place VR objects in the VR tour allows placement of: one or more standard photographs, one or more standard videos, one or more standard sound files, text, one or more 3D models, one or more 360 photographs, one or more 360 videos, one or more 360 (binaural) audio files, or a combination thereof, as a VR object in the VR tour. In some embodiments, the generated VR tour is optimized for delivery on a head mounted display (HMD). In some embodiments, the VR tour and the VR content are for real estate sales and marketing, advertising, entertainment, education, healthcare, or a combination thereof. In some embodiments, the application is implemented as a software-as-a-service (SaaS). In some embodiments, the application is implemented as a mobile application. In some embodiments, the application is implemented as a desktop or laptop application.

In another aspect, disclosed herein are non-transitory computer-readable storage media encoded with a computer program including instructions executable by a processor to create a virtual reality (VR) tour builder and editor application comprising: a software module presenting an interface allowing a user to upload a 2D floorplan and VR content items; a software module presenting an interface allowing the user to select one or more vantage points on the 2D floorplan, each vantage point having coordinates, and associate one or more VR content items with each vantage point; a software module generating a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and a software module presenting an interface allowing the user to place VR objects in the VR tour.

In another aspect, disclosed herein are computer-implemented methods of providing a virtual reality (VR) tour builder and editor application comprising: providing, by a computer, an interface allowing a user to upload a 2D floorplan and VR content items; providing, by the computer, an interface allowing the user to select one or more vantage points on the 2D floorplan, each vantage point having coordinates, and associate one or more VR content items with each vantage point; generating, by the computer, a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and providing, by the computer, an interface allowing the user to place VR objects in the VR tour.

In another aspect, disclosed herein are computer-implemented systems comprising: a digital processing device comprising: at least one processor, an operating system configured to perform executable instructions, a memory, and a computer program including instructions executable by the digital processing device to create a multi-modal virtual reality (VR) tour application comprising: a software module pre-loading the same VR tour onto: i) an external device for use by an administrative user and ii) a head mounted display (HMD)-enabled device for use by an end user; a software module generating a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and a software module generating a low latency remote control mode for viewing the VR tour, wherein the external device view of the VR tour is displayed on the HMD by transmitting positional information describing the position of the external device in three-dimensional space and tour state information to the HMD and updating the HMD based on the positional information. In some embodiments, in the low latency multiviewer mode, only the positional information and tour state information is transmitted, without transmitting VR tour content. In some embodiments, in the low latency multiviewer mode, the positional information describes the position of the HMD in x-, y-, and z-axes. In some embodiments, in the low latency remote control mode, only the positional information and tour state information is transmitted, without transmitting VR tour content. In some embodiments, in the low latency remote control mode, the positional information describes the position of the external device in x-, y-, and z-axes. In some embodiments, the same VR tour is pre-loaded onto a plurality of head mounted display (HMD)-enabled devices for use by a plurality of simultaneously connected end users and wherein, in the low latency remote control mode, the plurality of HMDs are updated based on the positional information describing the position of the external device. In further embodiments, the plurality of head mounted display (HMD)-enabled devices comprises 2, 3, 4, 5, 10, 20, 30, or more simultaneously connected end user devices. In some embodiments, the application further comprises a software module allowing the administrative user to place virtual markers in the VR tour, which are transmitted to the HMD and displayed on the HMD. In some embodiments, the application further comprises a software module allowing synchronous voice communication between the administrative user and the end user. In some embodiments, the application further comprises a software module allowing synchronous text-chat communication between the administrative user and the end user. In some embodiments, the application further comprises a software module allowing capture of still photographs based on the VR tour and the positional information. In some embodiments, the application further comprises a software module tracking, in the low latency multiviewer mode, end user behavior information. In further embodiments, the end user behavior information comprises navigation within the VR tour, interaction with a VR object within the VR tour, prolonged view focus on a particular portion of the VR tour or a particular VR object, repeated view focus on a particular portion of the VR tour or a particular VR object, or a combination thereof.

In another aspect, disclosed herein are non-transitory computer-readable storage media encoded with a computer program including instructions executable by a processor to create a multi-modal virtual reality (VR) tour application comprising: a software module pre-loading the same VR tour onto: i) an external device for use by an administrative user and ii) a head mounted display (HMD)-enabled device for use by an end user; a software module generating a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and a software module generating a low latency remote control mode for viewing the VR tour, wherein the external device view of the VR tour is displayed on the HMD by transmitting positional information describing the position of the external device in three-dimensional space and tour state information to the HMD and updating the HMD based on the positional information.

In another aspect, disclosed herein are computer-implemented methods of providing a multi-modal virtual reality (VR) tour application comprising: pre-loading, by a computer, the same VR tour onto: i) an external device for use by an administrative user and ii) a head mounted display (HMD)-enabled device for use by an end user; providing, by the computer, a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and providing, by the computer, a low latency remote control mode for viewing the VR tour, wherein the external device view of the VR tour is displayed on the HMD by transmitting positional information describing the position of the external device in three-dimensional space and tour state information to the HMD and updating the HMD based on the positional information.

In another aspect, disclosed herein are computer-implemented systems comprising: a digital processing device comprising: at least one processor, an operating system configured to perform executable instructions, a memory, and a computer program including instructions executable by the digital processing device to create a virtual reality (VR) tour analytics application comprising: a software module determining a head mounted display (HMD) of an end user used to view the VR tour and determining a viewport for the HMD; a software module tracking and storing timestamped tour state data during a VR tour, the tour state data comprising user vantage point; a software module tracking and storing timestamped user view data during a VR tour, the user view data comprising HMD viewing angles; a software module applying weighting to the user view data based on distance to the center of the viewport of the HMD; and a software module tracking and storing timestamped user interaction data during a VR tour, the user interaction data comprising a VR object and a type of interaction. In some embodiments, the application further comprises a software module determining changes to the tour state and the user view based on the timestamped tour state data and the timestamped user view data respectively. In some embodiments, the application further comprises a software module cumulating the user view data over a time interval to create a heat map of user view focus, which is displayed as an overlay on the content of the VR tour. In some embodiments, the application further comprises a software module correlating the user view data with VR objects in the VR tour. In some embodiments, the application further comprises a software module activating user focus-based interactions when a length of focus exceeds a pre-determined threshold or a focus repeats a number of times in excess of a pre-determined threshold. In some embodiments, the tour state data and the user view data are stored locally at a device associated with the HMD and transmitted to the application at the conclusion of a VR tour. In some embodiments, the tour state data and the user view data are transmitted to the application substantially in real-time.

In another aspect, disclosed herein are non-transitory computer-readable storage media encoded with a computer program including instructions executable by a processor to create a virtual reality (VR) tour analytics application comprising: a software module determining a head mounted display (HMD) of an end user used to view the VR tour and determining a viewport for the HMD; a software module tracking and storing timestamped tour state data during a VR tour, the tour state data comprising user vantage point; a software module tracking and storing timestamped user view data during a VR tour, the user view data comprising HMD viewing angles; a software module applying weighting to the user view data based on distance to the center of the viewport of the HMD; and a software module tracking and storing timestamped user interaction data during a VR tour, the user interaction data comprising a VR object and a type of interaction.

In another aspect, disclosed herein are computer-implemented methods of providing a virtual reality (VR) tour analytics application comprising: determining, by a computer, a head mounted display (HMD) of an end user used to view the VR tour and determining a viewport for the HMD; tracking and storing, by the computer, timestamped tour state data during a VR tour, the tour state data comprising user vantage point; tracking and storing, by the computer, timestamped user view data during a VR tour, the user view data comprising HMD viewing angles; applying, by the computer, weighting to the user view data based on distance to the center of the viewport of the HMD; and tracking and storing, by the computer, timestamped user interaction data during a VR tour, the user interaction data comprising a VR object and a type of interaction.

### BRIEF DESCRIPTION OF THE DRAWINGS

FIG. 1 shows a non-limiting example of a system, media, method, and platform for an improved virtual reality tour and associated analytics; in this case, an embodiment of processes for creating, editing, and navigating VR tours.

FIG. 2 shows a non-limiting example of a user interface for an improved virtual reality tour and associated analytics; in this case, a user interface for editing and assigning uploaded content to a VR tour.

FIG. 3 shows a non-limiting example of a user interface for an improved virtual reality tour and associated analytics; in this case, a floor plan of a VR tour property with specific vantage points.

FIG. 4 shows a non-limiting example of a system, media, method, and platform for an improved virtual reality tour and associated analytics; in this case, a schema for automatic processing of VR assets.

FIG. 5 shows a non-limiting example of a system, media, method, and platform for an improved virtual reality tour and associated analytics; in this case, a flow chart for automatic processing of VR assets.

FIG. 6 shows a non-limiting example of a system, media, method, and platform for an improved virtual reality tour and associated analytics; in this case, a schema for assigning assets to VR tour content and to floor plans, configured to further assign the coordinates of vantage points.

FIG. 7A shows a non-limiting example of a system, media, method, and platform for an improved virtual reality tour and associated analytics; in this case, a flow chart for assigning vantage points to assets.

FIG. 7B shows a non-limiting example of a system, media, method, and platform for an improved virtual reality tour and associated analytics; in this case, a flow chart for assigning vantage points to assets.

FIG. 8 shows a non-limiting example of a system, media, method, and platform for an improved virtual reality tour and associated analytics; in this case, a schema for automatic creation of a VR tour by finding connections between assets.

FIG. 9 shows a non-limiting example of a system, media, method, and platform for an improved virtual reality tour and associated analytics; in this case, a flow chart for automatic creation of a VR tour by finding connections between assets.

FIG. 10A shows a non-limiting example of a system, media, method, and platform for an improved virtual reality tour and associated analytics; in this case, a schema for creating a VR tour using an HMD device by placing hotspots.

FIG. 10B shows a non-limiting example of a system, media, method, and platform for an improved virtual reality tour and associated analytics; in this case, a schema for creating a VR tour using an HMD device by moving hotspots on a view sphere.

FIG. 11 shows a non-limiting example of a system, media, method, and platform for an improved virtual reality tour and associated analytics; in this case, a schema for creating a VR tour using an HMD device by moving hotspots in 3D.

FIG. 12 shows a non-limiting example of a system, media, method, and platform for an improved virtual reality tour and associated analytics; in this case, a flow chart for creating a VR tour using an HMD device.

FIG. 13 shows a non-limiting example of a system, media, method, and platform for an improved virtual reality tour and associated analytics; in this case, a method for storing VR objects.

FIG. 14 shows a non-limiting example of a system, media, method, and platform for an improved virtual reality tour and associated analytics; in this case, a schema for recognizing VR objects in 3D pictures and videos by analyzing the contours, distance, and colors for marketing and interaction.

FIG. 15 shows a non-limiting example of a system, media, method, and platform for an improved virtual reality tour and associated analytics; in this case, a flow chart for recognizing VR objects in 3D pictures.

FIG. 16 shows a non-limiting example of a system, media, method, and platform for an improved virtual reality tour and associated analytics; in this case, a schema for lossless compression of VR content by detecting and removing the left eye and right eye viewport similarities.

FIG. 17 shows a non-limiting example of a system, media, method, and platform for an improved virtual reality tour and associated analytics; in this case, a flow chart for lossless compression of VR content by detecting and removing left eye and right eye viewport similarities.

FIG. 18 shows a non-limiting example of a system, media, method, and platform for an improved virtual reality tour and associated analytics; in this case, a schema for lossless compression of VR content by removing non-equirectangular pixels.

FIG. 19 shows a non-limiting example of a system, media, method, and platform for an improved virtual reality tour and associated analytics; in this case, a flow chart for lossless compression of VR content by removing non-equirectangular pixels.

FIG. 20 shows a non-limiting example of a system, media, method, and platform for an improved virtual reality tour and associated analytics; in this case, a schema for compression of VR assets by adjusting image detail and quality based on distance and depth.

FIG. 21 shows a non-limiting example of a system, media, method, and platform for an improved virtual reality tour and associated analytics; in this case, a flow chart for compression of VR assets by adjusting image detail and quality based on distance and depth.

FIG. 22 shows a non-limiting example of a system, media, method, and platform for an improved virtual reality tour and associated analytics; in this case, a schema for compression of VR assets by applying gradient compression.

FIG. 23 shows a non-limiting example of a system, media, method, and platform for an improved virtual reality tour and associated analytics; in this case, a flow chart for compression of VR assets by applying gradient compression.

FIG. 24 shows a non-limiting example of a system, media, method, and platform for an improved virtual reality tour and associated analytics; in this case, a schema for optimizing VR content streaming by compressing the data and removing the data behind the angle of view.

FIG. 25 shows a non-limiting example of a system, media, method, and platform for an improved virtual reality tour and associated analytics; in this case, a flow chart for optimizing VR content streaming by compressing the data and removing the data behind the angle of view.

FIG. 26 shows a non-limiting example of a system, media, method, and platform for an improved virtual reality tour and associated analytics; in this case, a schema for saving a VR scene as observed through an HMD b storing the HMD device angle and extracting the flat image data.

FIG. 27 shows a non-limiting example of a system, media, method, and platform for an improved virtual reality tour and associated analytics; in this case, a flow chart for saving a VR scene as observed through an HMD b storing the HMD device angle and extracting the flat image data.

FIG. 28 shows a non-limiting example of a system, media, method, and platform for an improved virtual reality tour and associated analytics; in this case, a schema for creating a depth map from 3D pictures and videos.

FIG. 29 shows a non-limiting example of a system, media, method, and platform for an improved virtual reality tour and associated analytics; in this case, a flow chart for creating a depth map from 3D pictures and videos.

FIG. 30 shows a non-limiting example of a system, media, method, and platform for an improved virtual reality tour and associated analytics; in this case, a schema for creating a heat map by analyzing the center of a viewport as the most focused point.

FIG. 31 shows a non-limiting example of a system, media, method, and platform for an improved virtual reality tour and associated analytics; in this case, a schema for creating a heat map by analyzing the center of a viewport as the most focused point overlaid onto VR content.

FIG. 32 shows a non-limiting example of a system, media, method, and platform for an improved virtual reality tour and associated analytics; in this case, a schema for a data log containing heat map data information.

FIG. 33 shows a non-limiting example of a system, media, method, and platform for an improved virtual reality tour and associated analytics; in this case, a flow chart for capturing viewport data for creating a heat map.

FIG. 34A shows a non-limiting example of a system, media, method, and platform for an improved virtual reality tour and associated analytics; in this case, a flow chart for curating viewport data for creating a heat map.

FIG. 34B shows a non-limiting example of a system, media, method, and platform for an improved virtual reality tour and associated analytics; in this case, a flow chart for curating viewport data for creating a heat map.

FIG. 35 shows a non-limiting example of a user interface for an improved virtual reality tour and associated analytics; in this case, a home screen of the mobile application configured to display a top bar region and a main view region.

FIG. 36 shows a non-limiting example of a user interface for an improved virtual reality tour and associated analytics; in this case, a home screen of the application configured to allow the user to login to the service and select various modes in the top bar.

FIG. 37 shows a non-limiting example of a user interface for an improved virtual reality tour and associated analytics; in this case, a login screen configured to allow the user to login to the service with a login username and password.

FIG. 38 shows a non-limiting example of a user interface for an improved virtual reality tour and associated analytics; in this case, a home screen after a user is logged in, configured to display the user's information and device ID in the top bar region, allowing the user to change the mode of the mobile application.

FIG. 39 shows a non-limiting example of a user interface for an improved virtual reality tour and associated analytics; in this case, a mode selection screen configured to allow the user to switch between presentation mode, edit mode, and remote mode.

FIG. 40 shows a non-limiting example of a user interface for an improved virtual reality tour and associated analytics; in this case, a user interface screen configured to allow the user to log out from the mobile application.

FIG. 41 shows a non-limiting example of a user interface for an improved virtual reality tour and associated analytics; in this case, a user interface screen after a user is logged in, configured to allow a user to filter, sort and add VR tour listings in the main view region.

FIG. 42 shows a non-limiting example of a user interface for an improved virtual reality tour and associated analytics; in this case, a VR tour listing screen configured to display more information about a selected listing.

FIG. 43 shows a non-limiting example of a user interface for an improved virtual reality tour and associated analytics; in this case, a VR tour listing screen configured to display the VR tour queue after a user adds a listing.

FIG. 44 shows a non-limiting example of a user interface for an improved virtual reality tour and associated analytics; in this case, an edit mode screen configured to allow a user to edit VR tour listings.

FIG. 45 shows a non-limiting example of a user interface for an improved virtual reality tour and associated analytics; in this case, a remote mode screen configured to allow the user to connect to another device by entering a device ID.

FIG. 46 shows a non-limiting example of a user interface for an improved virtual reality tour and associated analytics; in this case, a remote mode screen configured to confirm that a connection with another device has been established.

FIG. 47 shows a non-limiting example of a user interface for an improved virtual reality tour and associated analytics; in this case, a remote mode screen configured to allow the user to start a VR tour remotely with a connected user or users.

FIG. 48 shows a non-limiting example of a user interface for an improved virtual reality tour and associated analytics; in this case, a remote mode screen configured to display the HMD view in the main view region and configured to allow the user to navigate between the HMD view and the floor plan view.

FIG. 49 shows a non-limiting example of a user interface for an improved virtual reality tour and associated analytics; in this case, a remote mode screen configured to display the floor plan view in the main view area and further allowing the user to select specific vantage points within the floor plan.

FIG. 50 shows a non-limiting example of a system, media, method, and platform for an improved virtual reality tour and associated analytics; in this case, a flow chart for logging into the mobile application.

FIG. 51 shows a non-limiting example of a system, media, method, and platform for an improved virtual reality tour and associated analytics; in this case, a flow chart for selecting the top bar region options in the mobile application.

FIG. 52 shows a non-limiting example of a system, media, method, and platform for an improved virtual reality tour and associated analytics; in this case, a flow chart for changing modes in the mobile application.

FIG. 53 shows a non-limiting example of a system, media, method, and platform for an improved virtual reality tour and associated analytics; in this case, a flow chart for presentation mode options in the mobile application.

FIG. 54 shows a non-limiting example of a system, media, method, and platform for an improved virtual reality tour and associated analytics; in this case, a flow chart for edit mode options in the mobile application.

FIG. 55A shows a non-limiting example of a system, media, method, and platform for an improved virtual reality tour and associated analytics; in this case, a flow chart for remote mode options in the mobile application.

FIG. 55B shows a non-limiting example of a system, media, method, and platform for an improved virtual reality tour and associated analytics; in this case, a flow chart for remote mode options in the mobile application.

FIG. 56 shows a non-limiting example of a system, media, method, and platform for an improved virtual reality tour and associated analytics; in this case, a flow chart for remote mode VR control options in the mobile application.

FIG. 57 shows a non-limiting example of a system, media, method, and platform for an improved virtual reality tour and associated analytics; in this case, a schema for sending VR session data from an HMD VR tour through the Internet or peer-to-peer.

FIG. 58 shows a non-limiting example of a system, media, method, and platform for an improved virtual reality tour and associated analytics; in this case, a flow chart for sending VR session data from an HMD VR tour through the Internet or through peer-to-peer.

FIG. 59 shows a non-limiting example of a system, media, method, and platform for an improved virtual reality tour and associated analytics; in this case, a schema for sending user input commands to control the VR tour through the Internet or through peer-to-peer.

FIG. 60 shows a non-limiting example of a system, media, method, and platform for an improved virtual reality tour and associated analytics; in this case, a flow chart for sending user input commands to control the VR tour through the Internet or through peer-to-peer.

FIG. 61 shows a non-limiting example of a system, media, method, and platform for an improved virtual reality tour and associated analytics; in this case, a schema for controlling the voice source in a VR tour from an external device.

FIG. 62 shows a non-limiting example of a system, media, method, and platform for an improved virtual reality tour and associated analytics; in this case, a flow chart for controlling the voice source in a VR tour from an external device.

FIG. 63 shows a non-limiting example of a system, media, method, and platform for an improved virtual reality tour and associated analytics; in this case, a schema for using markers to attract attention to a certain area on HMD displayed VR content.

FIG. 64 shows a non-limiting example of a system, media, method, and platform for an improved virtual reality tour and associated analytics; in this case, a flow chart for using markers to attract attention to a certain area on HMD displayed VR content.

FIG. 65 shows a non-limiting example of a system, media, method, and platform for an improved virtual reality tour and associated analytics; in this case, a schema for left and right view spheres for displaying VR content on an HMD.

FIG. 66 shows a non-limiting example of a system, media, method, and platform for an improved virtual reality tour and associated analytics; in this case, a schema depicting left and right view sphere distance for displaying VR content on an HMD.

FIG. 67 shows a non-limiting example of a system, media, method, and platform for an improved virtual reality tour and associated analytics; in this case, a schema for left and right view spheres mapped to left and right views in an HMD for displaying VR content.

FIG. 68 shows a non-limiting example of a system, media, method, and platform for an improved virtual reality tour and associated analytics; in this case, a schema for display containing 2D floor plan content in a VR tour through an HMD.

FIG. 69A shows a non-limiting example of a system, media, method, and platform for an improved virtual reality tour and associated analytics; in this case, a flow chart for selecting vantage points from a 2D floor plan within a 3D VR tour HMD display.

FIG. 69B shows a non-limiting example of a system, media, method, and platform for an improved virtual reality tour and associated analytics; in this case, a flow chart for selecting vantage points from a 2D floor plan within a 3D VR tour HMD display.

FIG. 70 shows a non-limiting example of a system, media, method, and platform for an improved virtual reality tour and associated analytics; in this case, a schema for VR tour navigation via interaction with hotspots.

FIG. 71 shows a non-limiting example of a system, media, method, and platform for an improved virtual reality tour and associated analytics; in this case, a flow chart for VR tour navigation via interaction with hotspots.

FIG. 72 shows a non-limiting example of a system, media, method, and platform for an improved virtual reality tour and associated analytics; in this case, a schema for displaying advertisements in a VR tour based on user focus-based interactions or on a pre-determined threshold of focus repeats.

FIG. 73 shows a non-limiting example of a system, media, method, and platform for an improved virtual reality tour and associated analytics; in this case, a flow chart for displaying advertisements in a VR tour based on user focus-based interactions or on a pre-determined threshold of focus repeats.

FIG. 74 shows a non-limiting example of a system, media, method, and platform for an improved virtual reality tour and associated analytics; in this case, a schema for interacting with VR objects by analyzing cumulative focus time.

FIG. 75 shows a non-limiting example of a system, media, method, and platform for an improved virtual reality tour and associated analytics; in this case, a flow chart for interacting with VR objects by analyzing cumulative focus time.

FIG. 76 shows a non-limiting example of a system, media, method, and platform for an improved virtual reality tour and associated analytics; in this case, a schema for transforming web-based content to spherical left eye and right eye views in an HMD.

FIG. 77 shows a non-limiting example of a system, media, method, and platform for an improved virtual reality tour and associated analytics; in this case, a flow chart for transforming web-based content to spherical left eye and right eye views in an HMD.

### DETAILED DESCRIPTION OF THE INVENTION

Described herein, in certain embodiments, are computer-implemented systems comprising: a digital processing device comprising: at least one processor, an operating system configured to perform executable instructions, a memory, and a computer program including instructions executable by the digital processing device to create a virtual reality (VR) tour builder and editor application comprising: a software module presenting an interface allowing a user to upload a 2D floorplan and VR content items; a software module presenting an interface allowing the user to select one or more vantage points on the 2D floorplan, each vantage point having coordinates, and associate one or more VR content items with each vantage point; a software module generating a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and a software module presenting an interface allowing the user to place VR objects in the VR tour.

Also described herein, in certain embodiments, are non-transitory computer-readable storage media encoded with a computer program including instructions executable by a processor to create a virtual reality (VR) tour builder and editor application comprising: a software module presenting an interface allowing a user to upload a 2D floorplan and VR content items; a software module presenting an interface allowing the user to select one or more vantage points on the 2D floorplan, each vantage point having coordinates, and associate one or more VR content items with each vantage point; a software module generating a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and a software module presenting an interface allowing the user to place VR objects in the VR tour.

Also described herein, in certain embodiments, are computer-implemented methods of providing a virtual reality (VR) tour builder and editor application comprising: providing, by a computer, an interface allowing a user to upload a 2D floorplan and VR content items; providing, by the computer, an interface allowing the user to select one or more vantage points on the 2D floorplan, each vantage point having coordinates, and associate one or more VR content items with each vantage point; generating, by the computer, a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and providing, by the computer, an interface allowing the user to place VR objects in the VR tour.

Also described herein, in certain embodiments, are computer-implemented systems comprising: a digital processing device comprising: at least one processor, an operating system configured to perform executable instructions, a memory, and a computer program including instructions executable by the digital processing device to create a multi-modal virtual reality (VR) tour application comprising: a software module pre-loading the same VR tour onto: i) an external device for use by an administrative user and ii) a head mounted display (HMD)-enabled device for use by an end user; a software module generating a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and a software module generating a low latency remote control mode for viewing the VR tour, wherein the external device view of the VR tour is displayed on the HMD by transmitting positional information describing the position of the external device in three-dimensional space and tour state information to the HMD and updating the HMD based on the positional information.

Also described herein, in certain embodiments, are non-transitory computer-readable storage media encoded with a computer program including instructions executable by a processor to create a multi-modal virtual reality (VR) tour application comprising: a software module pre-loading the same VR tour onto: i) an external device for use by an administrative user and ii) a head mounted display (HMD)-enabled device for use by an end user; a software module generating a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and a software module generating a low latency remote control mode for viewing the VR tour, wherein the external device view of the VR tour is displayed on the HMD by transmitting positional information describing the position of the external device in three-dimensional space and tour state information to the HMD and updating the HMD based on the positional information.

Also described herein, in certain embodiments, are computer-implemented methods of providing a multi-modal virtual reality (VR) tour application comprising: pre-loading, by a computer, the same VR tour onto: i) an external device for use by an administrative user and ii) a head mounted display (HMD)-enabled device for use by an end user; providing, by the computer, a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and providing, by the computer, a low latency remote control mode for viewing the VR tour, wherein the external device view of the VR tour is displayed on the HMD by transmitting positional information describing the position of the external device in three-dimensional space and tour state information to the HMD and updating the HMD based on the positional information.

Also described herein, in certain embodiments, are computer-implemented systems comprising: a digital processing device comprising: at least one processor, an operating system configured to perform executable instructions, a memory, and a computer program including instructions executable by the digital processing device to create a virtual reality (VR) tour analytics application comprising: a software module determining a head mounted display (HMD) of an end user used to view the VR tour and determining a viewport for the HMD; a software module tracking and storing timestamped tour state data during a VR tour, the tour state data comprising user vantage point; a software module tracking and storing timestamped user view data during a VR tour, the user view data comprising HMD viewing angles; a software module applying weighting to the user view data based on distance to the center of the viewport of the HMD; and a software module tracking and storing timestamped user interaction data during a VR tour, the user interaction data comprising a VR object and a type of interaction.

Also described herein, in certain embodiments, are non-transitory computer-readable storage media encoded with a computer program including instructions executable by a processor to create a virtual reality (VR) tour analytics application comprising: a software module determining a head mounted display (HMD) of an end user used to view the VR tour and determining a viewport for the HMD; a software module tracking and storing timestamped tour state data during a VR tour, the tour state data comprising user vantage point; a software module tracking and storing timestamped user view data during a VR tour, the user view data comprising HMD viewing angles; a software module applying weighting to the user view data based on distance to the center of the viewport of the HMD; and a software module tracking and storing timestamped user interaction data during a VR tour, the user interaction data comprising a VR object and a type of interaction.

Also described herein, in certain embodiments, are computer-implemented methods of providing a virtual reality (VR) tour analytics application comprising: determining, by a computer, a head mounted display (HMD) of an end user used to view the VR tour and determining a viewport for the HMD; tracking and storing, by the computer, timestamped tour state data during a VR tour, the tour state data comprising user vantage point; tracking and storing, by the computer, timestamped user view data during a VR tour, the user view data comprising HMD viewing angles; applying, by the computer, weighting to the user view data based on distance to the center of the viewport of the HMD; and tracking and storing, by the computer, timestamped user interaction data during a VR tour, the user interaction data comprising a VR object and a type of interaction.

### Compatible Head-Mounted Displays (HMDs)

Described herein are platforms, systems, media, and methods for creating, displaying, and navigating virtual reality (VR) environments with a head-mounted display (HMD). In some embodiments, the HMD is worn on the head of a user. In some embodiments, the HMD is an eyeglass or a visor. In other embodiments, the HMD is attached to the helmet of a user. In further embodiments, the HMD comprises one or more lens displays. In even further embodiments, the lens displays on the HMD comprise cathode ray tube displays, liquid crystal displays, liquid crystal on silicon displays, or organic light-emitting diode displays. In still further embodiments, HMDs comprise see-through techniques comprising diffractive waveguide, holographic waveguide, polarized waveguide, reflective waveguide, Clear-Vu reflective waveguide, and switchable waveguide. Commercially available HMD manufacturers and brands include, by way of non-limiting examples, Avegant, Atari® Jaguar VR, Canon® VR, Carl Zeiss® VR One, Daqri Smart Helmet, eMagin EMAN, Epson®, HTC® Vive, ImmersiONVRelia, Kaiser Electro-Optics, Kopin Corporation Golden-i, LASTER Technologies, Liquid Image, Magic Leap, Merge VR, Microsoft® Hololens, MicroOptical, Motorola®, MyVu, Nintendo® Virtual Boy, novero, Oculus® VR, Olympus®, Recon Instruments, Rockwell Collins® Optronics, Samsung® Gear VR, SEGA® Sega VR, Sensics, Sony® PlayStation VR, Takara Dynovisor, TDVision, VictorMaxx CyberMaxx, VPL Research, VRVana, and Vuzix. Commercially available optical HMD manufacturers and brands include, by way of non-limiting examples, Google® Glass, Sony® Glasstron, Olympus® Optical PC Eye-Trek, IBM®, Nokia®, Mirage Innovations, DigiLens, SBG Labs VIRTUALITY HMEyetrack, Lumus, MicroVision Nomad, Penny C Wear, Brother Industries, Konica Minolta®, Optinvent, Optical Research Associates, Augmented Vision, Vuzix, Atheer Labs, Meta, GlassUp, Laster Technologies, Innovega, Fraunhofer COMEDD, The Technology Partnership, Telepathy, Oculon Optoelectronics, Fujitsu, Baidu®, Microsoft®, LAFORGE Optical, Toshiba Glass, Ashkelon Eyeware Technologies, BAE Systems, Silicon Micro Display, Shimadzu, TDK, ODALab, Virtual Vision Inc., eMagin, nVision Industries, NVIS, Liteye Systems, Trivisio, O Display Systems, and Cinoptics.

In still further embodiments, the HMD comprises a head mount and a display device. In some embodiments, the display device is a smartphone. In other embodiments, the display device is a tablet. In a particular embodiment, the head mount is Google® Cardboard. Commercially available display devices compatible with Google® Cardboard include, by way of non-limiting examples, Amazon® Fire, HTC® One, Apple® iPhone 6, Google® Nexus 5, Motorola® Moto X, Samsung® Galaxy S6, Samsung® Galaxy Tab, and Sony® Tablet S. One of ordinary skill in the art to which this invention belongs would recognize that any device comprising a high resolution display screen and equipped with a gyroscope and accelerometer as a means of navigation is capable of being used as an HMD.

### Exemplary Fields of Use

Described herein are platforms, systems, media, and methods for creating, displaying, and navigating virtual reality (VR) environments across multiple fields of use. In some embodiments, the field of use is within a specific industry. By way of non-limiting examples, industries include real estate, retail, entertainment, education, healthcare, and military. In a particular embodiment, the VR system is used for a real estate agent to give a remote virtual tour of a property to potential homebuyers. In a particular embodiment, the VR system is used by a shopper to enter a virtual store to purchase clothing. In a particular embodiment, the VR system is used in a video game to allow for multiple users to observe and interact in a unified VR gaming environment. In a particular embodiment, the VR system is used by a teacher to transmit a VR presentation to a 360-degree videoconference to students so that the students follow the teacher's lead. In a particular embodiment, the VR system is used by a therapist to produce or provide physical therapy simulations. In a particular embodiment, the VR system is used by a squad of soldiers to engage and interact in a VR combat training mission. In other embodiments, the field of use is advertising and marketing. In a particular embodiment, a user in a VR environment focuses on a billboard, which rotates through multiple advertisements generated by user-indicated preferences or by user focused interactivity in the environment. In a particular embodiment, a user attending a VR tour of a real estate property focuses multiple times and for a long period each time on a specific couch in the property, after which the user is given the opportunity to purchase that specific type of couch or a substantially similar couch.

### Augmented Reality (AR) and Mixed Reality

Described herein are platforms, systems, media, and methods for creating, displaying, and navigating virtual reality (VR) environments in conjunction with physical real-world environments and objects to create an augmented reality (AR). In some embodiments, the platforms, systems, media, and methods described by the invention disclosed herein are suitable for implementation in AR. In other embodiments, the platforms, systems, media, and methods described by the invention disclosed herein are suitable for joint implementation in VR and AR to create a mixed reality. To implement the invention disclosed herein to an AR platform, system, media, and method, an AR-compatible device or AR-compatible HMD is required. In some embodiments, an AR-compatible device comprises a see-through lens. In other embodiments, AR is configured such that a user interacts with and manipulates real world objects.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Virtual Reality (VR)

In some embodiments, the platforms, systems, media, and methods described herein include virtual reality (VR), or use of the same. In some embodiments, VR is an immersive multimedia computer-simulated reality. In other embodiments, a computer system is configured to replicate a real, imagined, or real and imagined environment. In further embodiments, VR is experienced through a display. In even further embodiments, VR is displayed through a device screen or through a head-mounted display (HMD). In still further embodiments, VR devices are connected through a server or a direct peer-to-peer connection. In still further embodiments, VR devices are an external sensor device configured to provide sensory feedback. Many suitable implementations of external sensor devices are contemplated, including, but not limited to, a keyboard, a mouse, a controller, a glove, a game pad device, or a game accessory device. In some embodiments, VR is applied as an overlay to the real-world environment to create augmented reality (AR).

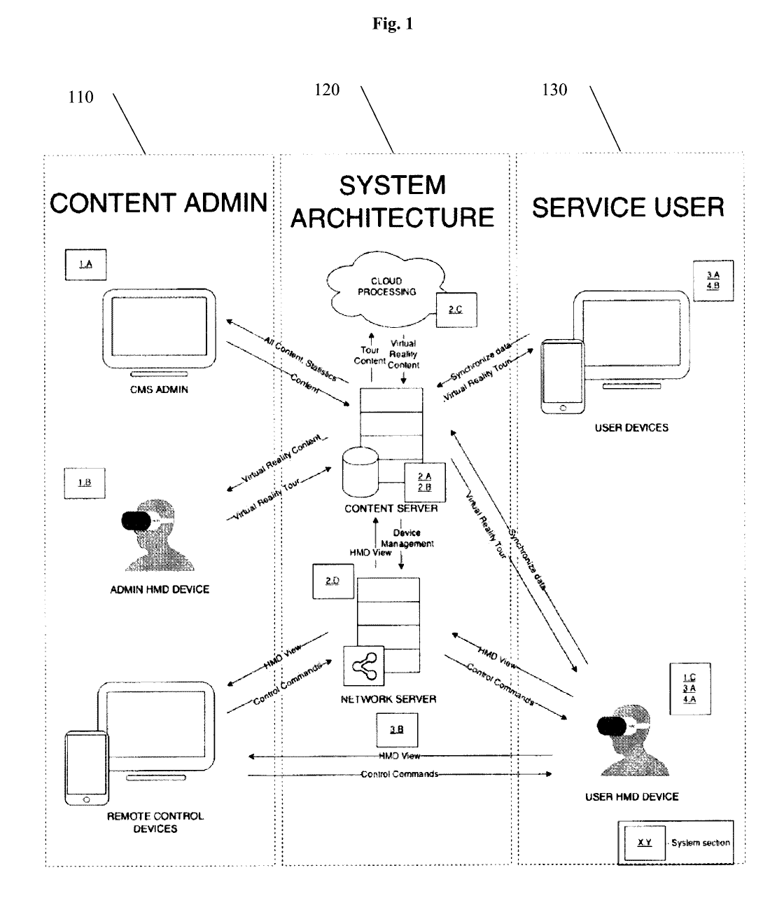

Referring to FIG. 1, in a particular embodiment, a schema and flow chart for the systems, media, methods, and platforms of the improved virtual reality tour and associated analytics is provided. In this embodiment, a content admin 110 is able to create VR content using the Content Management System (CMS) and manage the display of the content in an HMD device or through remote control devices. The content itself is processed through the system architecture 120, comprising a content server and a network server. The content is streamed to the service user 130, who accesses the content through an HMD device or other devices.

### View Sphere

In some embodiments, the platforms, systems, media, and methods described herein include view spheres, or use of the same. In some embodiments, a view sphere comprises VR textures applied to a mesh sphere or grid for presenting VR content. In further embodiments, a view sphere is displayed through an HMD.

### Viewport

In some embodiments, the platforms, systems, media, and methods described herein include viewports, or use of the same. In some embodiments, the viewport is a field of view of a user while observing VR content. In further embodiments, the viewport is the field of view of the user through an HMD.

Assets

In some embodiments, the platforms, systems, media, and methods described herein include assets, or use of the same. In some embodiments, the assets comprise photographs. In some embodiments, the photographs are 2D, 2D panoramic, 2D 360-degree, 3D, 3D panoramic, or 3D 360-degree. In other embodiments, the assets comprise videos. In some embodiments, the videos are 3D, 3D panorama, or 3D 360-degree. In further embodiments, the assets comprise 3D models or 3D renderings. In even further embodiments, the assets comprise audio or sound files. In some embodiments, the sound files are monostereo. In other embodiments, the sound files are stereo. By way of non-limiting examples, sound files include audio recordings, voice recordings, music files, and sound bites. In some embodiments, assets are processed to create a VR environment. In further embodiments, assets are processed to create a VR environment comprising VR content, VR textures, VR scenes, VR objects, vantage points, hotspots, or a combination thereof. In still further embodiments, assets are processed to create a VR tour.

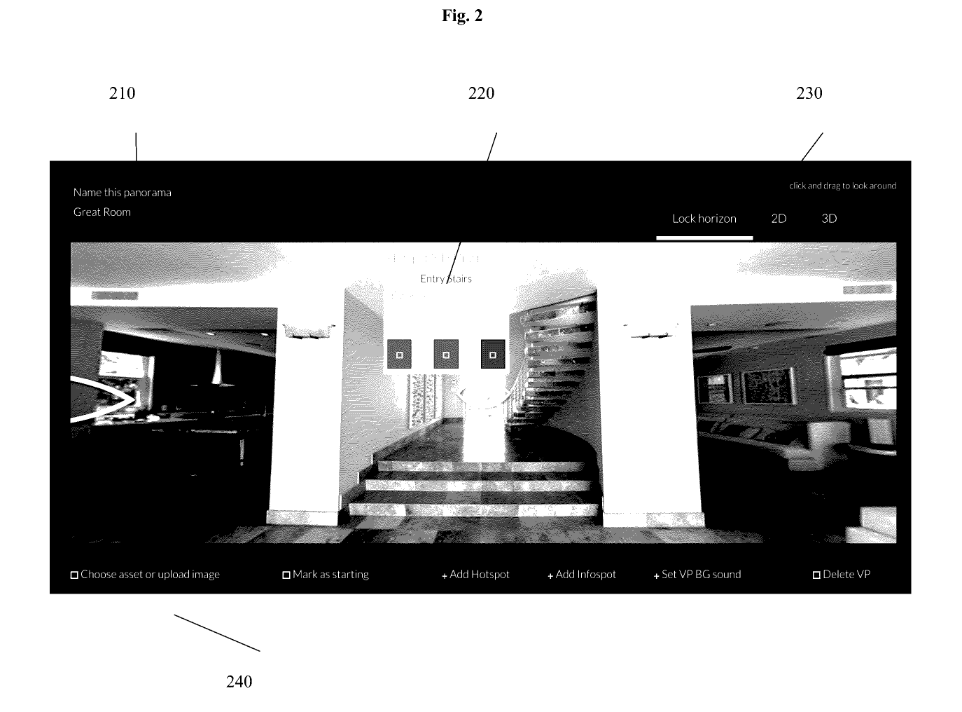

Referring to FIG. 2, in a particular embodiment, a user interface screen for processing and editing VR tour content is provided. In this embodiment, a real estate property is being transformed into a VR tour. The user interface allows the user to rename the room 210, connect hotspots 220 to link the room with other rooms, view and edit the image properties 230, and upload additional assets to expand the VR tour.

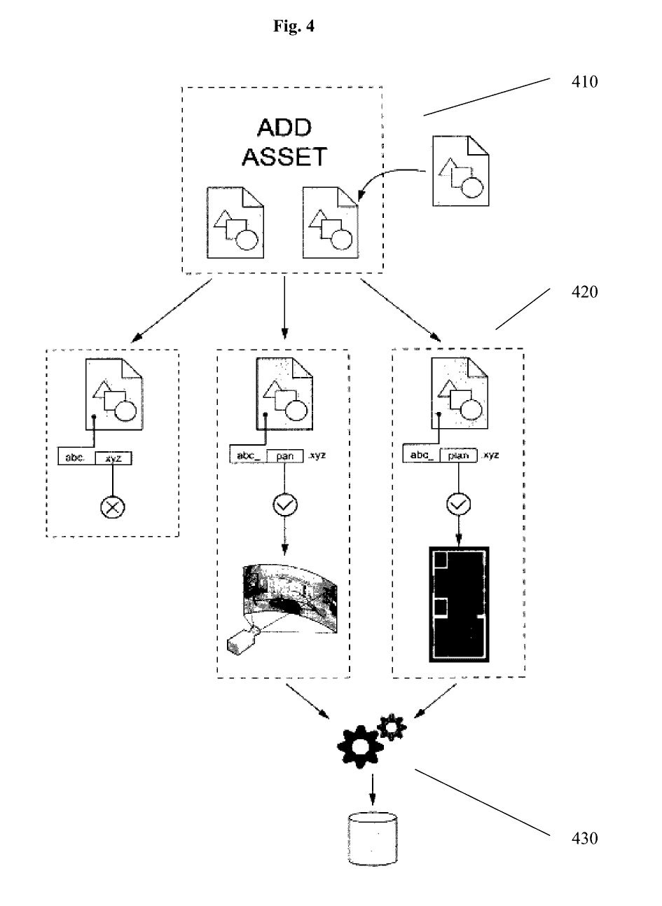

Referring to FIG. 4, in a particular embodiment, a schema for the systems, media, methods, and platforms of the improved virtual reality tour and associated analytics is provided. In this embodiment, a VR tour creation and editing application is configured to allow a user to upload assets 410, which are recognized and analyzed for content, parameters, and metadata 420. By creating semantics for the data, the process is automated 430 and enhances the ease of use for the user.

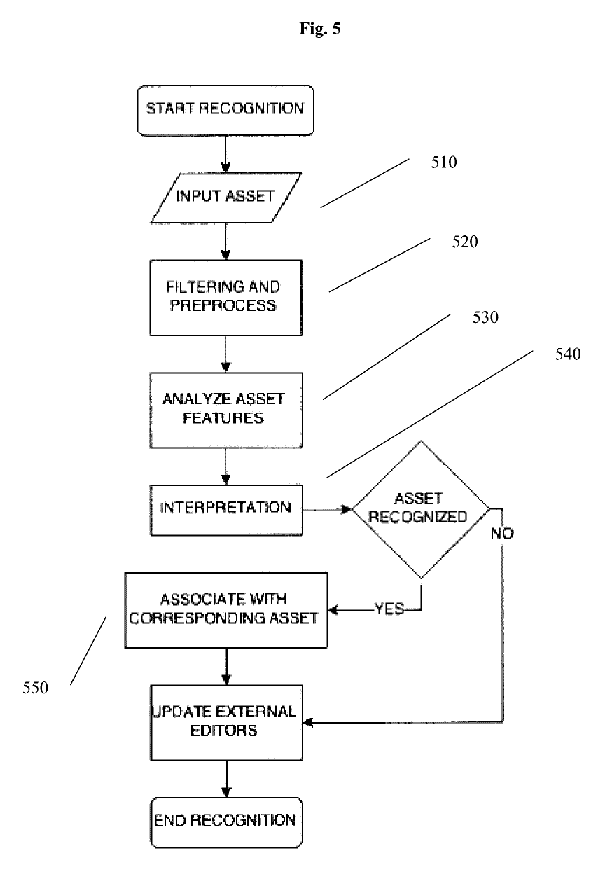

Referring to FIG. 5, in a particular embodiment, a flow chart for the recognition and analysis of assets is provided. In this embodiment, assets are uploaded 510 and automatically processed 520, analyzed 530, interpreted 540, and associated 550 by deduction of angles between assets, connecting intersections, and identifying the relative area of geometric figures. Processed assets are now ready to be edited in other platforms, systems, media, and methods.

### Virtual Reality (VR) Scene

In some embodiments, the platforms, systems, media, and methods described herein include VR scenes, or use of the same. In some embodiments, a VR scene comprises a set of assets for the display from a specific vantage point.

### Virtual Reality (VR) Content

In some embodiments, the platforms, systems, media, and methods described herein include VR content, or use of the same. In some embodiments, VR content comprises 360-degree and 3D 360-degree images, videos, and renderings. In other embodiments, VR content is generated from uploaded assets. In further embodiments, VR content comprises VR scenes, VR textures, and VR objects.

### Virtual Reality (VR) Texture

In some embodiments, the platforms, systems, media, and methods described herein include VR textures, or use of the same. In some embodiments, VR texture comprises processed and optionally compressed 360-degree and 3D 360-degree images, videos, and renderings to be displayed on a view sphere. In some embodiments, VR texture is processed for lossless compression to enable faster loading speeds and low latency viewing. In further embodiments, VR texture is processed to generate flat 2D images. In even further embodiments, VR texture is analyzed to create a depth map.

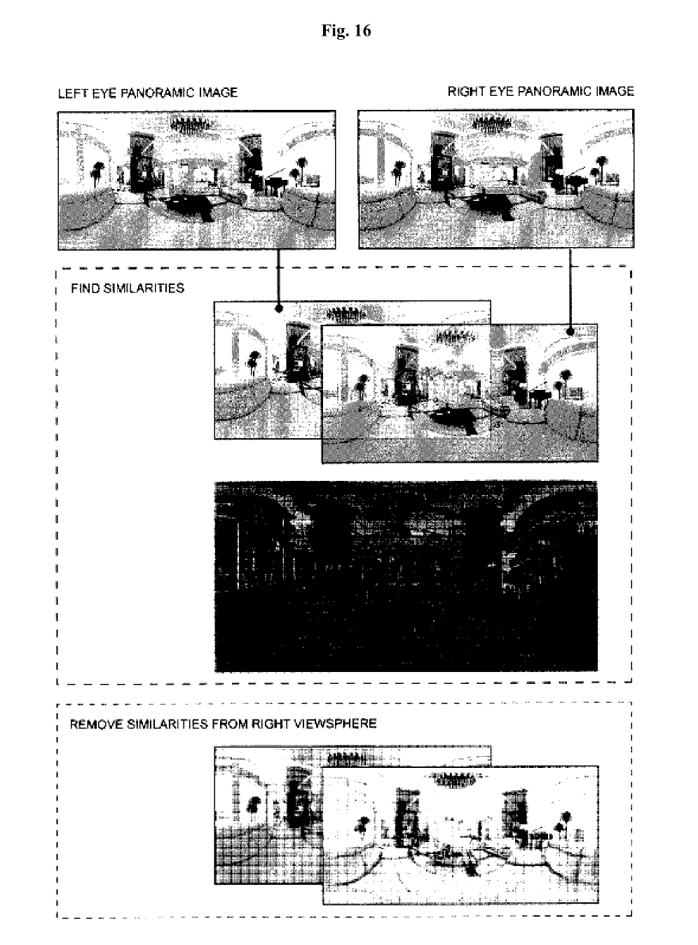

Referring to FIG. 16, in a particular embodiment, the lossless compression of VR content by removing VR texture similarities is provided. In this embodiment, the application processes the left eye and right eye views of the 3D images for similar pixels. The similar pixels are removed from the right eye image to generate a unified image.

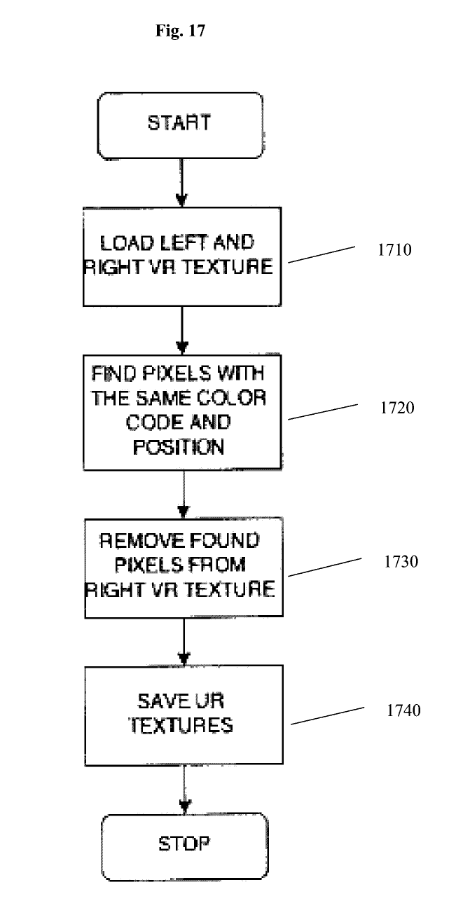

Referring to FIG. 17, in a particular embodiment a flow chart process depiction of the lossless compression of VR content by removing VR texture similarities is provided. In this embodiment, VR textures from left eye and right eye views 1710 are loaded and pixels of the same color and position 1720, i.e. similar pixels, are detected and removed from the right eye VR texture 1730. The new left eye and right eye VR textures are saved 1740 to generate a unified image.

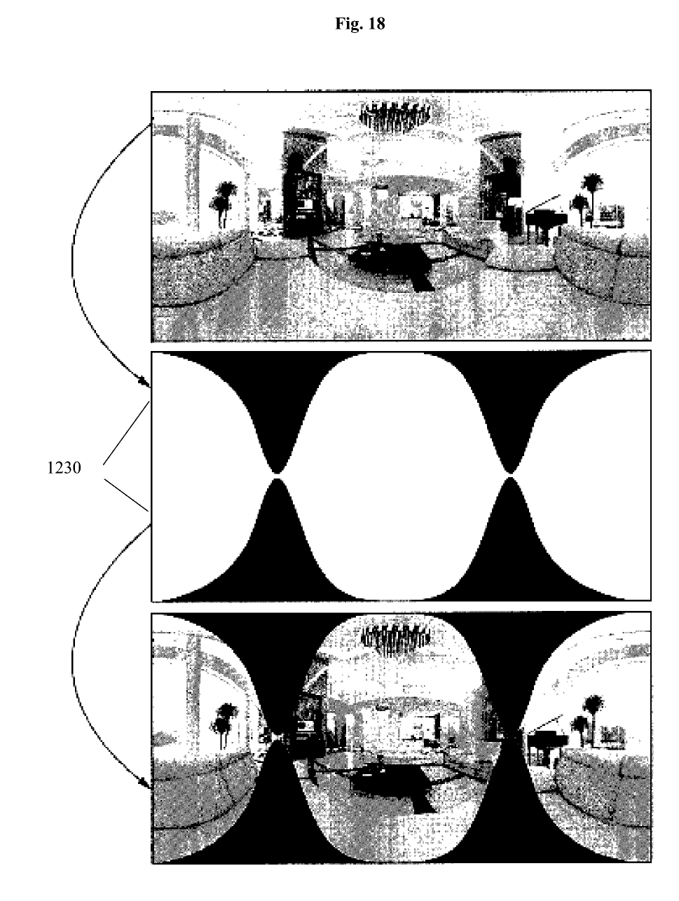

Referring to FIG. 18, in a particular embodiment, the lossless compression of VR content by removing non-equirectangular pixels is provided. In this embodiment, the VR texture in an equirectangular presentation on a view sphere possesses denser pixels towards the top and bottom 1810 of the sphere, resulting in overlapping pixels. The overlapping pixels are removed, thereby generating an output image of lower file size.

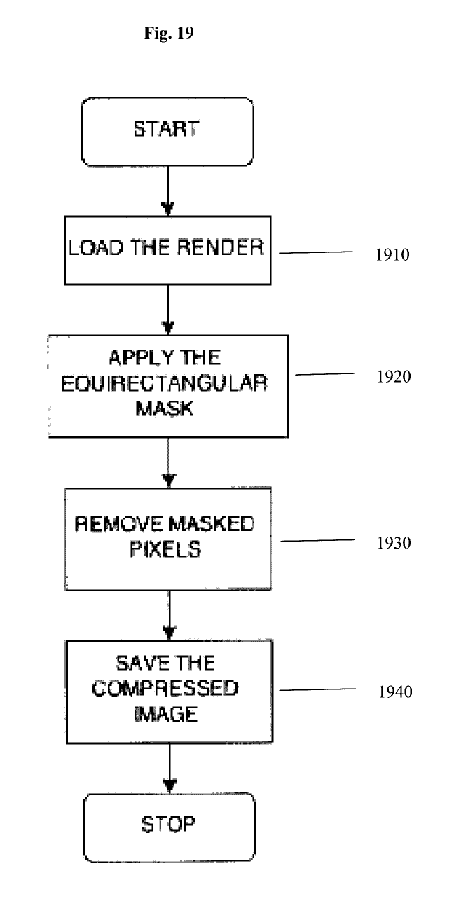

Referring to FIG. 19, in a particular embodiment, a flow chart process depiction of the lossless compression of VR content by removing non-equirectangular pixels is provided. In this embodiment, the renderer 1910 applies an equirectangular mask 1920 to an image. Masked pixels are denser pixels towards the top and bottom of a view sphere, and these pixels are removed 1930 and the compressed image is saved 1940 for viewing in a VR tour.

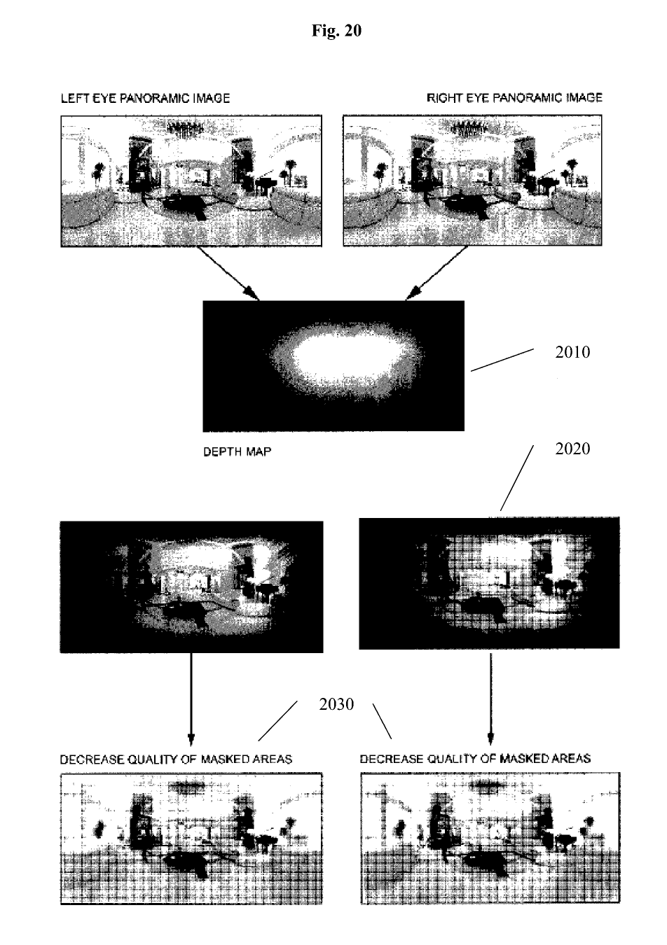

Referring to FIG. 20, in a particular embodiment, the compression of VR content by distance is provided. In this embodiment, assets are loaded to memory and a depth map 2010 is created. The depth map is used to generate a gradient mask that is applied to the view sphere as an overlay 2020 on the image. The parts of the images that are masked by the depth map are processed to decrease their quality according to the gradient 2030, thereby generating a compressed and lower file size image.

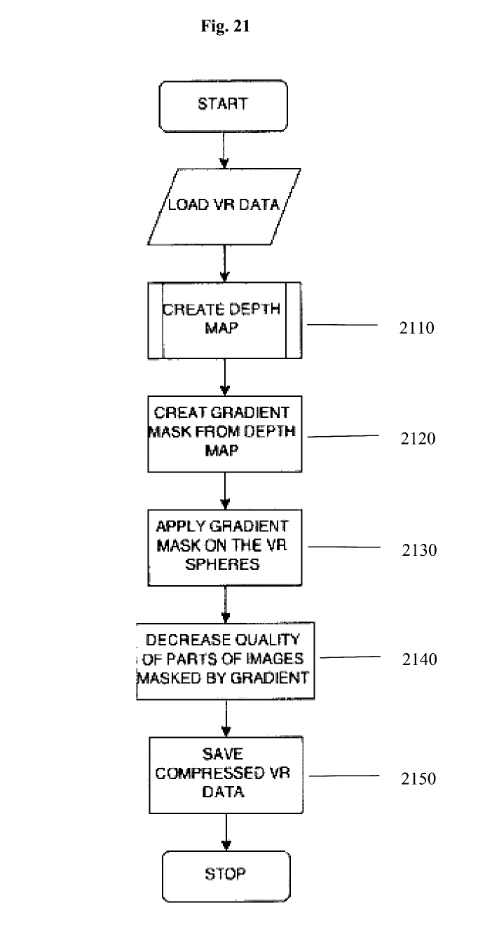

Referring to FIG. 21, in a particular embodiment, a flow chart process depiction of the compression of VR content by distance is provided. In this embodiment, a depth map 2110 is generated from VR content. A gradient mask 2120 created from the depth mask is applied 2130 over VR content view spheres, and the image quality is adjusted based on the depth map gradient 2140. The compressed image is then saved 2150 and available for use in a VR tour.

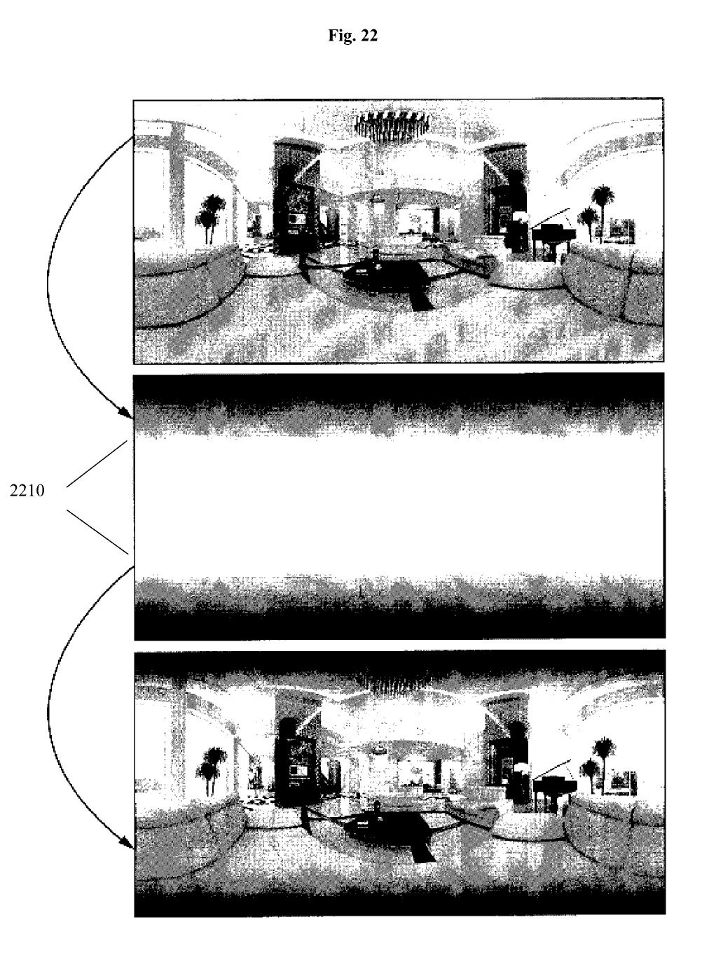

Referring to FIG. 22, in a particular embodiment, the compression of VR content by the most viewed area is provided. In this embodiment, the VR content quality is decreased for areas a user rarely sees, specifically the pixels near the top and the bottom 2210 of a view sphere. Gradient compression is applied to these pixels, whereby compression is applied at varying strengths depending on the distance of the pixels from the top and the bottom of the view sphere. The strongest compression is applied at the very top and very bottom of the gradient.

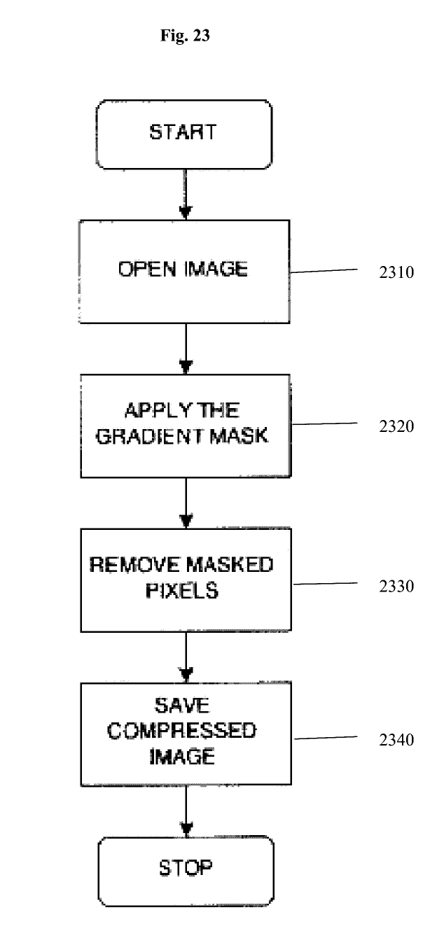

Referring to FIG. 23, in a particular embodiment, a flow chart process depiction of the compression of VR content by the most viewed area is provided. In this embodiment, a gradient mask 2320 is applied to a VR content image 2310. Pixels heavily masked by the gradient are removed or their quality is adjusted 2330 and the compressed image is saved 2340.

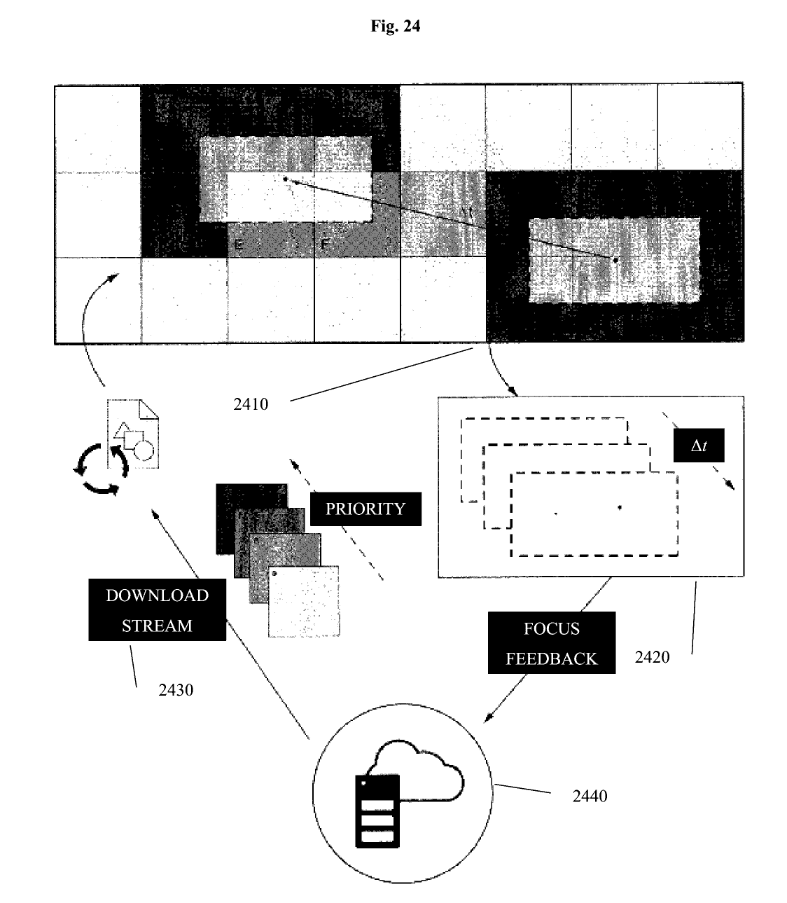

Referring to FIG. 24, in a particular embodiment, the compression of VR content by removing the data behind the angle of view is provided. In this embodiment, view focus prioritizes streaming of content. Streaming bandwidth is allocated 2430 to VR content depending on the time and number of instances viewed of that content 2420, thereby optimizing streaming bandwidth. Streaming optimization is further enabled by adjusting transmitted content quality based on the position of a fragment of VR content 2410 in conjunction with content viewing statistics. VR content fragments adjacent to highly viewed content is afforded more bandwidth and streamed at a higher quality. Viewer focus statistics are continuously sent to a server 2440 during streaming to better adjust the compression of downloaded content.

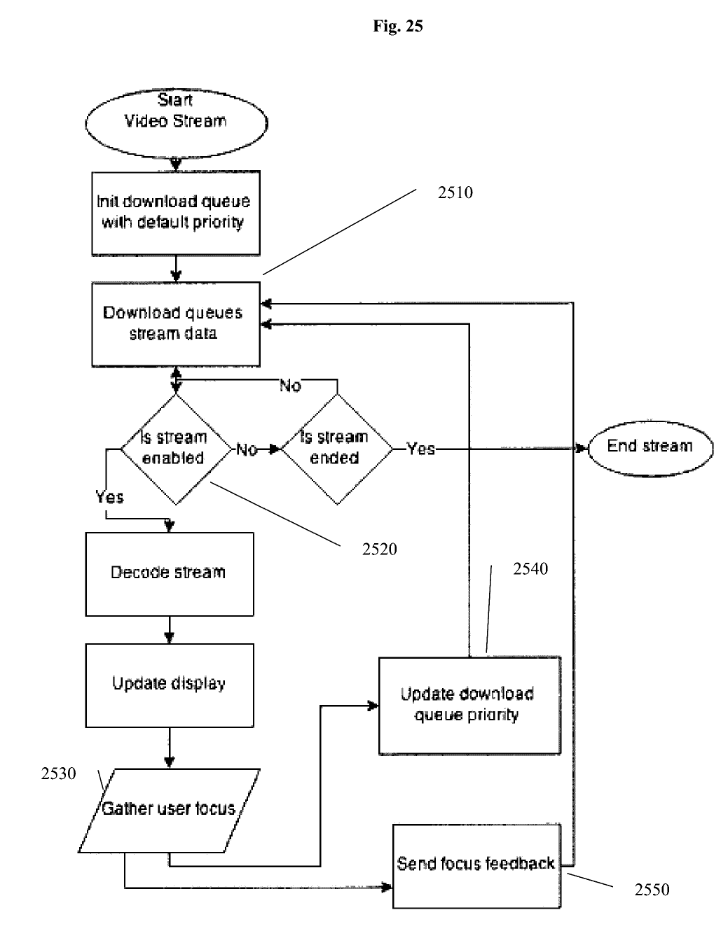

Referring to FIG. 25, in a particular embodiment, a flow chart process depiction of the compression of VR content by removing the data behind the angle of view is provided. In this embodiment, stream queue data is downloaded and buffered 2510. Upon detection of the initiation of a stream 2520, user focus information 2530 is gathered and used to assign bandwidth priority 2540 within the stream. Further information is sent to a server which further processes 2550 the user focus information to further optimize the stream.

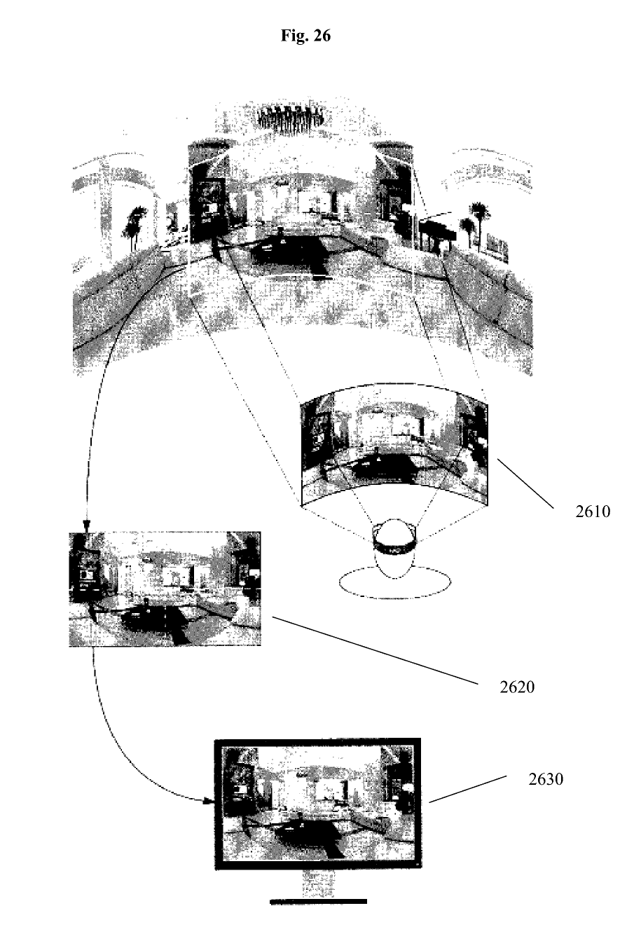

Referring to FIG. 26, in a particular embodiment, the transformation of VR content to a 2D image is provided. In this embodiment, the VR texture as viewed through an HMD 2610 is transformed by an algorithm configured to process asset information, device information, viewing angle, and field of view to generate a 2D flat image 2620, thereby allowing the image to be displayed on a flat screen 2630.

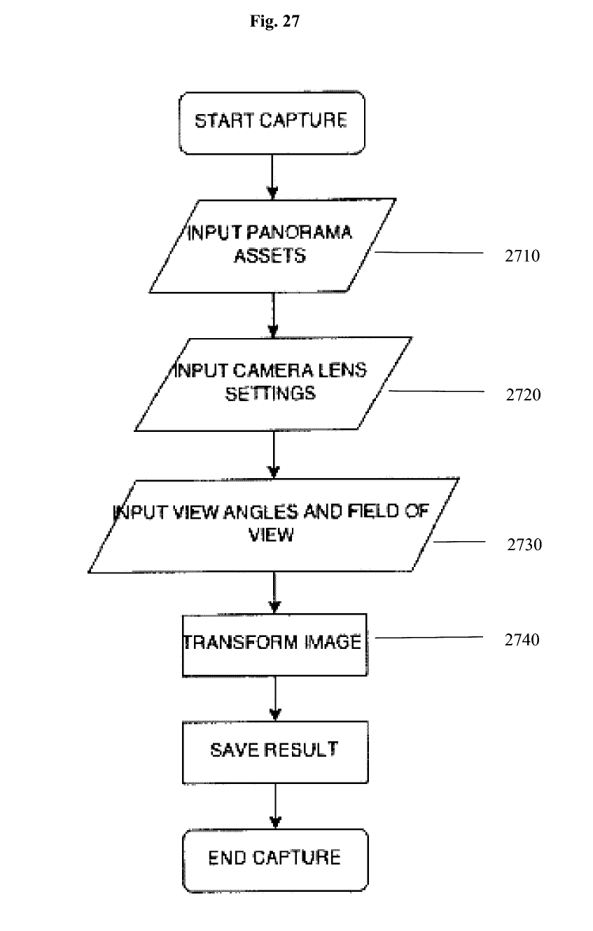

Referring to FIG. 27, in a particular embodiment, a flow chart process depiction of the transformation of VR content to a 2D image is provided. In this embodiment, 3D assets 2710 are analyzed based on hardware settings 2720 and image angles and field of view 2730. The assets are transformed 2740 from this information into a flat 2D image.

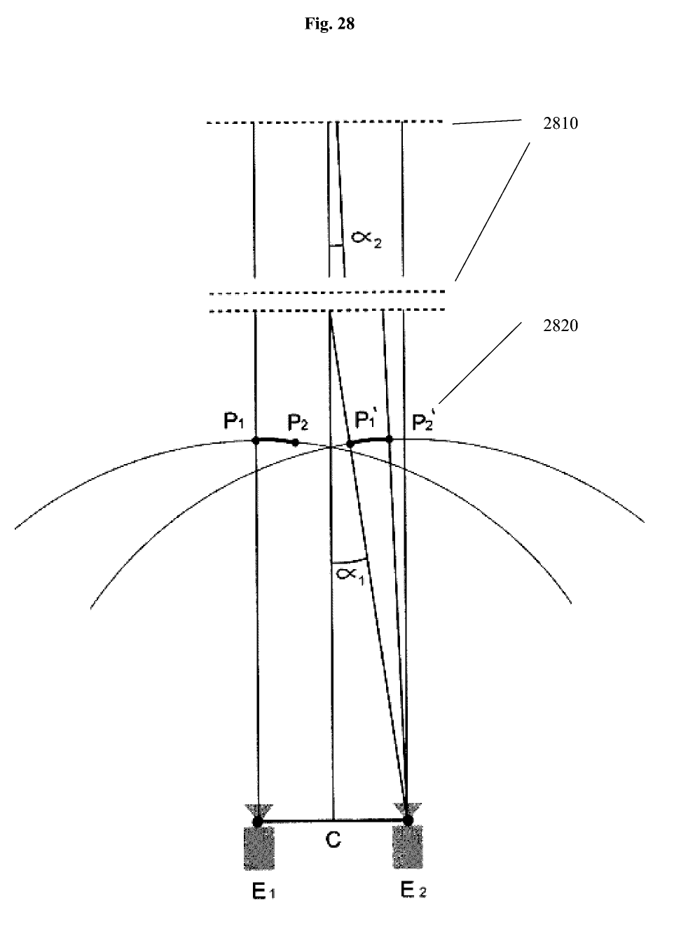

Referring to FIG. 28, in a particular embodiment, the automatic creation of a depth map from VR content is provided. In this embodiment, VR content is analyzed through a plurality of concentric and multiperspective panoramas 2810 to retrieve panoramic depth. Each pixel of a panorama 2820 is compared to the corresponding pixel on the other panoramas, thereby calculating relative shift. The depth of a panorama is generated based on relative shift and camera angle, thereby creating a depth map.

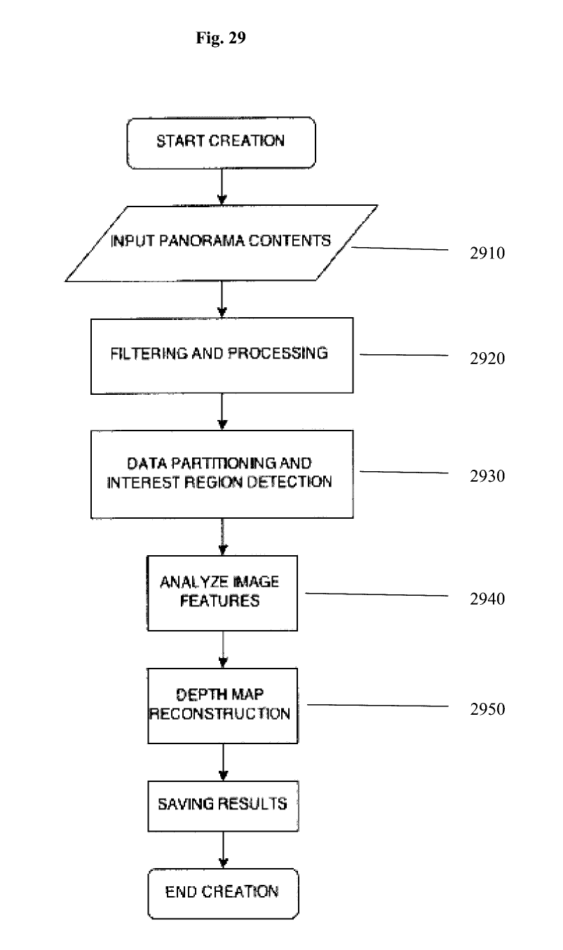

Referring to FIG. 29, in a particular embodiment, a flow chart process depiction of the automatic creation of a depth map from VR content is provided. In this embodiment, VR content 2910 is filtered and processed 2920 to detect image similarities across regions of interest 2930. The pixels are compared to each corresponding pixel 2940 to calculate relative shift and create a depth map 2950.

### Vantage Points

In some embodiments, the platforms, systems, media, and methods described herein include vantage points, or use of the same. In some embodiments, a vantage point provides a user a point-of-view perspective in a VR environment. In some embodiments, a VR environment comprises a plurality of selectable vantage points, wherein each selectable vantage point contains options for interaction. Many suitable implementations of interaction with vantage points are contemplated, including, but not limited to, select, view, skip, compile, remove, and edit.

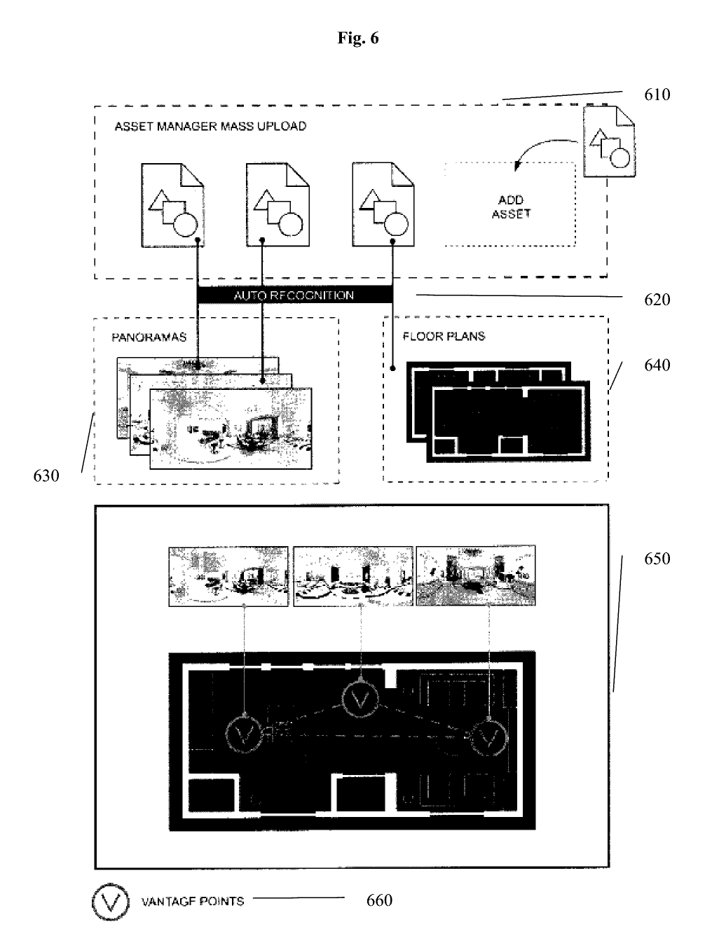

Referring to FIG. 6, in a particular embodiment, a schema for the systems, media, methods, and platforms of the improved virtual reality tour and associated analytics is provided. In this embodiment, a VR tour is automatically created through the automatic recognition of uploaded assets 610, which, after automatic recognition 620, assigns the assets as VR content media and objects 630 or as a floor plan image 640. The VR tour and floor plan 650 are automatically created. Vantage points in the VR tour 660 are automatically or manually assigned to specific regions of the floor plan.

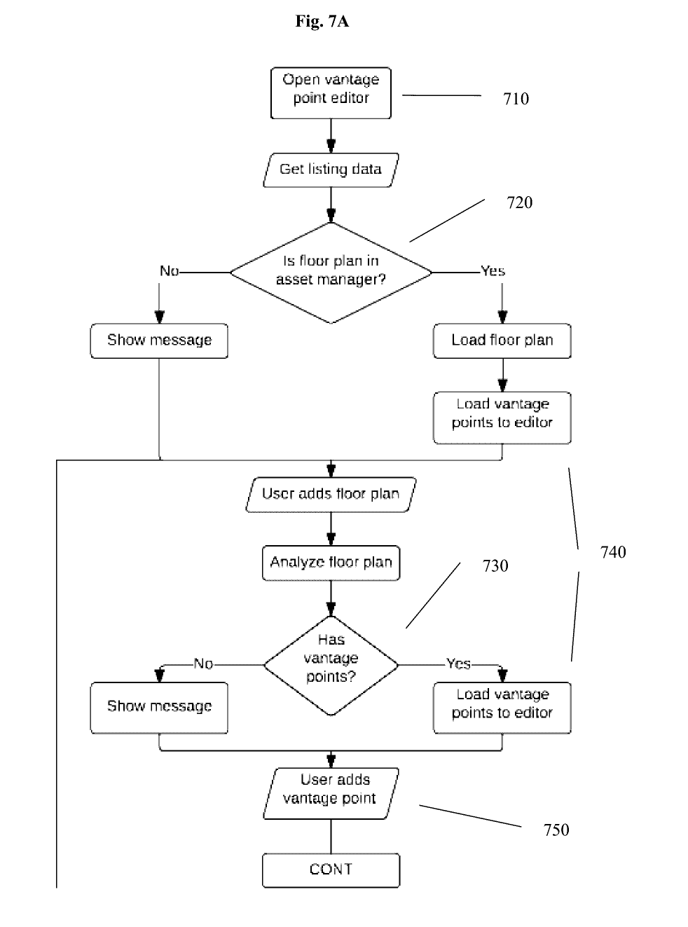

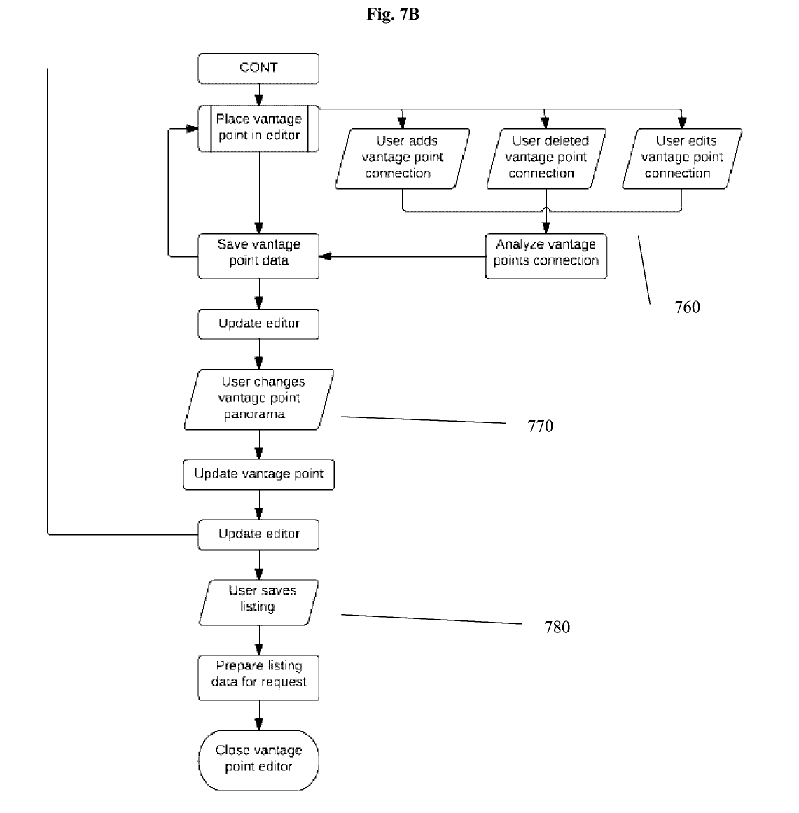

Referring to FIG. 7A and FIG. 7B, in a particular embodiment, a flow chart for a process by which a user assigns vantage points to a VR tour is depicted. In this embodiment, the user adds, edits, or deletes vantage points in a floor plan. The vantage point editor 710 detects the presence of a floor plan 720 and analyzes the floor plan for vantage points 730. Existing vantage points are loaded 740 and new vantage points are added by the user 750 with the option to delete or edit 760 the vantage points. The user assigns vantage points 770 to specific VR scenes, VR content, or VR objects and saves the VR tour listing 780 with the updated vantage point information.

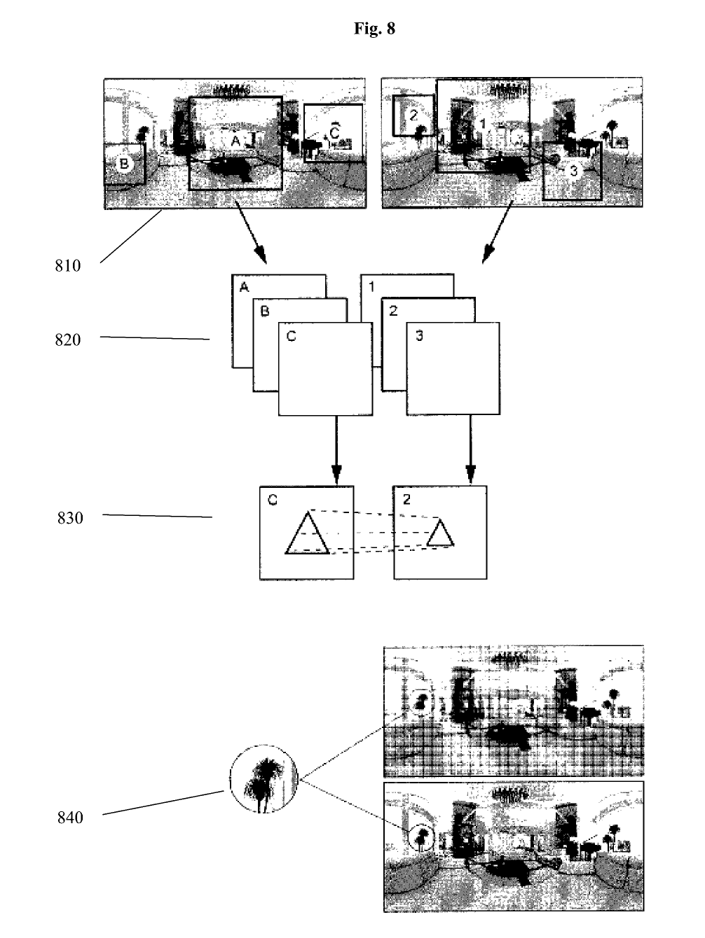

Referring to FIG. 8, in a particular embodiment, the automatic creation of connections between vantage points is provided. In this embodiment, vantage point connections are created through the conversion and analysis of a 3D image, 360 degree image, or panoramic image and finding common features in the regions of interest. First, the image undergoes filtration and conversion 810. Second, the image is parsed into fragments and regions of interest are set 820. Each fragment is analyzed and compared with other fragments 830 from other images. The connections between matching fragments 840 are used to create transitions between different vantage points.

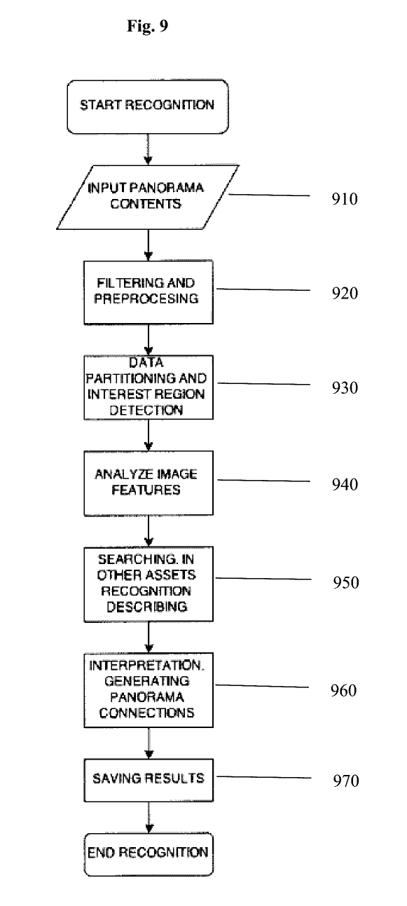

Referring to FIG. 9, in a particular embodiment, a flow chart for a process by which the automatic creation of connections between vantage points is provided. In this embodiment, uploaded VR content 910 is filtered 920 and converted to image fragments and regions of interest 930. The image fragments are analyzed for image features 940 including, but not limited to, line, space, shape, form, color, texture, value, unity, harmony, variety, balance, emphasis, rhythm, movement, pattern, gradation, and proportion. The features of each image is compared to other image fragments 950 and connections between matching fragments 960 are automatically generated and saved 970 to create transitions between different vantage points.

### Virtual Reality (VR) Tour

In some embodiments, the platforms, systems, media, and methods described herein include VR tours, or use of the same. In some embodiments, a VR tour is a presentation method to view previously processed assets at or between one or more vantage points. In some embodiments, a VR tour is presented through an HMD device. In other embodiments, a VR tour is managed through an application. In further embodiments, a VR tour is managed through a mobile application.

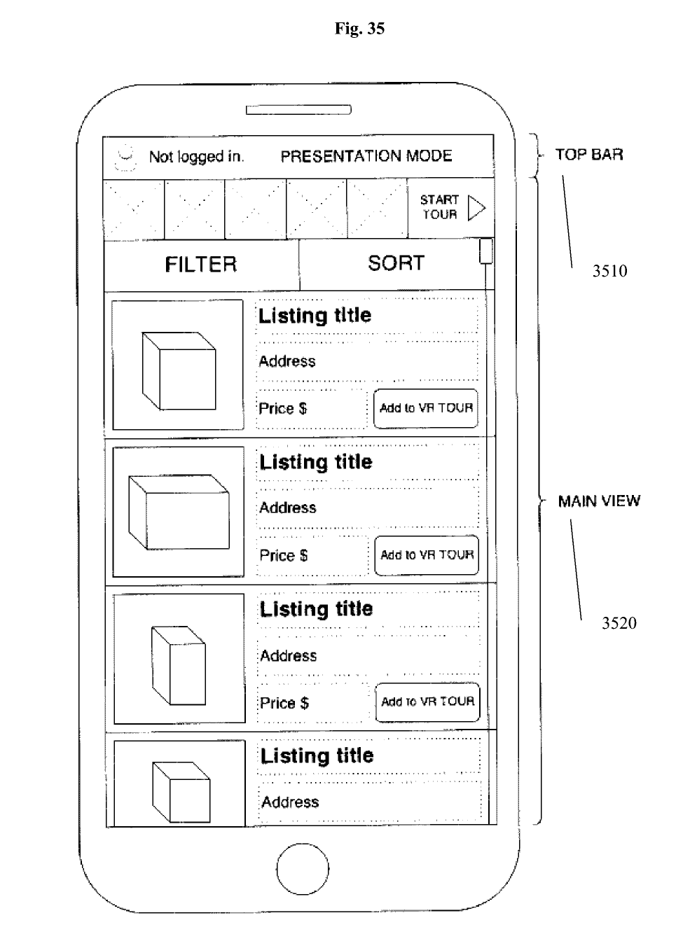

Referring to FIG. 35, in a particular embodiment, a user interface for a VR tour mobile application is provided. In this embodiment, the mobile application is a 2D content browser and has two user interface regions: the top bar region 3510 and the main view region 3520.

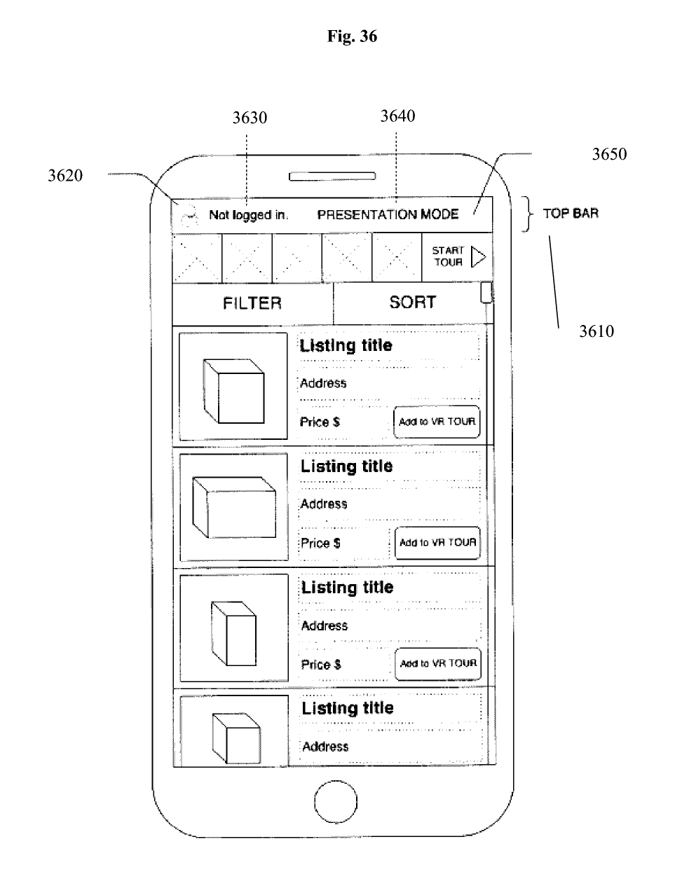

Referring to FIG. 36, in a particular embodiment, the top bar region 3610 of a VR tour mobile application is configured to allow a user to login 3620 to the application, view the login information 3630, and view the current mode information 3640. By default, the ability to change between modes 3650 is not present until the user is logged in.

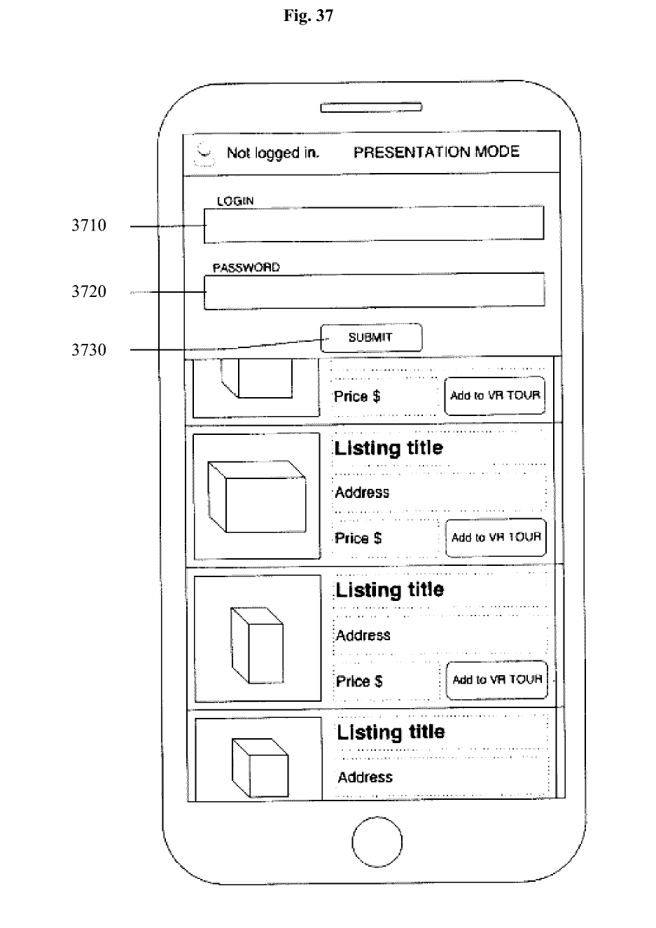

Referring to FIG. 37, in a particular embodiment, a login screen of a VR tour mobile application is provided. In this embodiment, a user presses a login button to access login fields. From the login fields, the user logs into the application by providing a login username 3710, a login password 3720, and pressing the submit button 3730.

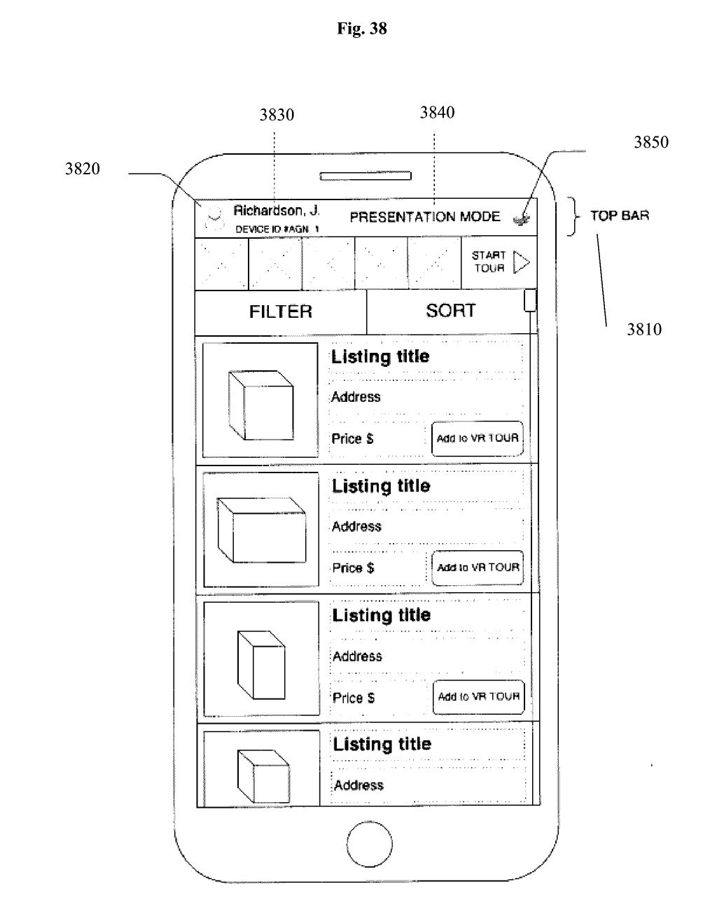

Referring to FIG. 38, in a particular embodiment, a top bar region 3810 of a VR tour mobile application after a user logs into the application is provided. In this embodiment, the top bar region 3810 is configured to display a login button 3820, user information 3830, current mode information 3840, and a change mode button 3850.

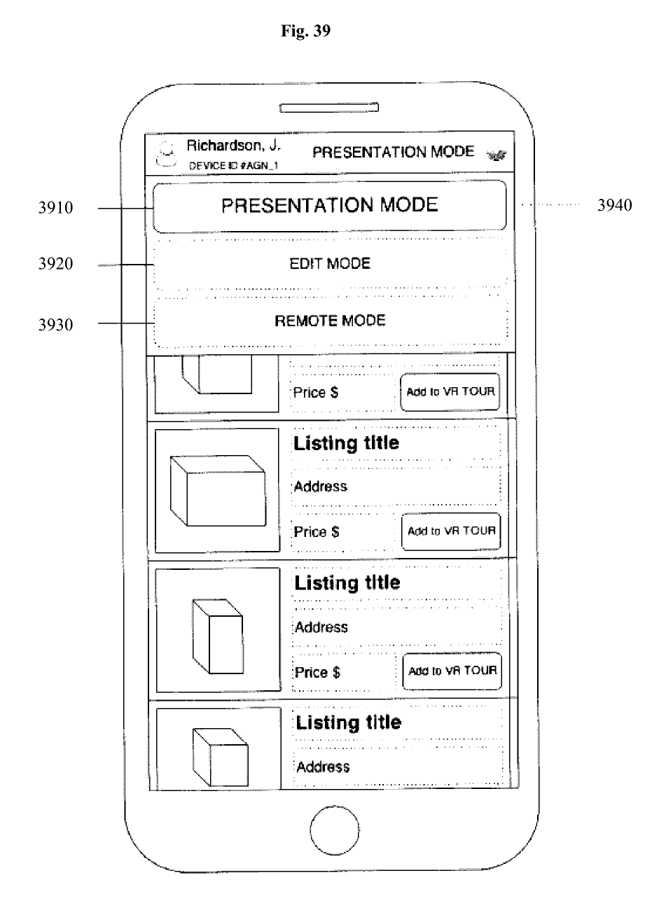

Referring to FIG. 39, in a particular embodiment, a mode selection screen of a VR tour mobile application is provided. In this embodiment, a user presses a change mode button to access the available modes. The user selects between presentation mode 3910, edit mode 3920, or remote mode 3930, with the currently active mode highlighted 3940.

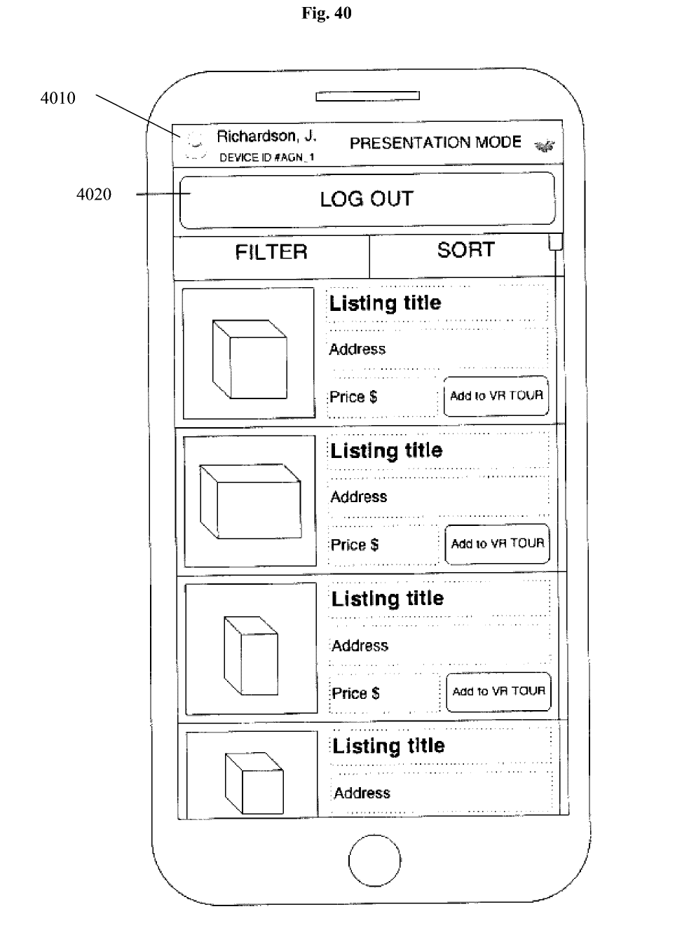

Referring to FIG. 40, in a particular embodiment, a user selects a login button 4010 to display a log out button 4020. By pressing the log out button 4020, the user logs out of the VR tour mobile application.

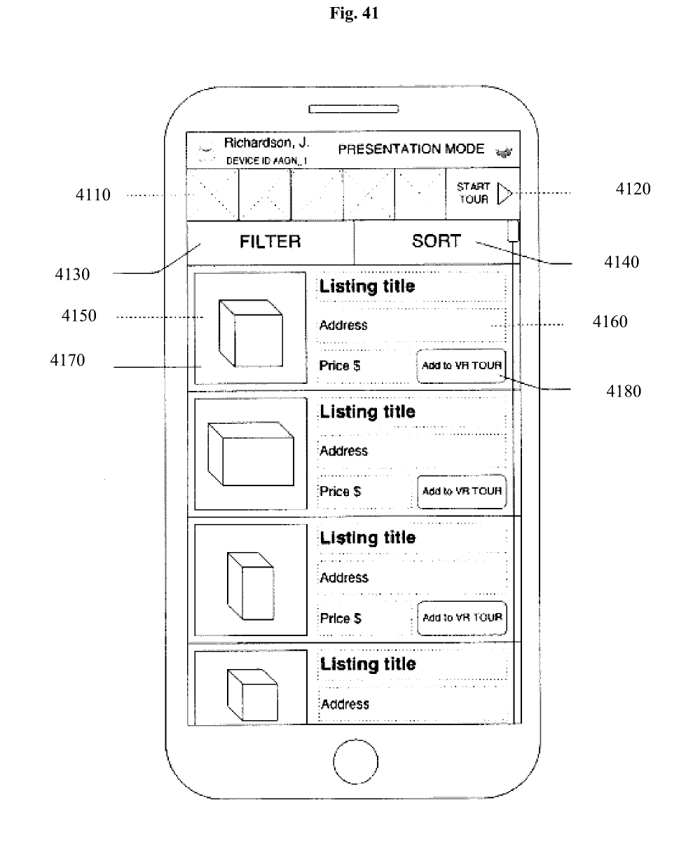

Referring to FIG. 41, in a particular embodiment, a presentation mode of a VR tour mobile application is provided. In this embodiment, a user is presented with a current VR tour queue 4110, which the user initiates by selecting a start tour button 4120. This mode is configured to allow the user to filter 4130 and sort 4140 through VR tour listings. The listings contain a listing image 4150 and listing information 4160. By selecting the listing, the user accesses further listing details 4170. The user optionally adds the listing 4180 to the VR tour queue.

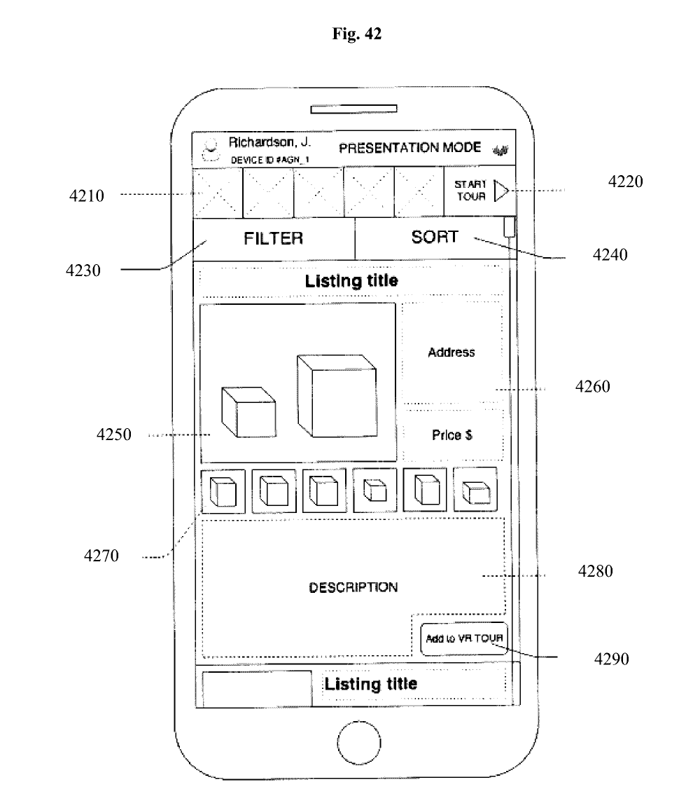

Referring to FIG. 42, in a particular embodiment, an expanded VR tour listing is provided. In this embodiment, a user retains access to the VR tour queue 4210, the ability to start the VR tour queue 4220, as well as the action of filtering 4230 and sorting 4240 VR tour listing titles. This user interface is configured to provide additional information on a VR tour listing by providing a listing image 4250, listing information 4260, a set of scrollable listing images in a gallery 4270, a listing description 4280, and the ability to add the listing to the VR tour queue 4290.

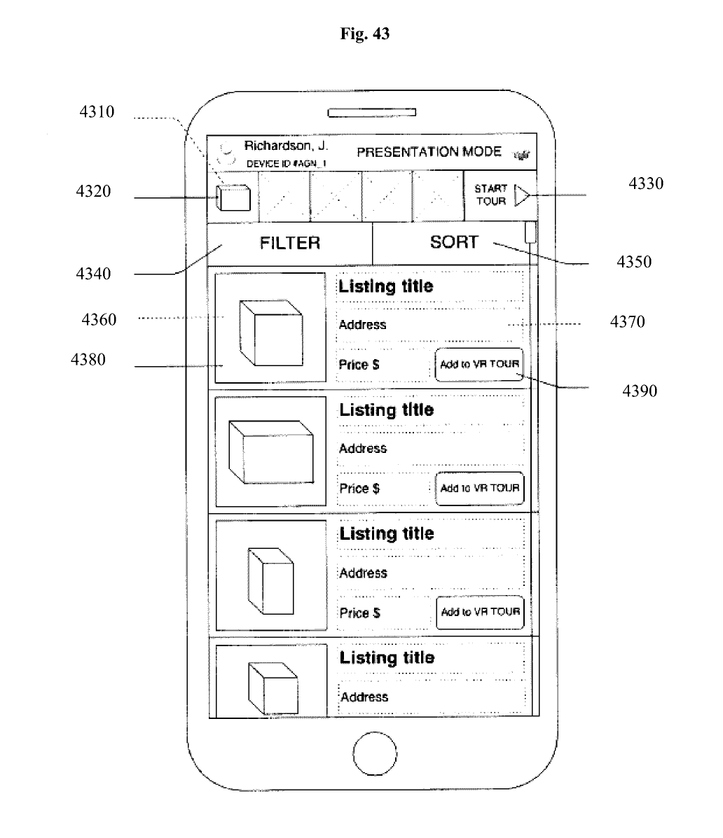

Referring to FIG. 43, in a particular embodiment, a presentation mode user interface of a VR tour mobile application with a VR tour listing in the listing queue is provided. In this embodiment, a user sees a previously selected listing 4310 in the VR tour queue 4320. The user further retains access to start the VR tour queue 4330, filter listings 4340, sort listings 4350, see listing images 4360, see listing information 4370, access listing details 4380, and add more listings 4390 to the queue.

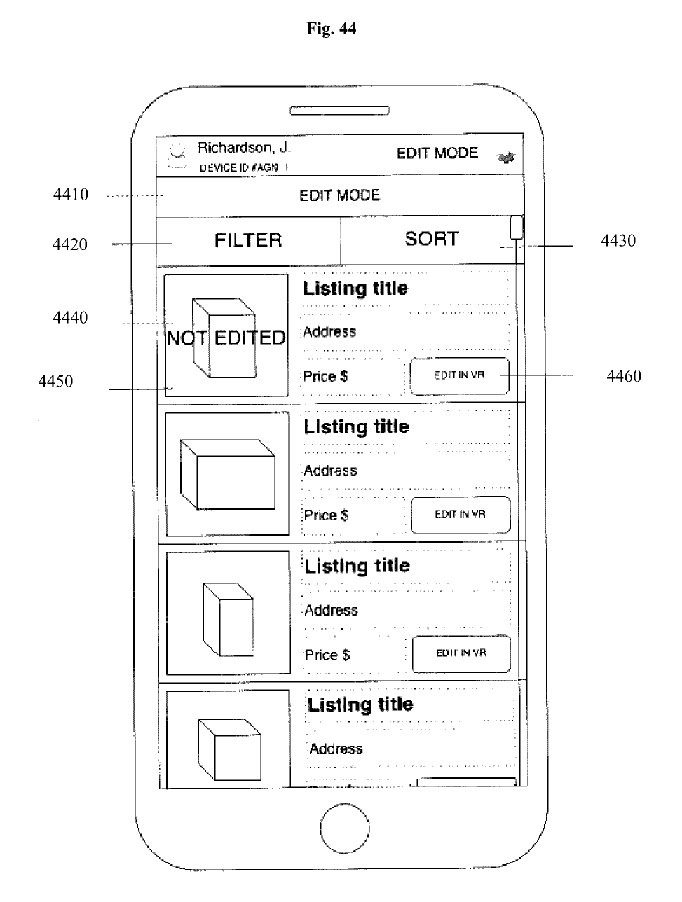

Referring to FIG. 44, in a particular embodiment, an edit mode user interface of a VR tour mobile application is provided. In this embodiment, the user interface is configured to notify a user that the application is in edit mode 4410. Similar to the previously described presentation modes, the user possesses the ability to filter 4420 and sort 4430 through listings. In edit mode, the listing image indicates an edit status 4440 of the listing and allows access to listing details 4450. To edit the listing, a user selects the corresponding edit button 4460.

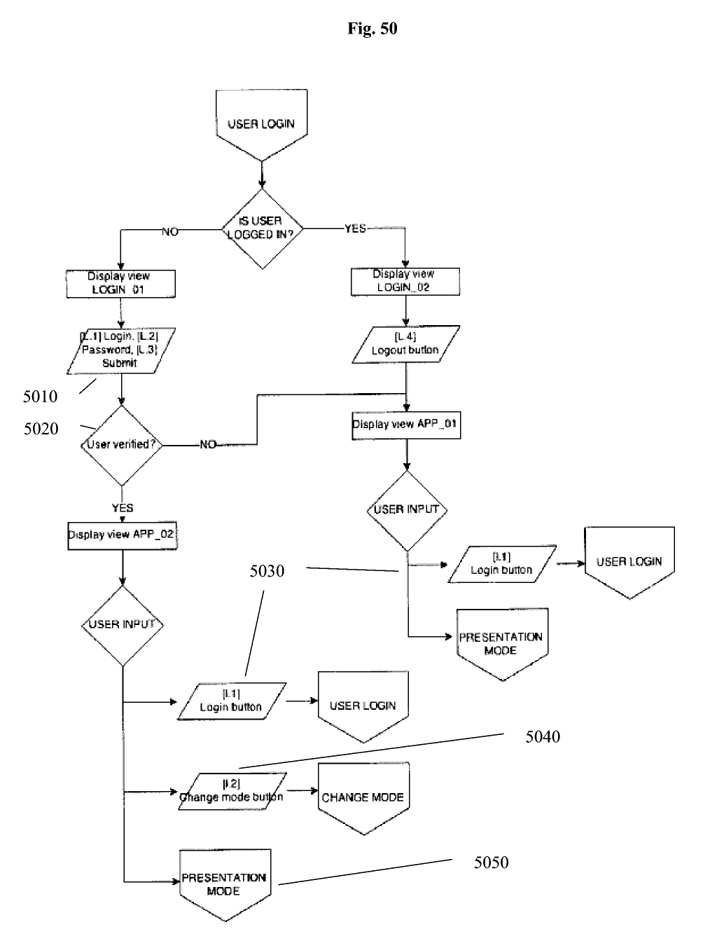

Referring to FIG. 50, in a particular embodiment, a flow chart depiction of the states and actions of a user login procedure for a VR tour mobile application is provided. In this embodiment, the user logs in with a login username and password 5010. If the user is not verified 5020, the user is logged out and prompted to join and create the service. Once a user is logged in, activating the login 5030 button will access login and logout features, and activation of the change mode button 5040 will allow the user to change the mode of the application. If no action is taken, the default mode of the application is presentation mode 5050.

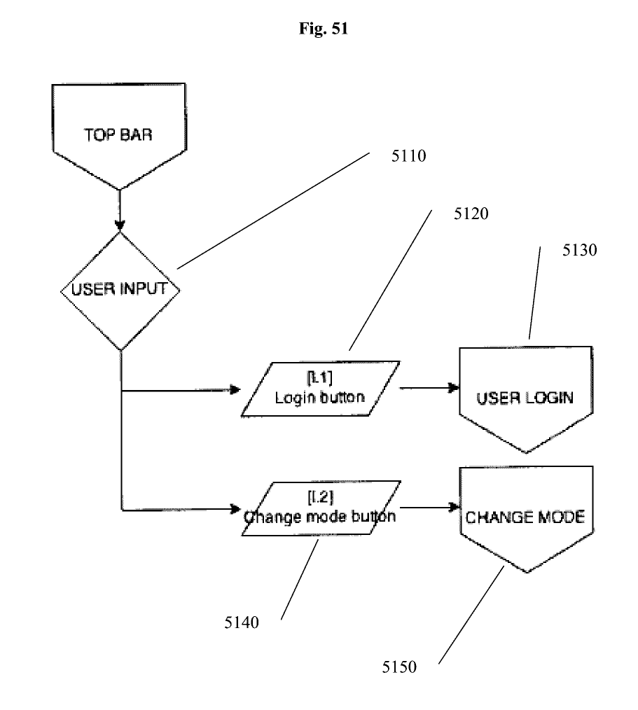

Referring to FIG. 51, in a particular embodiment, a flow chart depiction of the states and actions of a top bar region selection for a VR tour mobile application is provided. In this embodiment, the application is configured to accept user input 5110. If the user activates the login button 5120, the user's login options 5130 are accessible. If the user activates the change mode button 5140, the user selects the mode 5150 of the application.

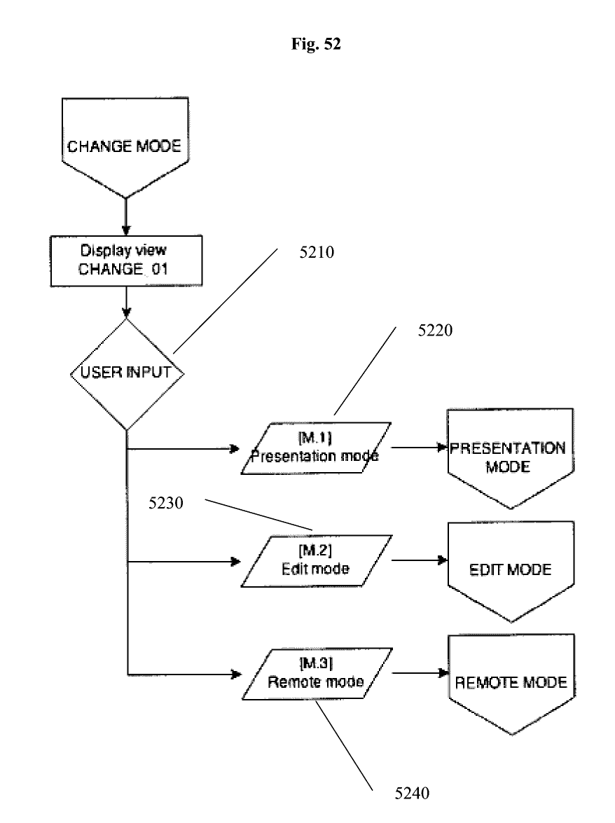

Referring to FIG. 52, in a particular embodiment, a flow chart depiction of the states and actions of a change mode procedure for a VR tour mobile application is provided. In this embodiment, user input 5210 by activates presentation mode 5220, edit mode 5230, and remote mode 5240 through activation of the corresponding mode buttons.

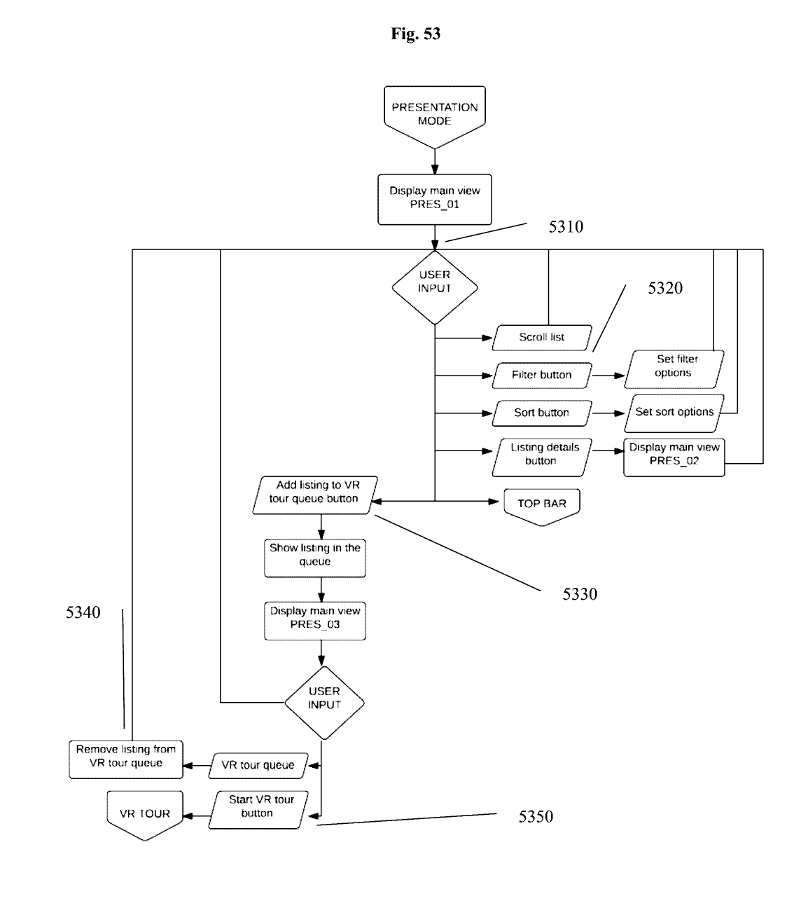

Referring to FIG. 53, in a particular embodiment, a flow chart depiction of the states and actions of a presentation mode selection for a VR tour mobile application is provided. In this embodiment, the application is configured to respond to user input 5310 to scroll through, filter, sort, or expand the details 5320 of VR tour listings. Users further add listings 5330 to a VR tour queue or remove previously added listings 5340 from the queue. Alternatively, users begin VR tours added to the tour queue by selecting the “start VR tour” button 5350.

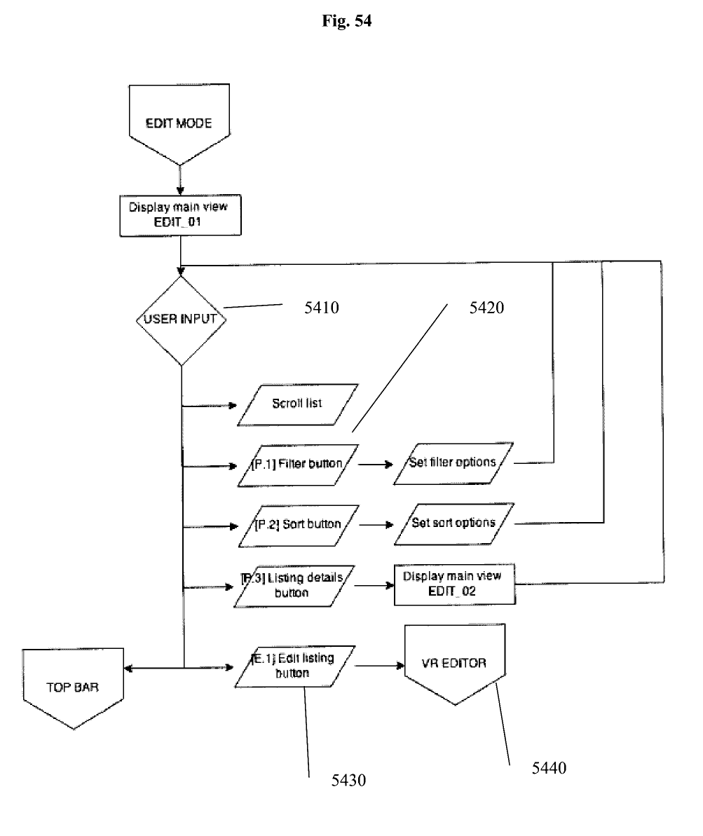

Referring to FIG. 54, in a particular embodiment, a flow chart depiction of the states and actions of an edit mode selection for a VR tour mobile application is provided. In this embodiment, the application is configured to respond to user input 5410 to scroll through, filter, sort, or expand the details 5420 of VR tour listings. Users select a listing and activate the “edit listing” button 5430 to open the VR editor 5440 to edit the VR tour listing.

### Multiviewer Mode

In some embodiments, the platforms, systems, media, and methods described herein include a multiviewer mode, or use of the same. In some embodiments, the multiviewer mode comprises a master device and a slave device. In other embodiments, the multiviewer mode comprises a master device and a plurality of slave devices. In further embodiments, the multiviewer mode is configured such that users of the slave device or slave devices share the viewport of the master device. In still further embodiments, the viewport coordination between master device and slave device is achieved through the sharing of viewing coordinates of the master device.

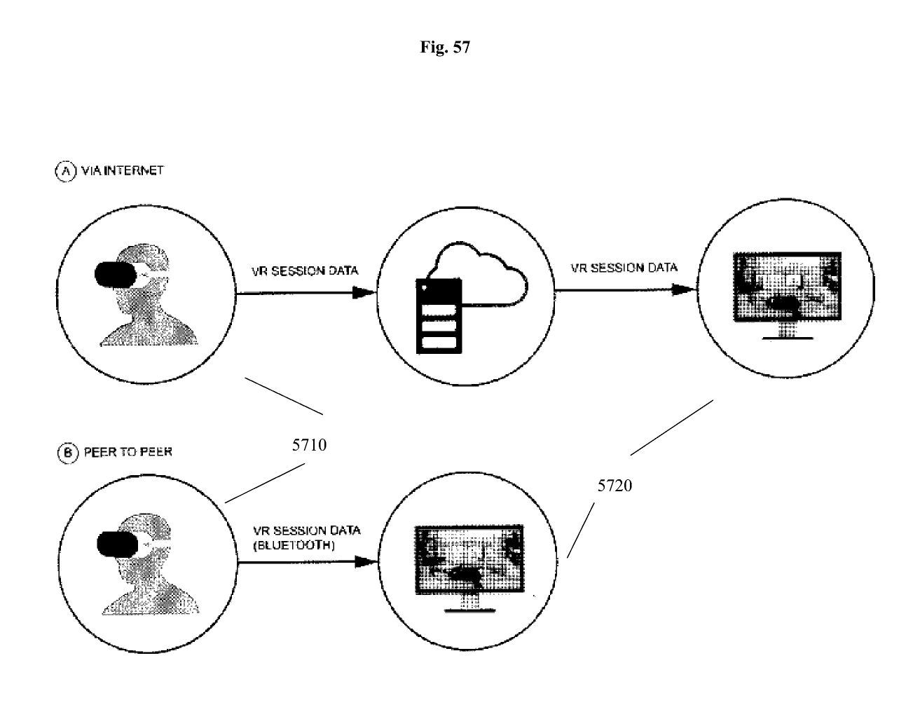

Referring to FIG. 57, in a particular embodiment, the display of a VR tour in an HMD by sending device transformation through the Internet is provided. In this embodiment, the HMD is configured to capture an angle of device rotation that is converted to the transformation of cameras in 3D space or to VR session data. The master device 5710 transmits left eye and right eye information of the present frame through a server or through a direct connection to a slave device 5720, which receives the data and overwrites camera transformation in its own 3D space corresponding to the received data. The master device thereby controls the viewport of the slave device.

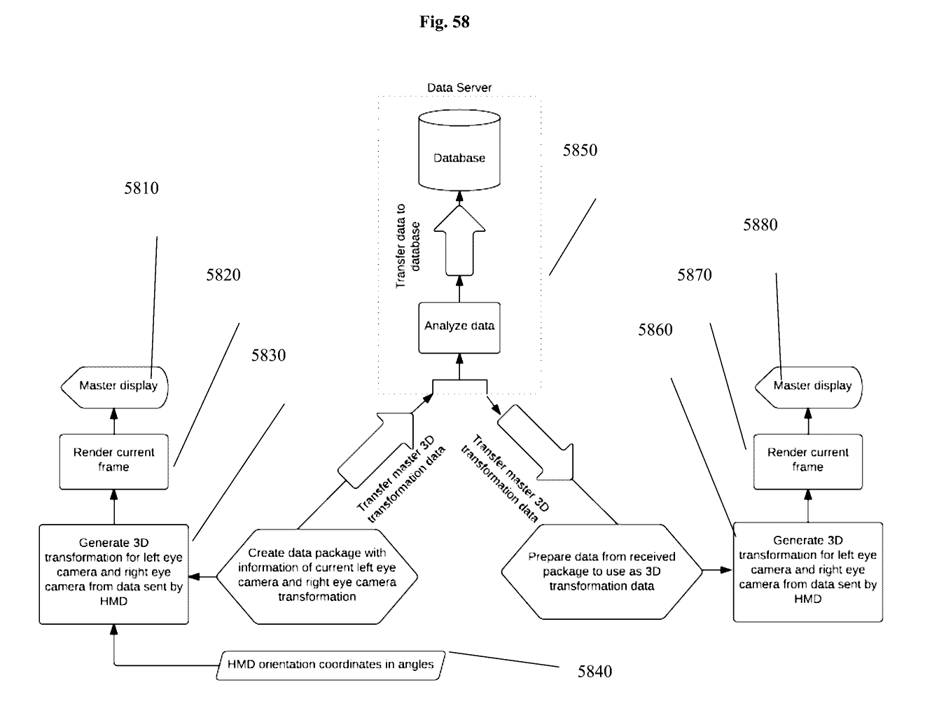

Referring to FIG. 58, in a particular embodiment, a flow chart process depiction of sharing master device coordinates to render the master display 5810 onto a slave display 5880 is provided. In this embodiment, the application is configured to render the current frame of the master display 5820 and generate left eye and right eye display information 5830 in coordinates 5840. This information is sent as a data package through a server 5850, or optionally through a direct connection, to a slave device. The slave device processes the data package and generates the left eye and right eye display information 5870 of the master device to be displayed onto the slave device 5880.

### Remote Control Mode

In some embodiments, the platforms, systems, media, and methods described herein include a remote control module, or use of the same. In some embodiments, the remote control mode is integrated with a mobile application and configured to allow live view remote control interaction with VR tours on connected devices. In other embodiments, the remote control mode remotely controls the VR content view on an HMD device. In further embodiments, the remote control module receives user input data, VR session data, camera angle data, or a combination thereof, from an HMD device. In some embodiments, the remote control mode connects a remote device to a content device through a data server. In other embodiments, the remote control mode connects a remote device to a content device through a direct connection.

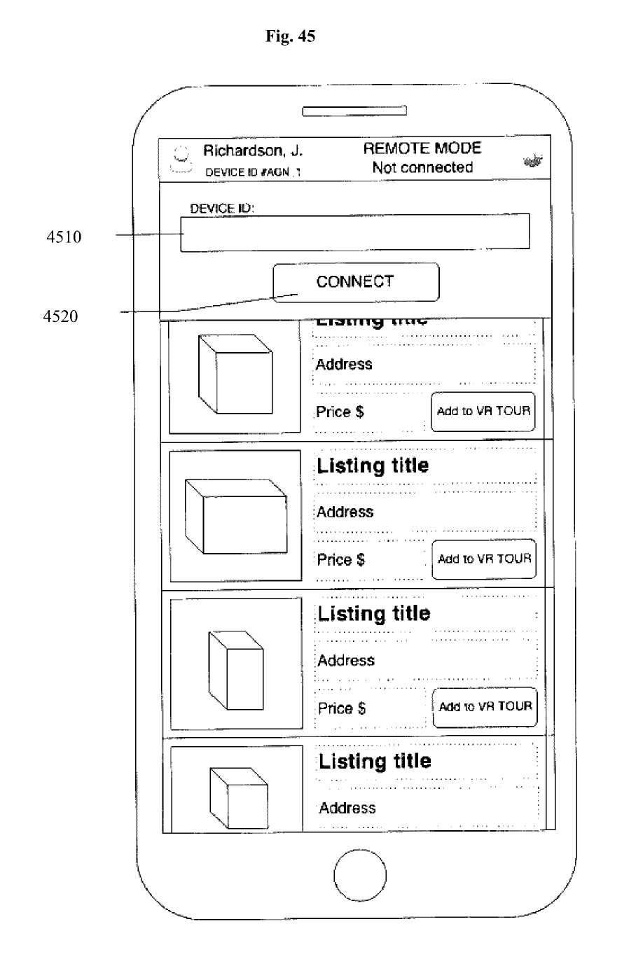

Referring to FIG. 45, in a particular embodiment, a remote mode of a VR tour mobile application is provided. In this embodiment, a user connects to an HMD device by entering the device ID 4510 and pressing the connect button 4520.

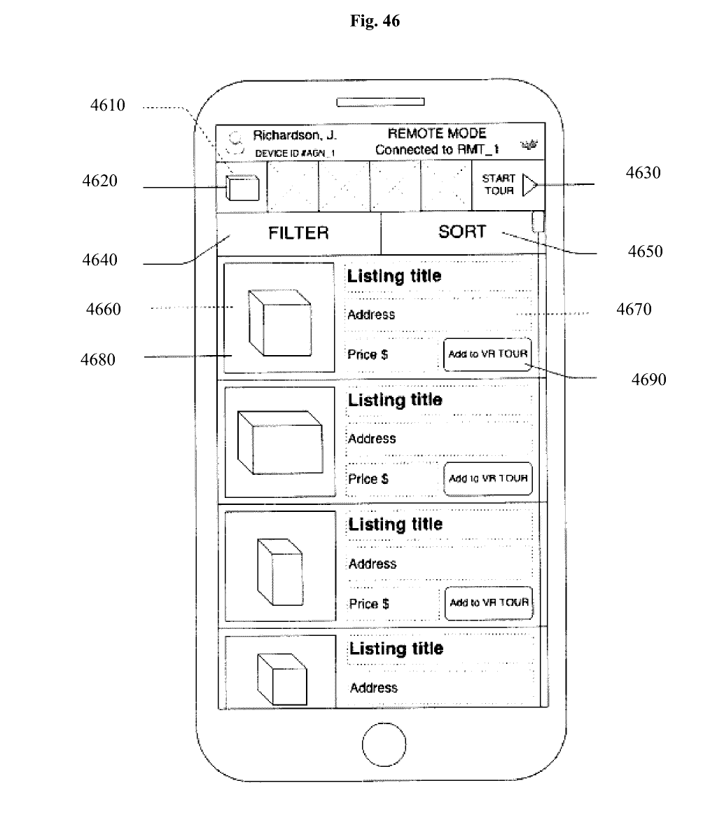

Referring to FIG. 46, in a particular embodiment, the remote mode user interface of a VR tour mobile application is provided. In this embodiment, the user interface is configured to show that the application is connected to a specific HMD remotely. A previously selected VR tour listing 4610 is displayed in the VR tour queue 4620 and the user optionally starts the tour 4630 to begin streaming to the HMD device. In this mode, the user retains the ability to filter 4640 and sort 4650 listings, view the listing image 4660 and listing information 4670, access listing details 4680, or add more listings to the VR tour queue 4690.

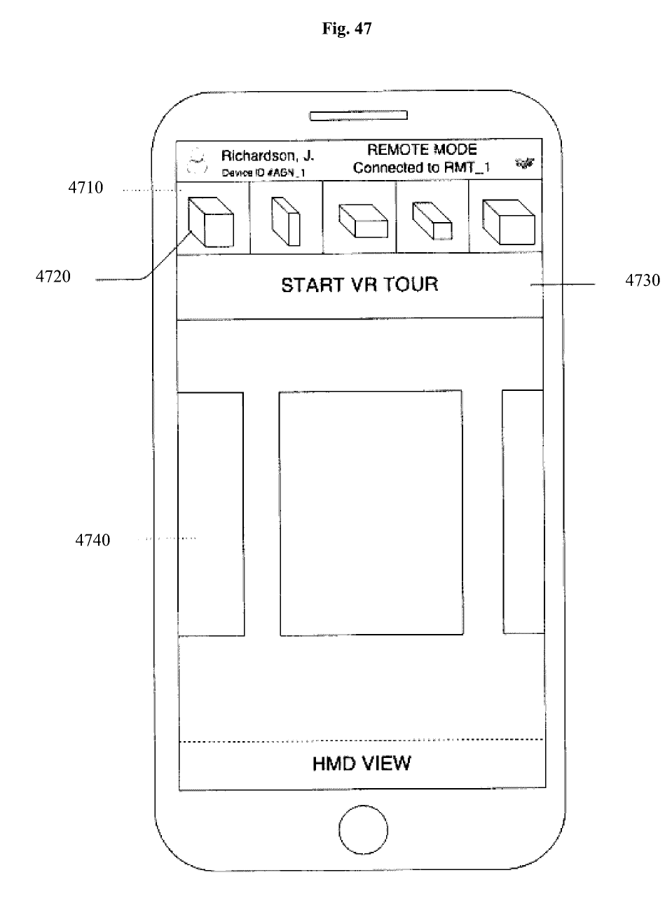

Referring to FIG. 47, in a particular embodiment, a remote mode of a VR tour mobile device is configured to display all the VR tour listings 4710 selected to view in the VR tour queue 4720. The user optionally starts the VR tour 4730 queue to start streaming the tour to a connected HMD device. The user optionally sees the HMD view 4740 of the selected streaming VR tour on the display screen of the mobile application.

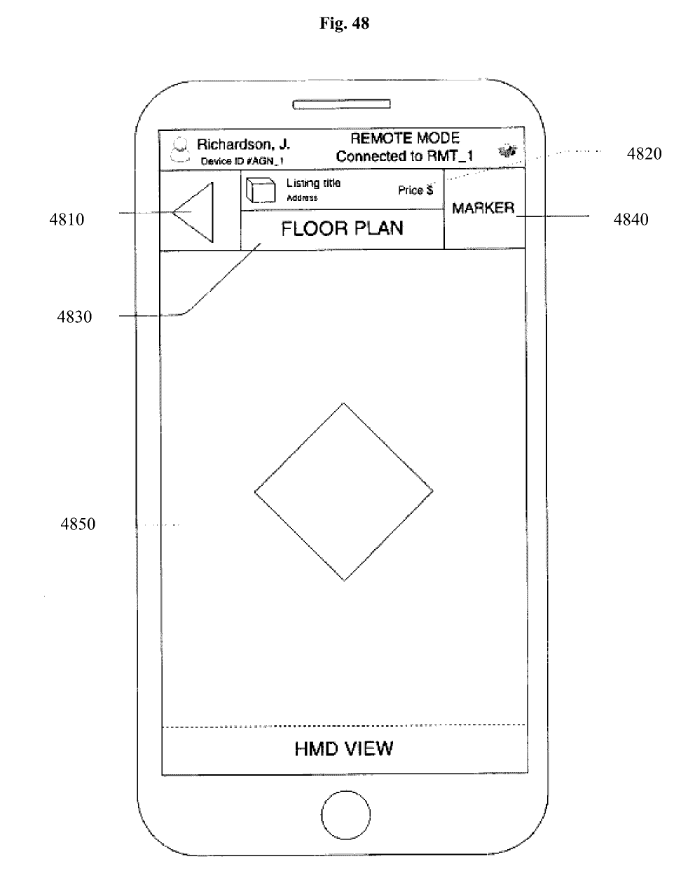

Referring to FIG. 48, in a particular embodiment, a remote mode of a VR tour mobile application is configured to allow the user to return back to the main menu 4810 while streaming a VR tour to a connected HMD device. The user is provided with listing information 4820 of the current streaming VR tour listing. The user further interacts with the tour by placing virtual markers 4840 onto the HMD view 4850 to direct the VR tour-taker's attention to a specific marked location in the VR tour. The user optionally accesses a floor plan by pressing the floor plan button 4830.

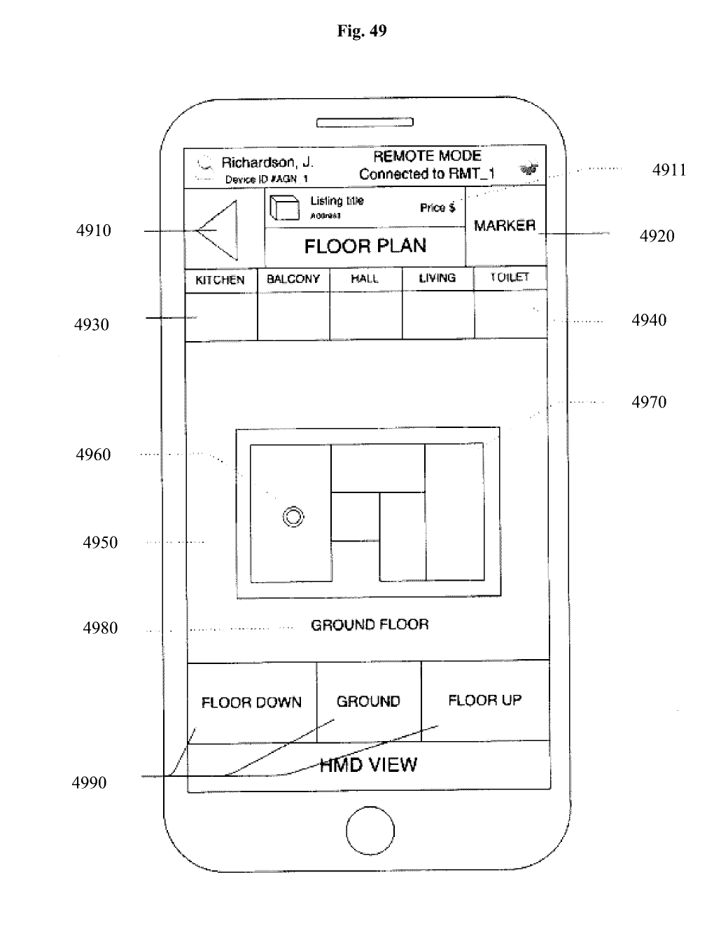

Referring to FIG. 49, in a particular embodiment, a floor plan view in remote mode of a VR tour mobile application is provided. In this embodiment, the user interface is configured to allow the user to return to the main menu 4910 and view the listing information 4911. The user optionally places markers 4920 onto the floor plan to direct the VR tour-taker's attention to a specific marked location in the floor plan. The user optionally selects vantage points 4930 from one or more vantage points 4940 in the floor plan. The user further views the connected HMD device view 4950 of the floor plan, comprising the current location in the VR tour 4960 in the floor plan 4970 of the current floor 4980. The user optionally selects to scroll through floors 4990 by increasing or decreasing floor levels or by returning to the ground floor.

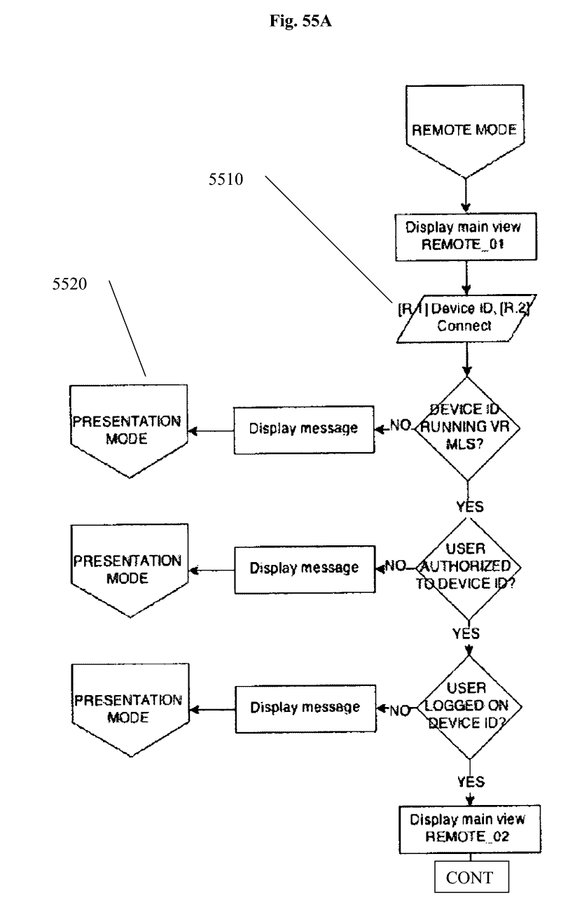

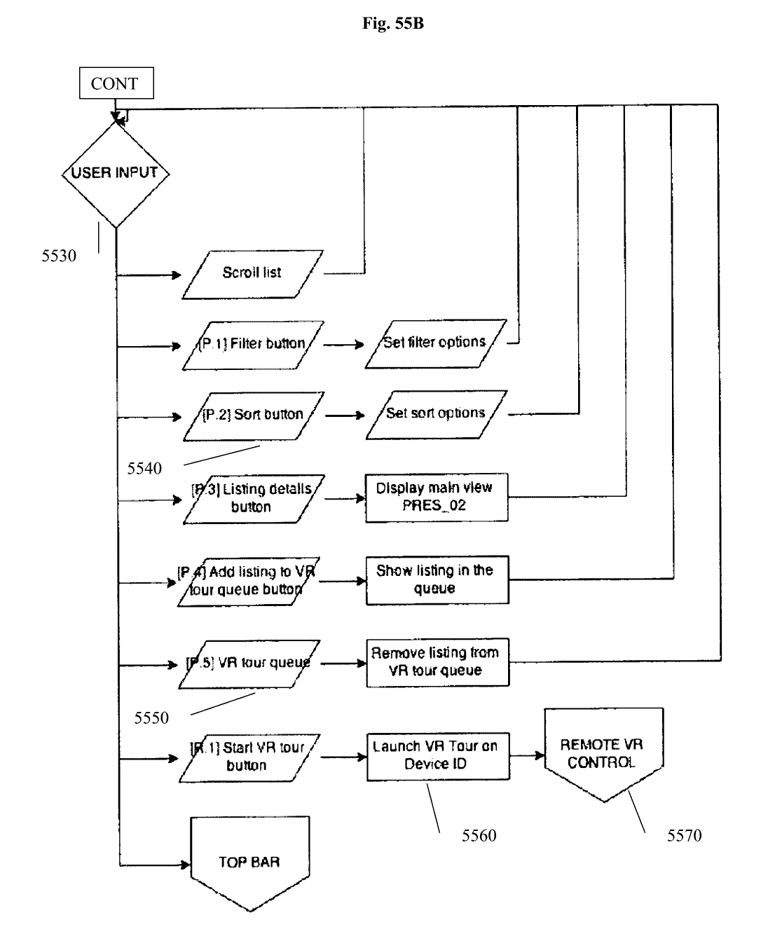

Referring to FIG. 55A and FIG. 55B, in a particular embodiment, a flow chart depiction of the states and actions of a remote mode selection for a VR tour mobile application is provided. In this embodiment, the application is configured to check if a device is connected 5510. If a device is connected but a user is not logged into the application, the application defaults into presentation mode 5520. If the device is connected and a user is logged into the application, the application responds to user input 5530 to scroll through, filter, sort, or expand the details 5540 of VR tour listings. The user further adds or removes 5550 VR tour listings to the queue. In remote mode, the user initiates a VR tour on the connected device 5560 when starting a VR tour and the user further controls the navigation of the tour in remote mode 5570.

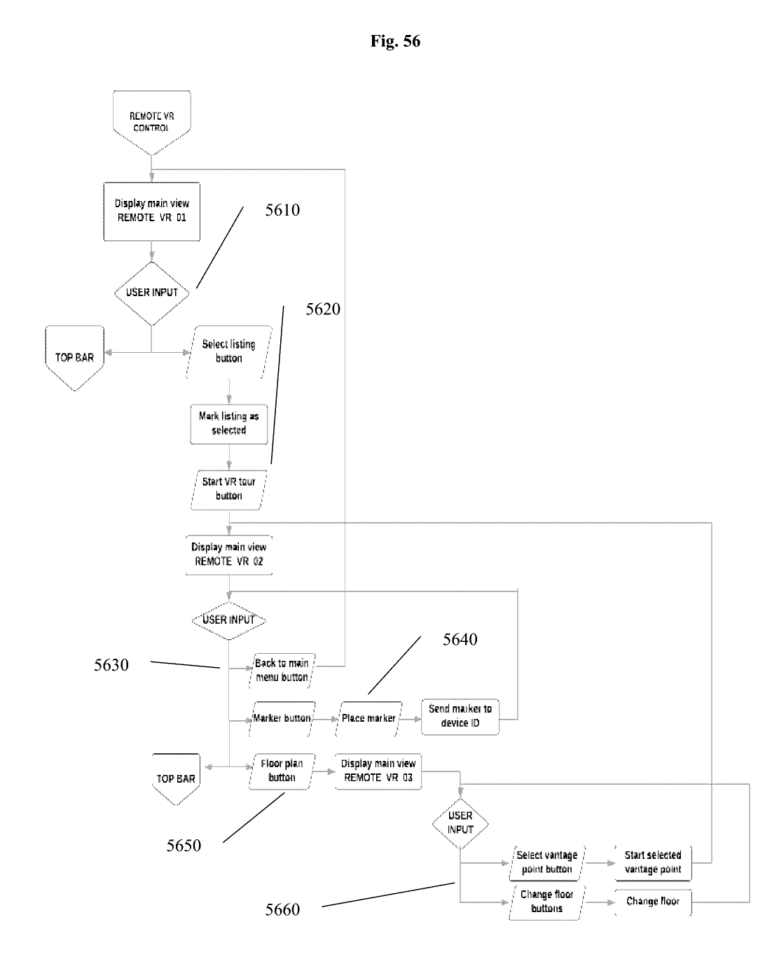

Referring to FIG. 56, in a particular embodiment, a flow chart depiction of the states and actions of a remote mode during VR control for a VR tour mobile application is provided. The control of a VR tour in remote mode is performed through a server or optionally through a direct connection. The control of the VR tour is performed through transmitting user input data, VR session data, camera angle, or a combination thereof to determine the state of the VR tour as observed through an HMD. In response to user input 5610, a user selects and begins a VR tour 5620 on a remote device. The user optionally returns to the main menu or elicits further actions in the tour 5630. Actions available to the remote control user include placing markers 5640 to direct the VR tour-taker's attention to a specific marked location in the VR tour or to access the floor plan 5650 of the VR tour. From the floor plan, the remote user directs the VR tour-taker to multiple vantage points 5660 throughout the floor plan.

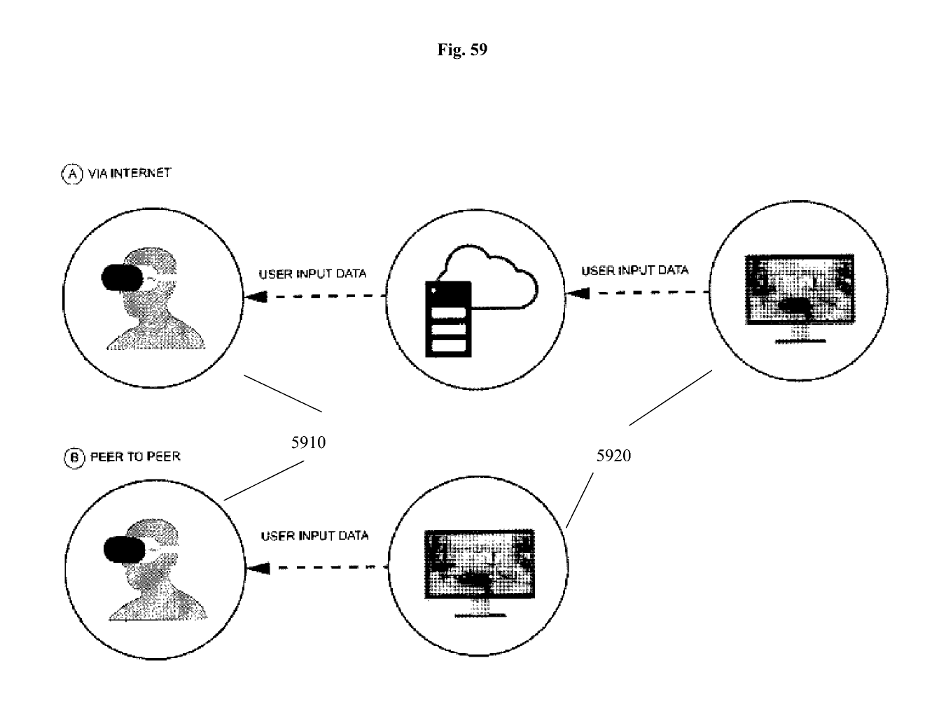

Referring to FIG. 59, in a particular embodiment, the control of a VR tour in an HMD by sending input commands through the Internet is provided. In this embodiment, a remote device 5920 sends input data through a data server or through a direct connection to a VR tour device 5910, in this instance, an HMD. Each device contains its own set of procedures for communication, and calling an action related to one of the procedures results in action on the current remote connected device.

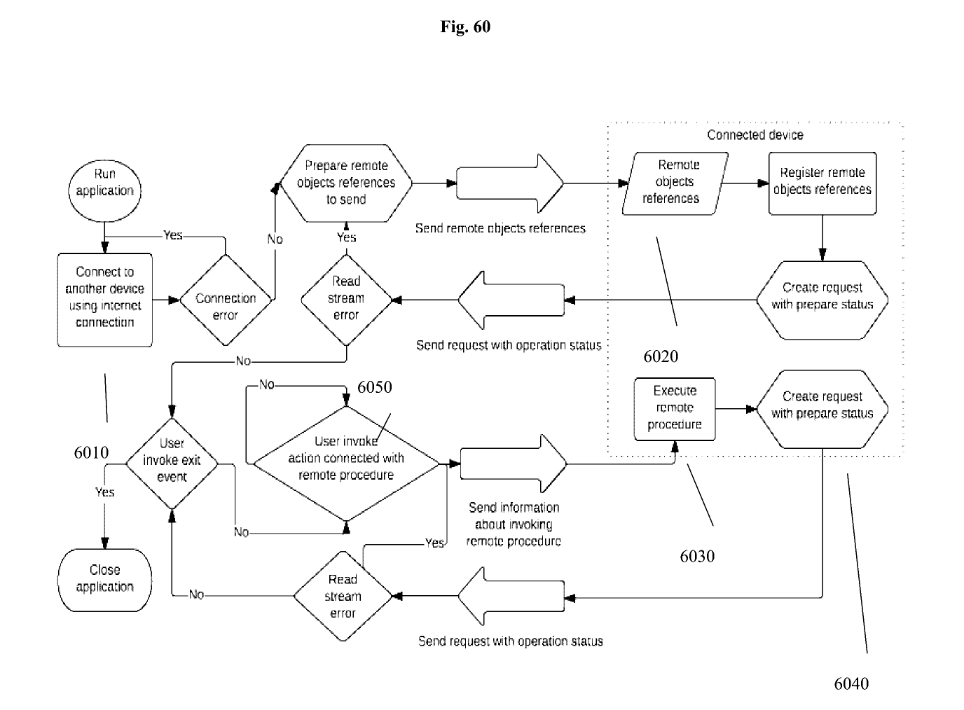

Referring to FIG. 60, in a particular embodiment, a flow chart process depiction of the executing a remote control mode is provided. In this embodiment, the application is configured to connect to another device 6010 through an Internet connection, whereby the remote device sends information that is processed by the connected device 6020. The remote device executes procedures 6030 on the connected device, which is executed and detected through an operation status 6040 sent back to the remote device. The connected device optionally executes its own procedures 6050, thereby preventing the remote device from activating procedures. In this manner, both devices share control of each other.

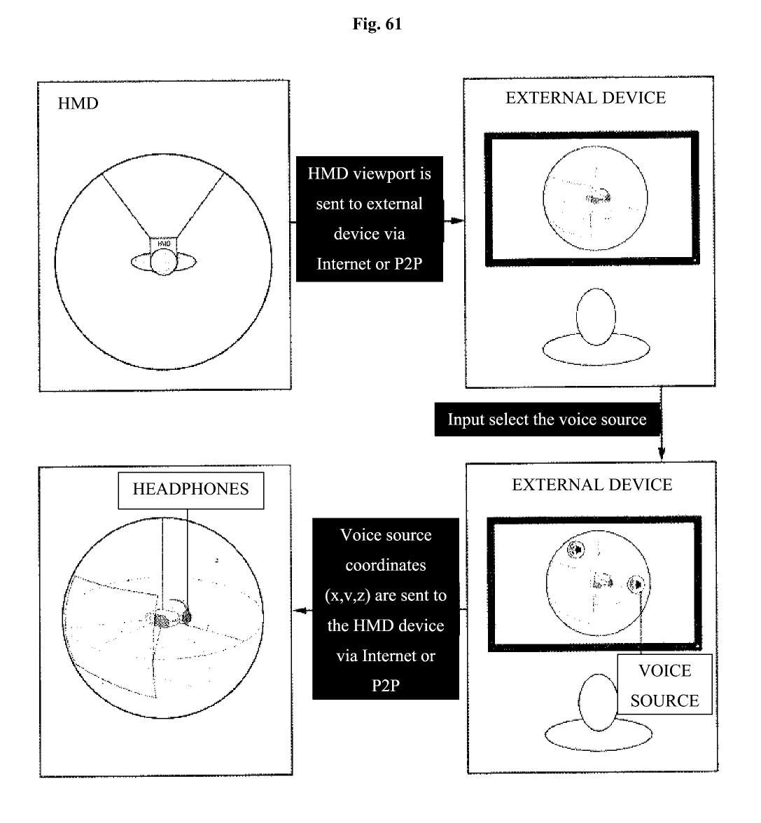

Referring to FIG. 61, in a particular embodiment, a schema depicting a method to control the source of voice in a VR tour from an external device is provided. In this embodiment, a voice source is coordinated and sent from a remote device. The HMD user hears the voice from a chosen point, thereby simulating the perception of space.

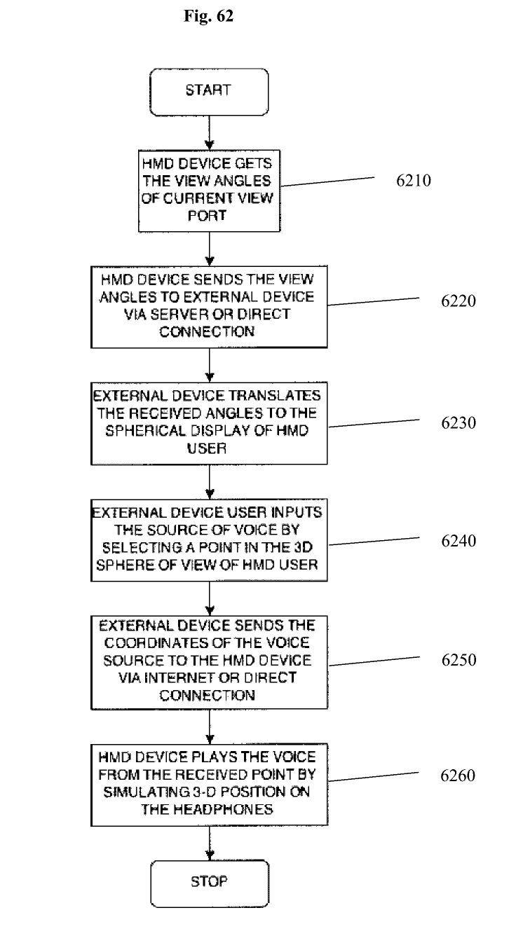

Referring to FIG. 62, in a particular embodiment, a flow chart process depiction of a method to control the source of voice in a VR tour from an external device is provided. In this embodiment, the current viewport 6210 of an HMD device is sent 6220 to an external device. The external device processes the coordinates 6230 of the HMD device viewport and inputs the voice clip 6240 into the spatially appropriate area of the viewport, which is then sent 6250 and played 6260 by the HMD device.

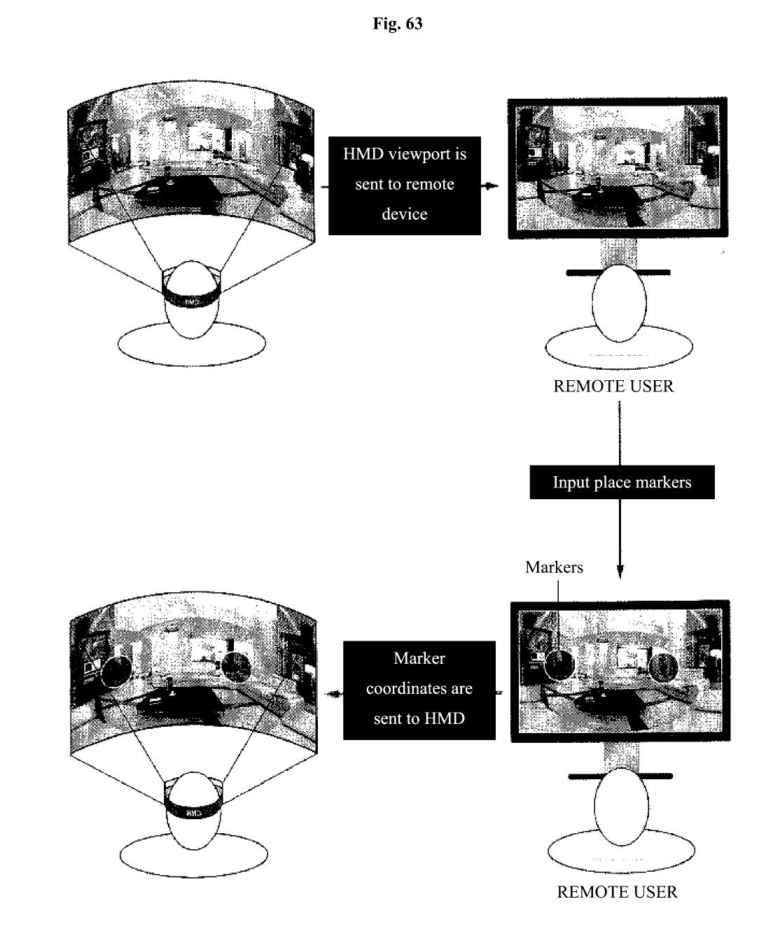

Referring to FIG. 63, in a particular embodiment, a remote user setting markers to attract VR tour user attention to a certain area on HMD displayed content is provided. In this embodiment, a user in remote mode of the VR tour application attracts the attention of a user engaging in a VR tour on an HMD device. Data describing the current view of the HMD user comprising VR session data or camera angle is sent to the remote user. The remote user places markers on the preview of the remote screen, and the coordinates of the markers are sent to the HMD application through a server or through direct connection. The HMD user then sees markers as overlays on the presented VR content.

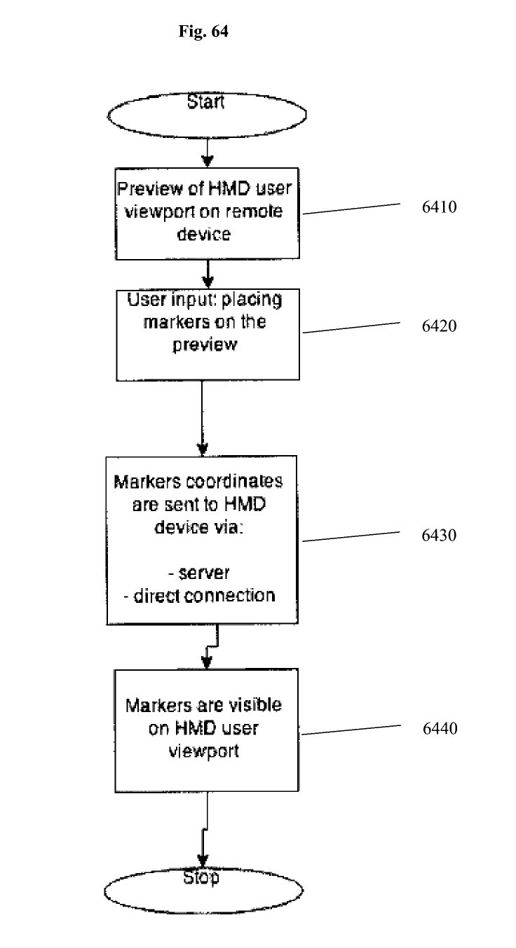

Referring to FIG. 64, in a particular embodiment, a flow chart process depiction of remotely setting markers to attract VR tour user attention is provided. In this embodiment, the HMD viewport is shared with the remote device 6410 and the remote device user places markers on the viewport of the remote device 6420 to preview the markers. The marker coordinates are sent to the HMD device 6430 through a server or optionally a direct connection, whereby the markers are visible 6440 in the pre-set location in the HMD viewport.

### HMD Application

In some embodiments, the platforms, systems, media, and methods described herein include n HMD application, or use of the same. In some embodiments, the HMD application controls the display and actions of a VR tour with an HMD device.

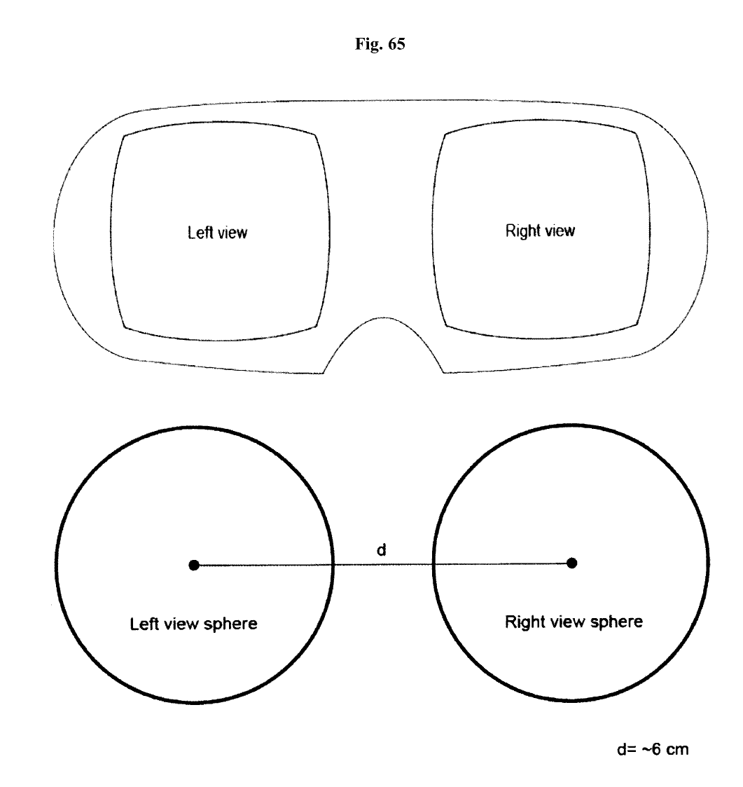

Referring to FIG. 65, in a particular embodiment, a schema of the display of an HMD device is provided. In this embodiment, the HMD device comprises a left view and a right view, each with an associate view sphere.

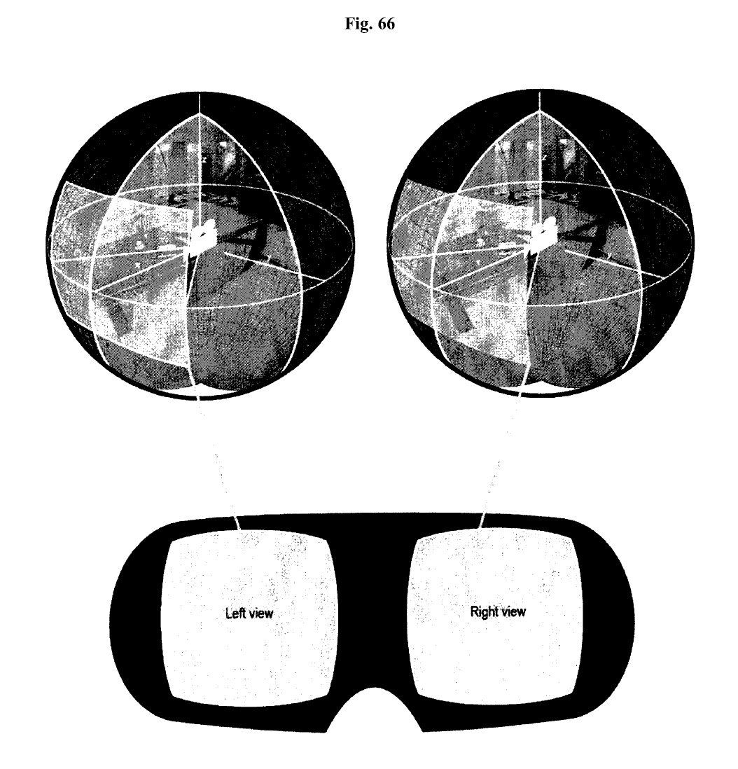

Referring to FIG. 66, in a particular embodiment, initiation of playback of VR content on a view sphere of an HMD device is provided. In this embodiment, user selected VR content is downloaded as VR textures, which are then applied to the view sphere. For each eye, a separate VR texture view sphere is provided. The middle of each view sphere contains virtual cameras configured to display separate images for each eye view in the HMD device.

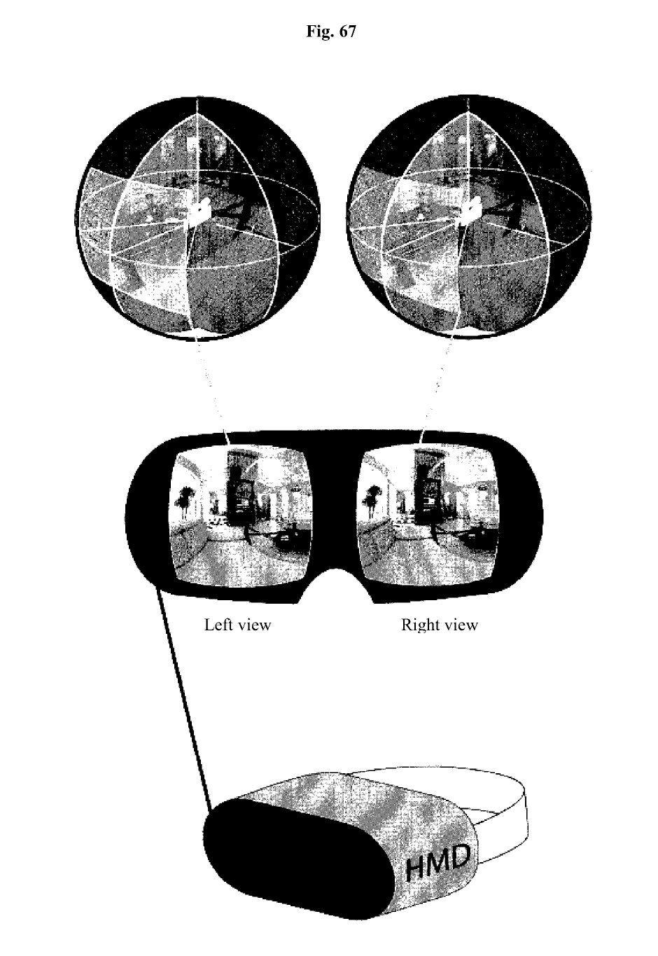

Referring to FIG. 67, in a particular embodiment, the left view and right view of an HMD device is configured to display separate view spheres of VR content.

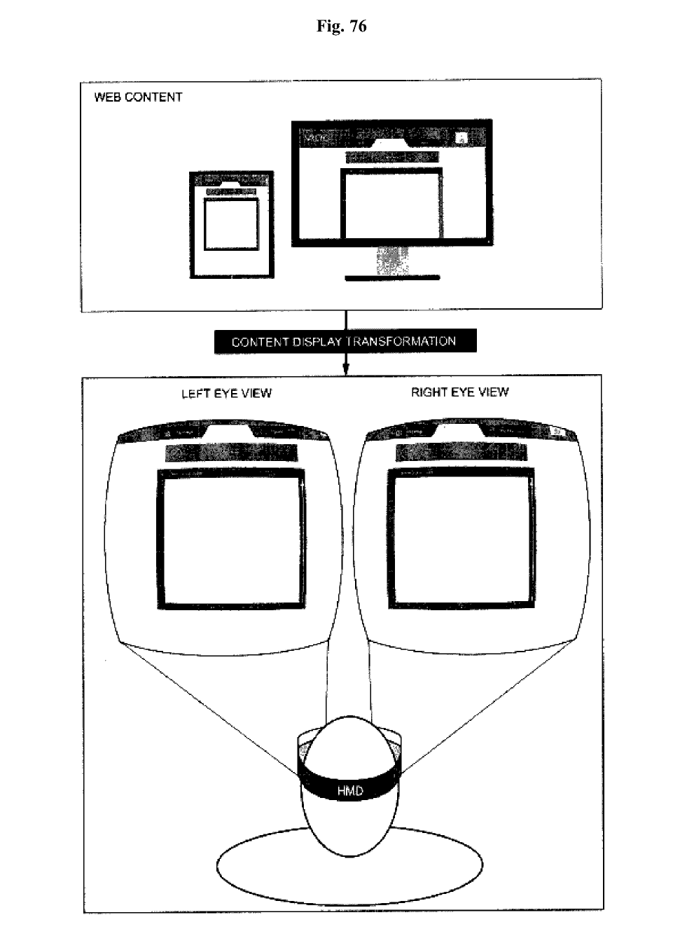

Referring to FIG. 76, in a particular embodiment, web content transformation for display in an HMD application is provided. In this embodiment, web content is transformed into a view sphere with separate left eye and right eye views to be displayed in a 3D VR tour setting using an HMD.

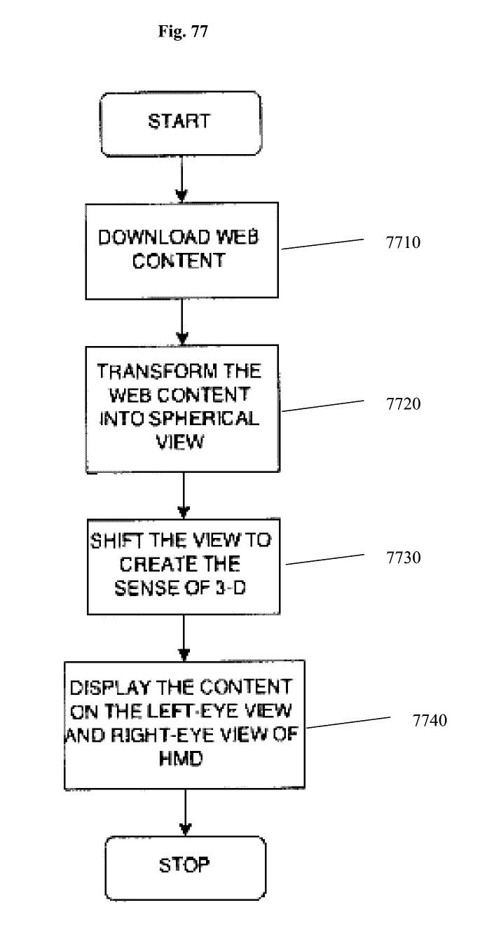

Referring to FIG. 77, in a particular embodiment, a flow chart process depiction of web content transformation for display in an HMD application is provided. In this embodiment, web content is downloaded 7710 by the HMD device and transformed 7720 into a spherical view to create a 3D environment 7730 to be displayed on the left eye and right eye viewports 7740 of the HMD device.

### Floor Plan

In some embodiments, the platforms, systems, media, and methods described herein include n floor plan, or use of the same. In some embodiments, a floor plan is a 2D graphical map of the VR tour environment or surrounding environment. In other embodiments, the floor plan is used for user orientation. In other embodiments, the floor plan is used to navigate between vantage points.

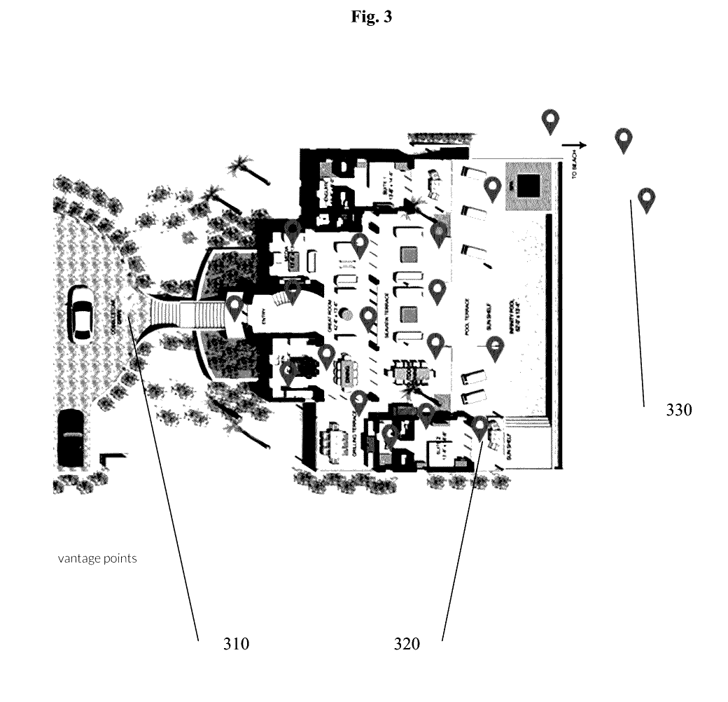

Referring to FIG. 3, in a particular embodiment, a 2D floor plan is presented displaying the currently selected vantage point 310 and other pre-assigned vantage points 320 in the VR tour. Vantage points further appear outside the property 330 in the surrounding environment.

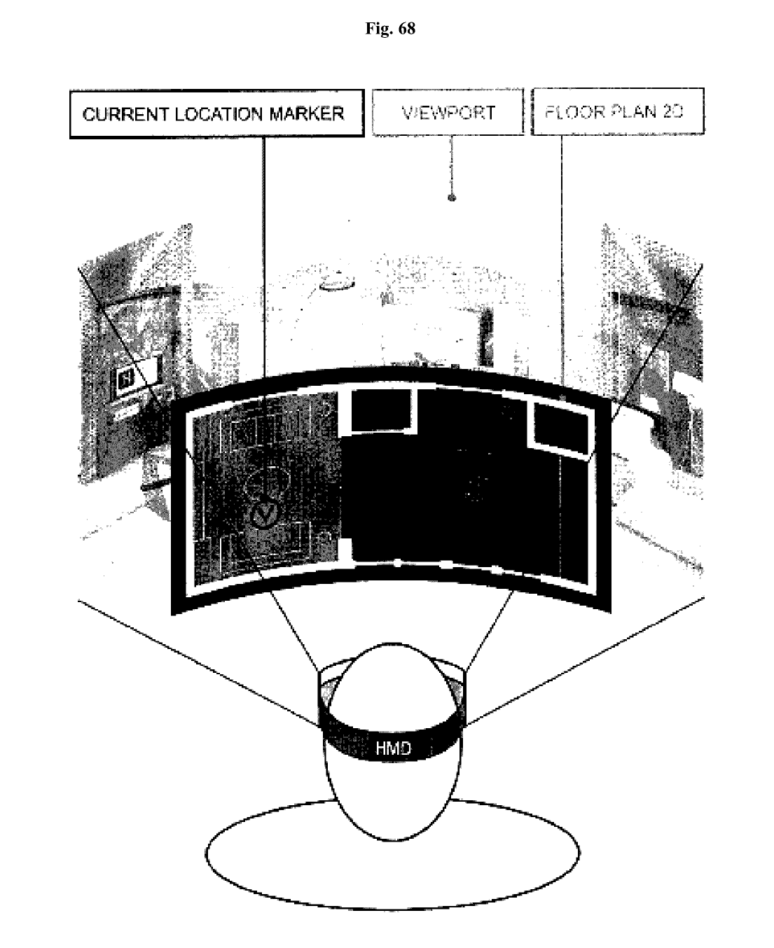

Referring to FIG. 68, in a particular embodiment, the display of 2D floor plans in a VR tour is provided. In this embodiment, a user is viewing a VR tour and opens a 2D floor plan for self-orientation. The user's present location is provided on the floor plan, and the user is provided markers for other vantage points in the floor plan. The user optionally selects other vantage point markers to navigate through the VR tour.

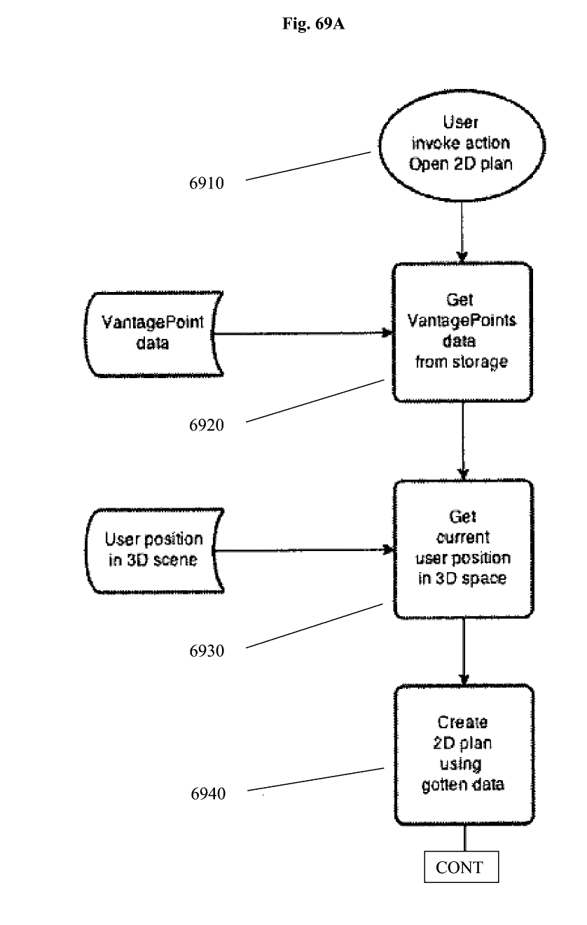

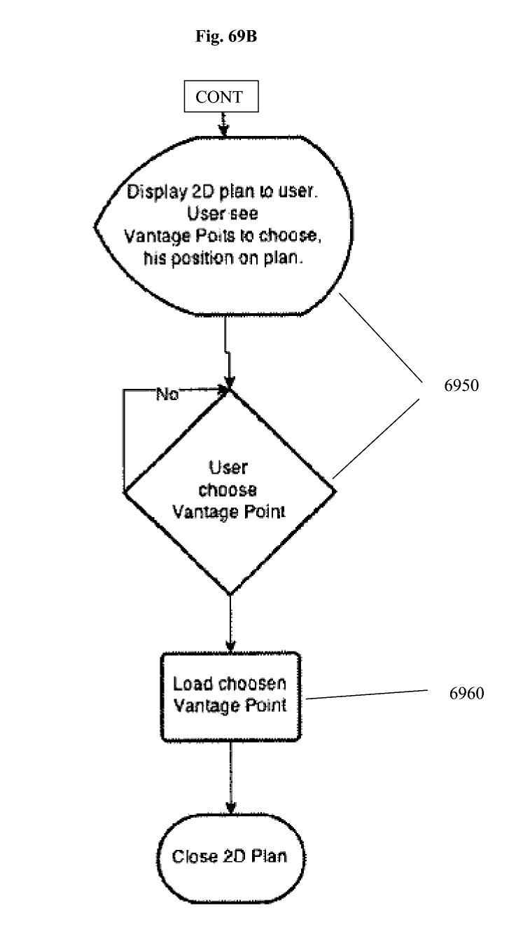

Referring to FIG. 69A and FIG. 69B, in a particular embodiment, a flow chart process for selecting vantage points from a floor plan is provided. In this embodiment, upon opening a 2D floor plan 6910 in an HMD application, vantage points 6920 and the user's current location 6930 are displayed onto the floor plan as observed by the user 6940. The user chooses between available vantage points 6950 on the floor plan and is taken to that vantage point 6960 in the VR tour.

### Virtual Reality (VR) Object

In some embodiments, the platforms, systems, media, and methods described herein include VR objects, or use of the same. In some embodiments, a VR object is an asset comprising information about non-VR texture objects but is displayed in a VR environment. In some embodiments, VR objects are created through the use of a computer. In other embodiments, VR objects are created through the use of an HMD. In further embodiments, VR objects are actionable objects within a VR tour. Many suitable implementations of VR object actions are contemplated, including, but not limited to, changing vantage points, displaying additional information, displaying additional content, displaying an advertisement, or displaying other VR objects. In further embodiments, VR objects are interactable objects within a VR tour. Many suitable implementations of VR object interactions are contemplated, including, but not limited to, counting the time a user interacts with an object, counter the number of times a user interacts with an object, moving an object, rotating an object, or centering a viewport on an object.

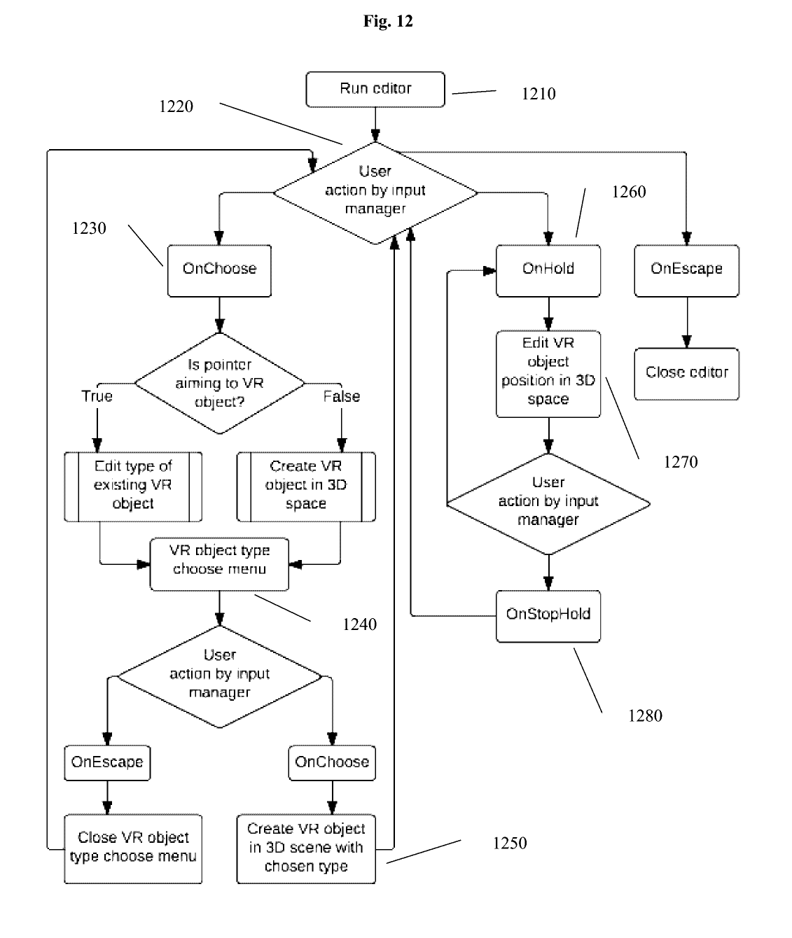

Referring to FIG. 12, in a particular embodiment, a flow chart for an application for creating and editing VR objects with an HMD is provided. In this embodiment, a user launches the editor 1210 and looks at a desired direction and uses an input controller 1220 to select the “OnChoose” 1230 process. From a menu, the user selects the desired object, which is saved in the HMD memory in 3D coordinates. The user optionally saves the VR object in solid memory. The user now has the ability to edit the VR object by selecting the VR object to change the properties and type 1240 of the VR object and place the VR object within a 3D VR environment 1250. To transform the position of the VR object, the user engages “OnHold” 1260 and moves the viewport 1270 until the object is in the desired location to drop the object using “OnStopHold” 1280. The user optionally changes distance of the VR object while transforming the object. To delete the VR object, the user engages “OnHold” 1260 and transforms an object to a deletion zone, then subsequently drops the object using “OnStopHold” 1280 to confirm the deletion.

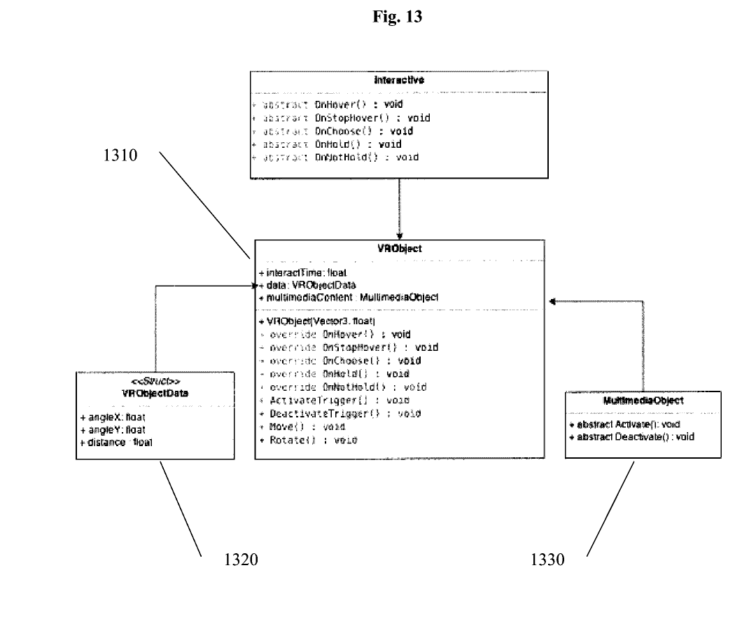

Referring to FIG. 13, in a particular embodiment, the data log 1310 for user activated VR object editing is provided. In this embodiment, the VR object 1320 is configured to associate with multimedia objects 1330 to enable navigation, interaction, advertising, and marketing using VR objects in VR tours.

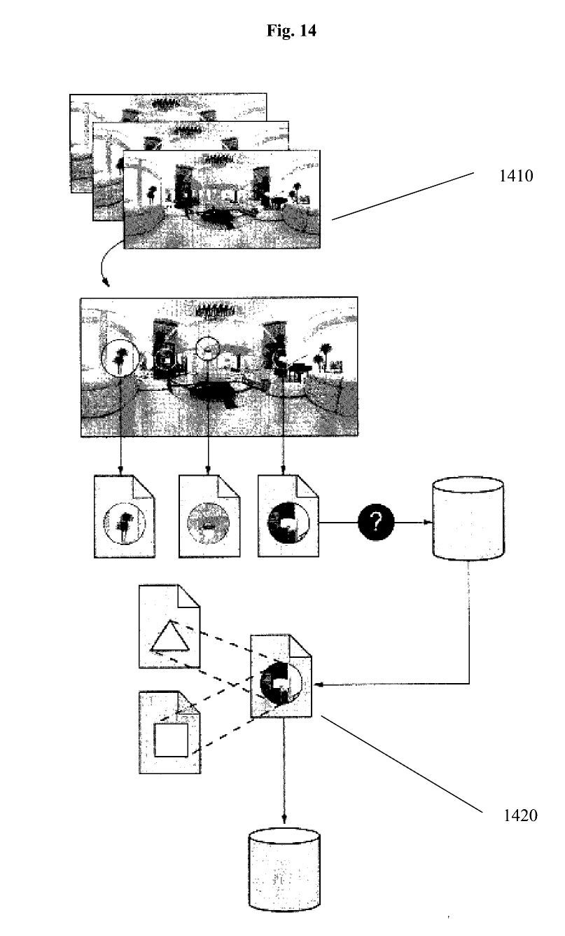

Referring to FIG. 14, in a particular embodiment, the automatic recognition of VR objects is provided. In this embodiment, assets 1410 are processed and analyzed for common features in regions of interest 1420 in image fragments. The metadata is sent to a database for classification and comparison.

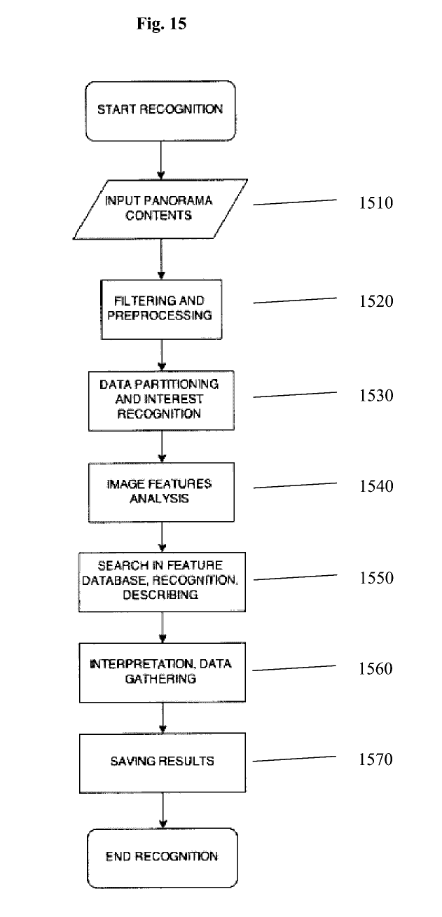

Referring to FIG. 15, in a particular embodiment, a flow chart depicting a process for the automatic recognition of VR objects is provided. In this embodiment, uploaded assets 1510 is filtered 1520 and converted to image fragments and regions of interest 1530. The image fragments are analyzed for image features 1540 including, but not limited to, line, space, shape, form, color, texture, value, unity, harmony, variety, balance, emphasis, rhythm, movement, pattern, gradation, and proportion. The features of each image is compared to other image fragments 1550 and connections between matching fragments 1560 are automatically generated and saved 1570 to create a VR scene from multiple assets containing the same VR object.

### Hotspot

In some embodiments, the platforms, systems, media, and methods described herein include hotspots, or use of the same. In some embodiments, a hotspot is a VR object for navigation between vantage points in a VR environment.

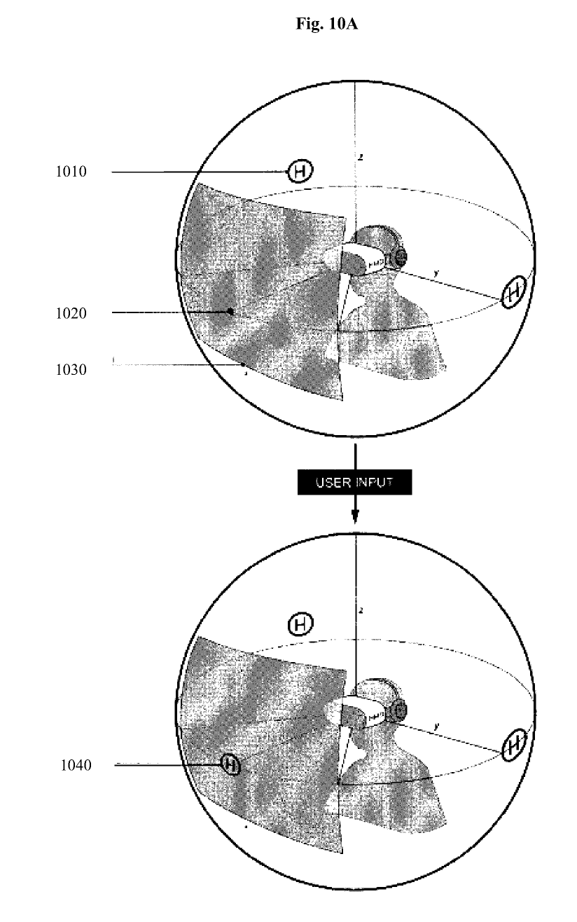

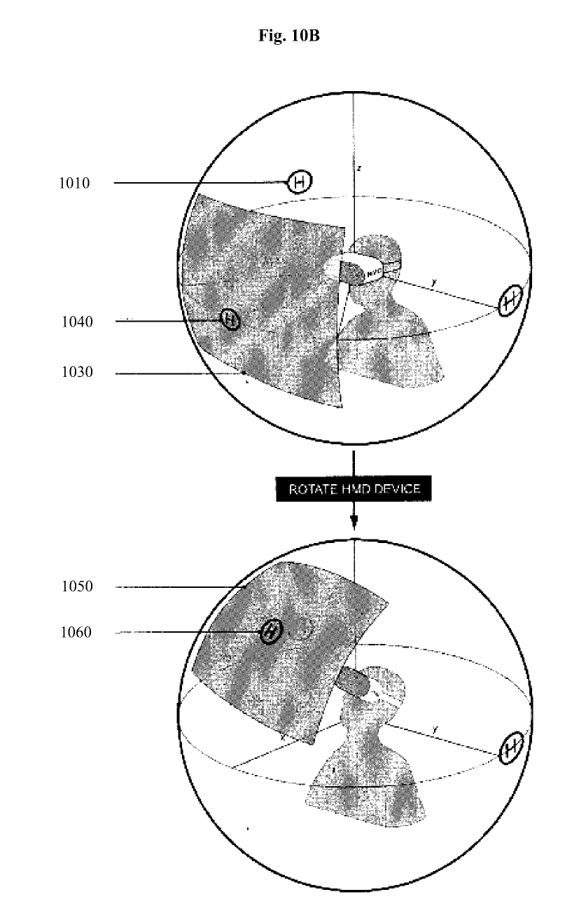

Referring to FIG. 10A and FIG. 10B, in a particular embodiment, the use of an HMD to create and edit hotspots 1010 is provided. In this embodiment, a user looks in a desired location and focuses on a specific location 1020 within a user's viewport through an HMD 1030. The user accesses a menu to create a new focus point hotspot 1040. When the viewport is rotated 1050 with the head movement of the user, the focus point hotspot rotates 1060 with the viewport.

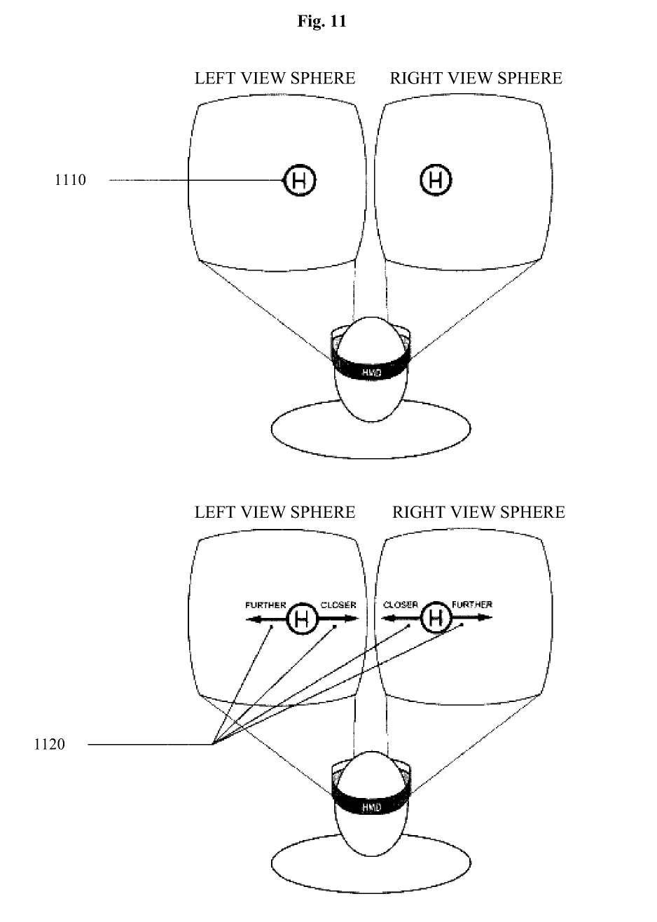

Referring to FIG. 11, in a particular embodiment, an HMD is used to edit a hotspot 1110 by creating hotspot depth through user input 1120. Depth is created by placing the hotspot closer or further 1120 along the field of view in the viewport.

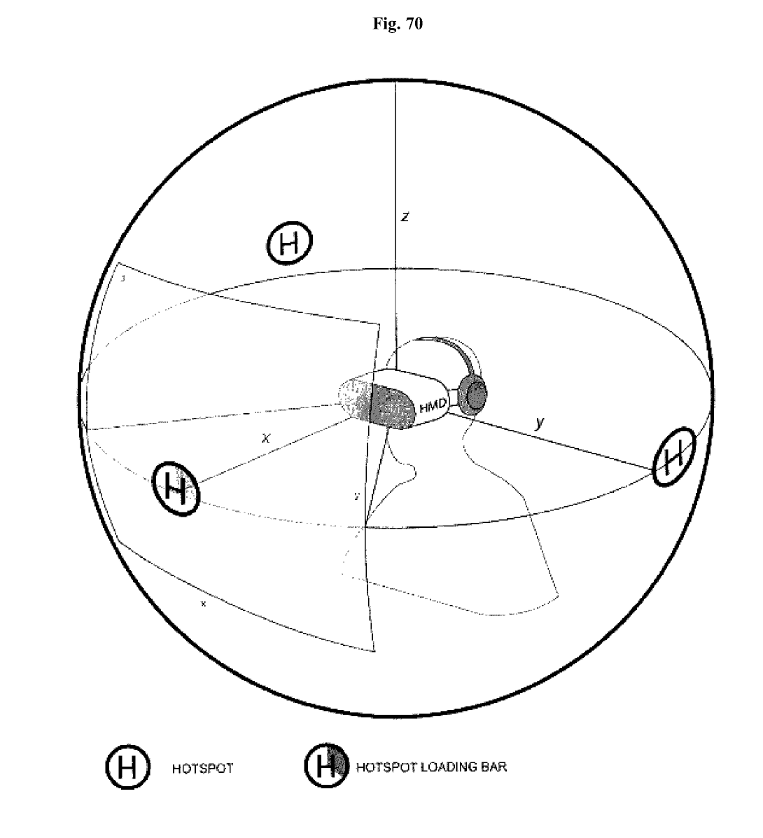

Referring to FIG. 70, in a particular embodiment, the navigation of a VR tour through interaction with hotspots is provided. In this embodiment, the currently presented VR scene through an HMD device includes hotspots. The specific hotspot a user is focused on is the focus point of the viewport. The user interacts with the hotspot by looking at the hotspot for a certain amount of time without changing focus area or by selecting the hotspot and invoking an event interaction. The interaction and activation of a hotspot transfers the user to another VR scene.

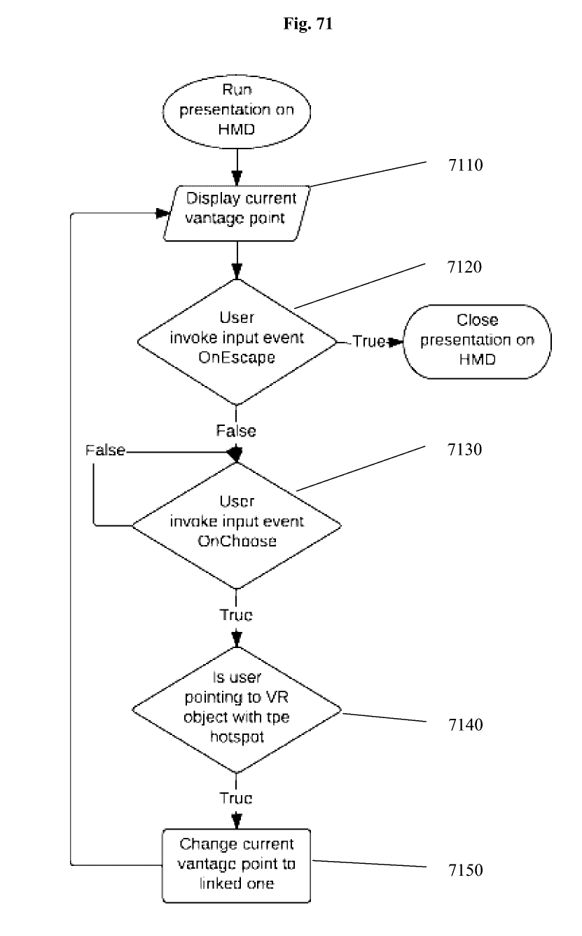

Referring to FIG. 71, in a particular embodiment, a flow chart process depiction of navigation of a VR tour through interaction with hotspots is provided. In this embodiment, a user in a VR tour on an HMD device 7110 viewing a current vantage point invokes “OnEscape” 7120 to exit out of the presentation. If the user does not want to exit the presentation, the user optionally moves between vantage points by invoking “OnChoose” 7130 while focusing on a hotspot 7140 to be transported to viewport of the vantage point 7150 associated with that hotspot.

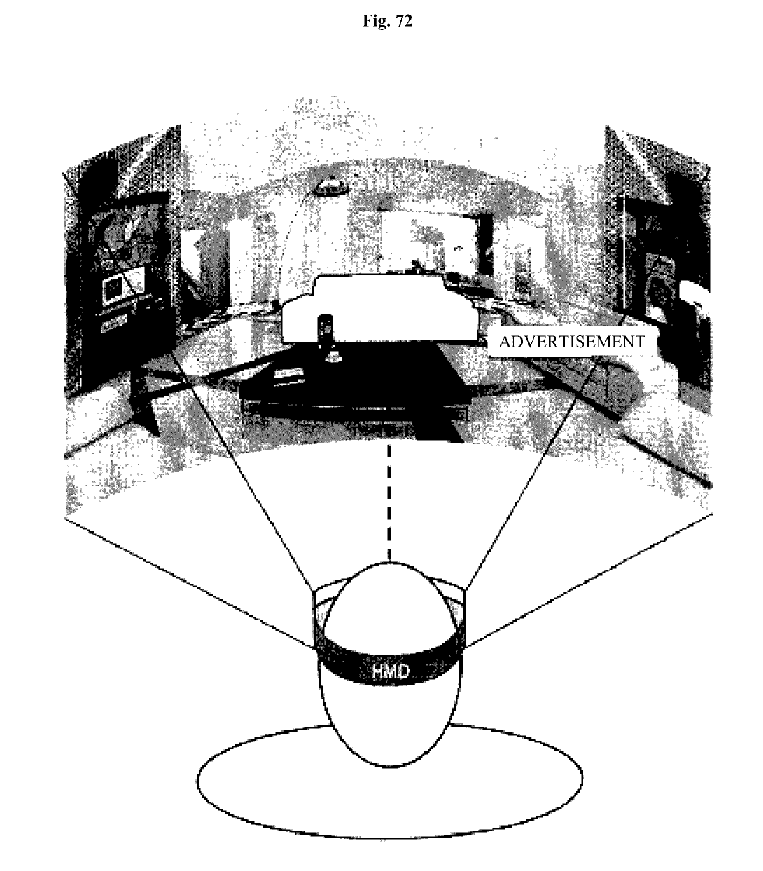

Referring to FIG. 72, in a particular embodiment, the display of advertisements in a VR tour through interaction with user-focused objects is provided. In this embodiment, a user focuses on a hotspot or VR object. Upon successful interaction and activation, an advertisement, in the form of sponsored objects, graphics, or videos, are displayed in a pre-defined active area of the VR tour.

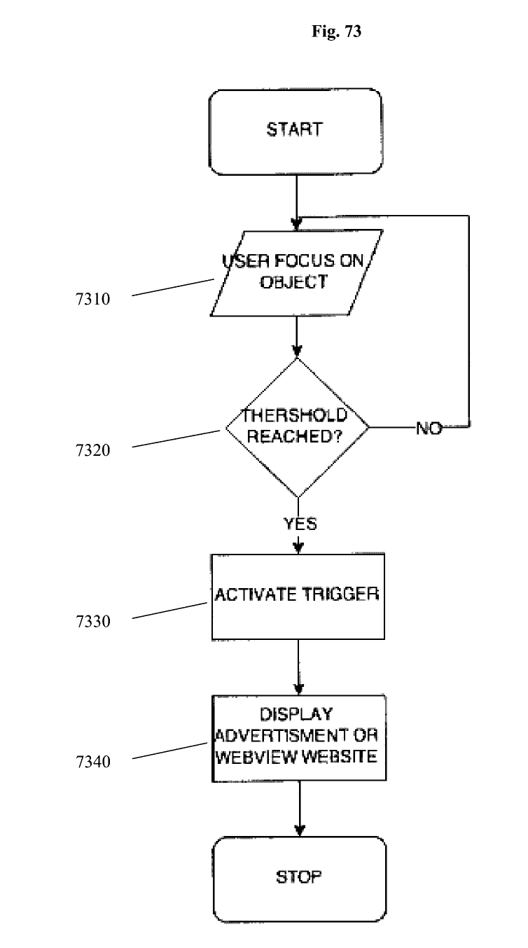

Referring to FIG. 73, in a particular embodiment, a flow chart process depiction of the display of advertisements in a VR tour through interaction with user-focused objects is provided. In this embodiment, a user focuses on an object 7310. If the amount of time the user focuses on the object meets a predetermined threshold 7320, the application triggers 7330 an advertisement 7340 to play at the user's focal point.

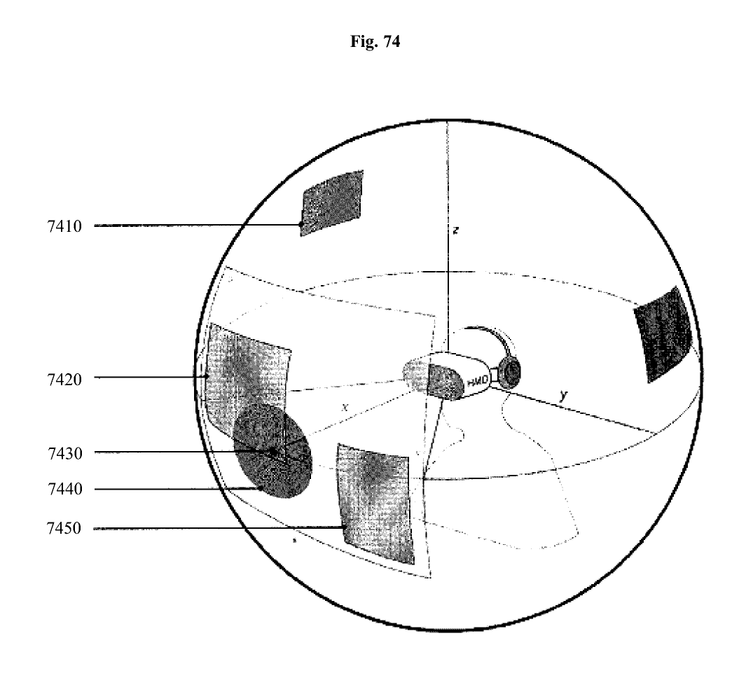

Referring to FIG. 74, in a particular embodiment, the interaction of VR objects by analyzing cumulative focus time is provided. In this embodiment, VR objects fall inside 7420 or outside 7410 a focus area 7440 of the viewport. The user focus point is the center of the HMD viewport 7430. VR objects within the focus area 7450 or under a focus point 7430 are assigned a timestamp to a focus time variable. If the focus time value is above a threshold value, an assigned action is automatically executed.

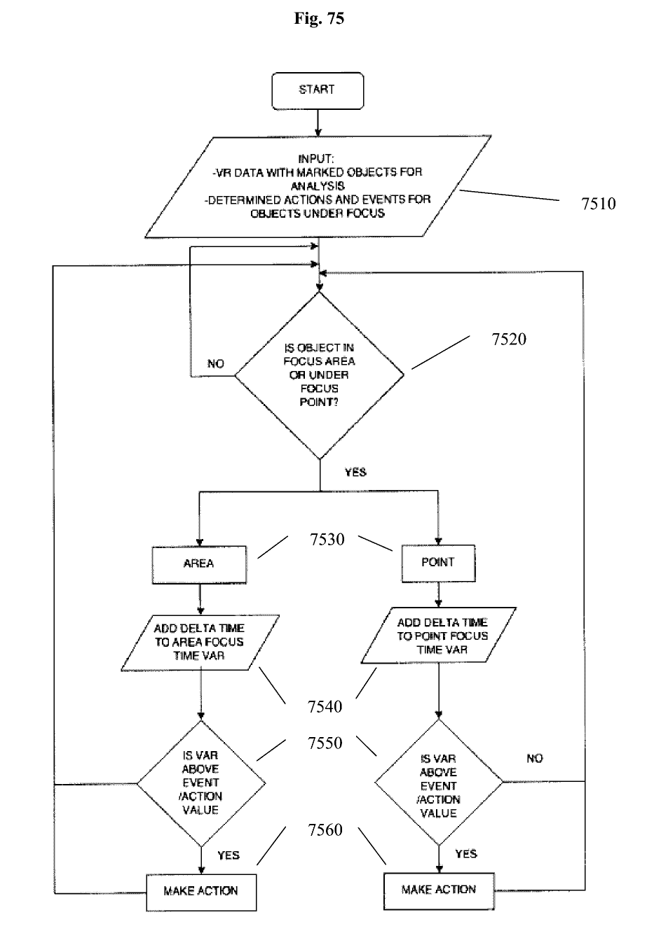

Referring to FIG. 75, in a particular embodiment, a flow chart process depiction for the interaction of VR objects by analyzing cumulative focus time is provided. In this embodiment, VR objects associated with focus events 7510 are determined if they fall within the range of a user's focus 7520. If the object falls within the user's focal area or focal point 7530, a timestamp 7540 is attributed to that object. If the user focuses on that object for longer than a threshold time 7550, an action 7560 associated with that object is triggered.

### Virtual Reality (VR) Session Data

In some embodiments, the platforms, systems, media, and methods described herein include VR session data, or use of the same. In some embodiments, VR session data are data structures used to store information about a current VR tour. Many suitable implementations of VR session data structures are contemplated, including, but not limited to, device ID, tour ID, vantage point ID, session token, session state data, timestamp, x angle of HMD, y angle of HMD, and user input.

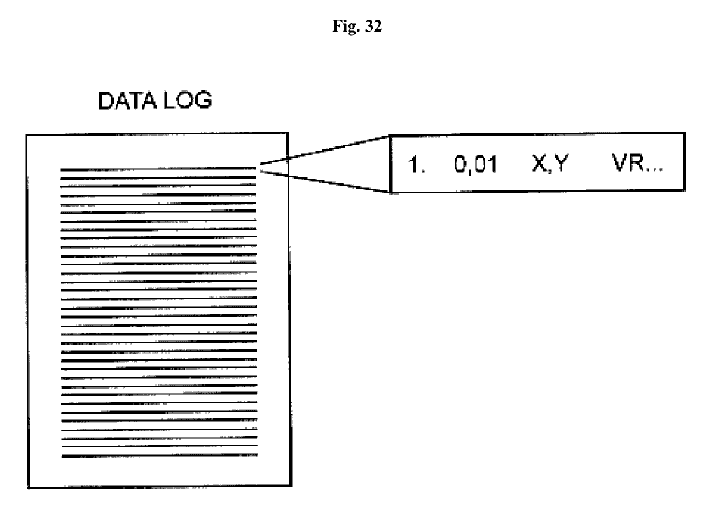

Referring to FIG. 32, in a particular embodiment, VR session data is saved and stored in a data log. In this embodiment, the data log represents timeline frames, from which statistical analyses are performed. In addition, the data log enables the extraction of time-based information such as user reactions and behavior in order to create heat maps by cumulating the view data, to correlate user view focus changes in time with specific VR objects, to conduct high level analysis charts across sessions, and to provide data for machine learning algorithms.

### Heat Map

In some embodiments, the platforms, systems, media, and methods described herein include a heat map, or use of the same. In some embodiments, a heat map is a mathematical distribution of user focus during a VR tour. In other embodiments, a heat map is generated through applying a Gaussian function. In further embodiments, a heat map is generated using VR session data. VR session data structures to generate a heat map include, but are not limited to, the length of time a user focuses on a VR object and the number of user focus repeats or interactions with a VR object.

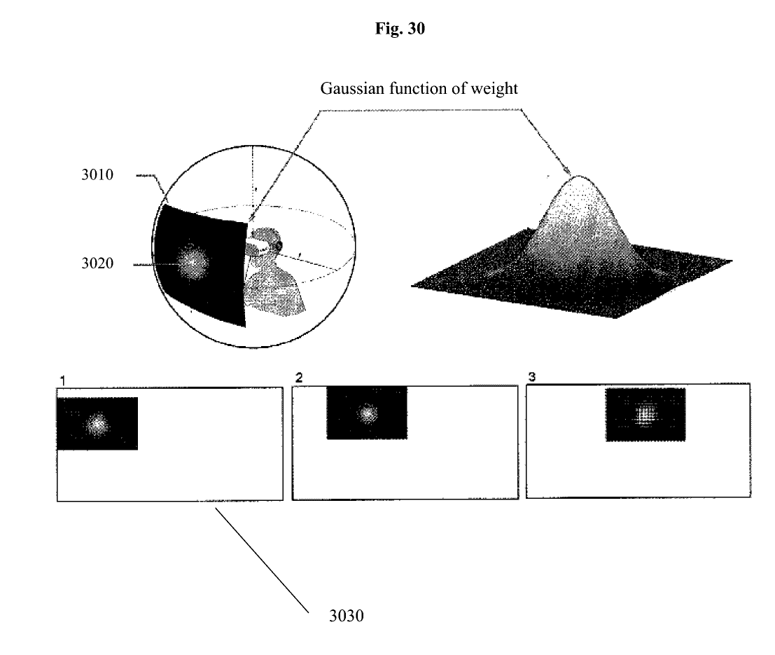

Referring to FIG. 30, in a particular embodiment, generation of a heat map from user focused views through an HMD is provided. In this embodiment, a user's eye movement is tracked throughout the viewport 3010 of an HMD. The user's view data is weighted based on the distance from the center of the user's view 3020 in the viewport. The weights are assigned by using a Gaussian function. Cumulative user view data over time is used to generate further heat maps 3030 of user view focus.

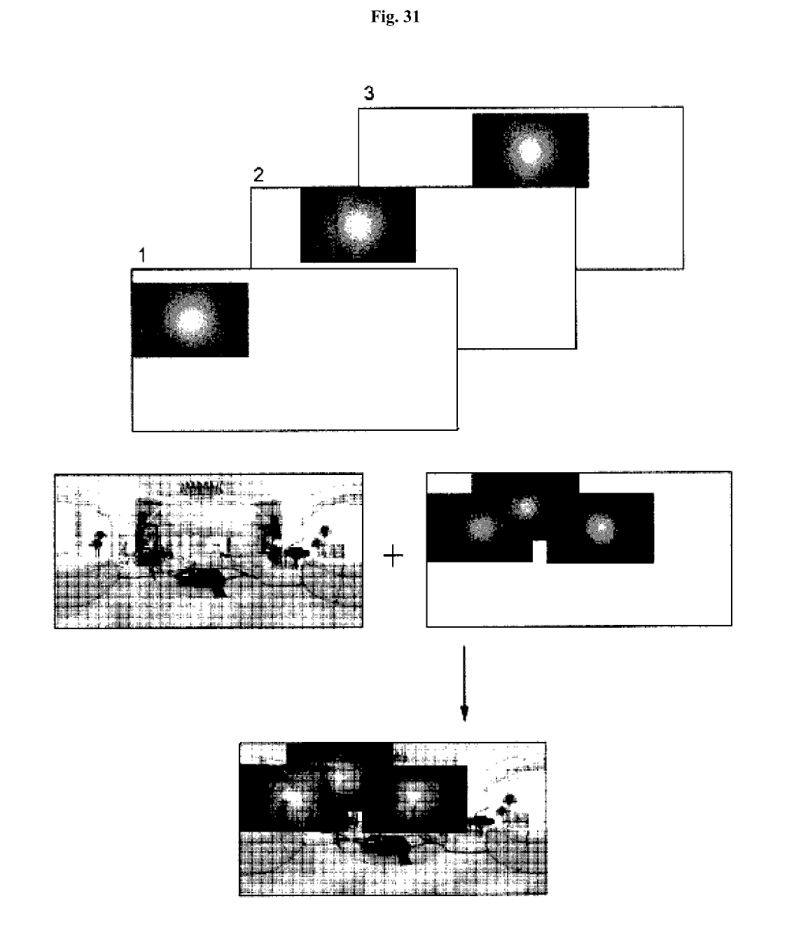

Referring to FIG. 31, in a particular embodiment, the heat maps of user view focus is displayed as an overlay onto the VR content of a VR tour.

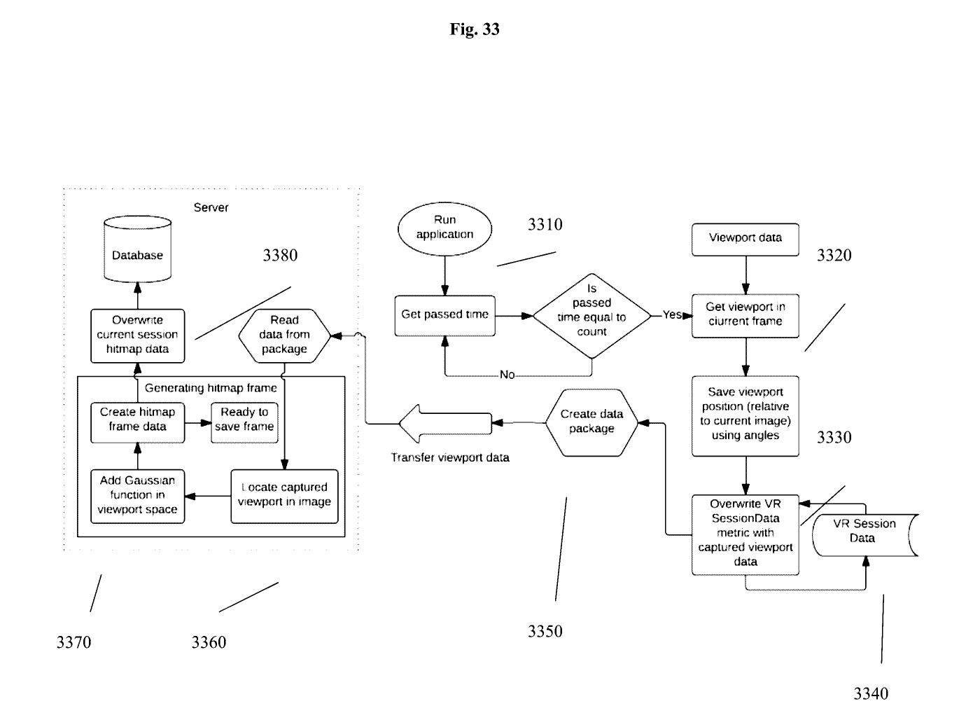

Referring to FIG. 33, in a particular embodiment, a flow chart depiction of the systems, media, methods, and platforms of the improved virtual reality tour and associated analytics for capturing VR session data configured to store the data on a server database is provided. In this embodiment, the application tracks the time 3310 a user focuses on a particular viewport frame 3320. The time tracked is associated with the viewport frame and is captured 3330 and stored as VR session data 3340. This data is transferred 3350 to a server, wherein a Gaussian function is applied 3360 to the viewport frame and a heat map is created 3370. Cumulative heat map data is saved and stored 3380 in a database.

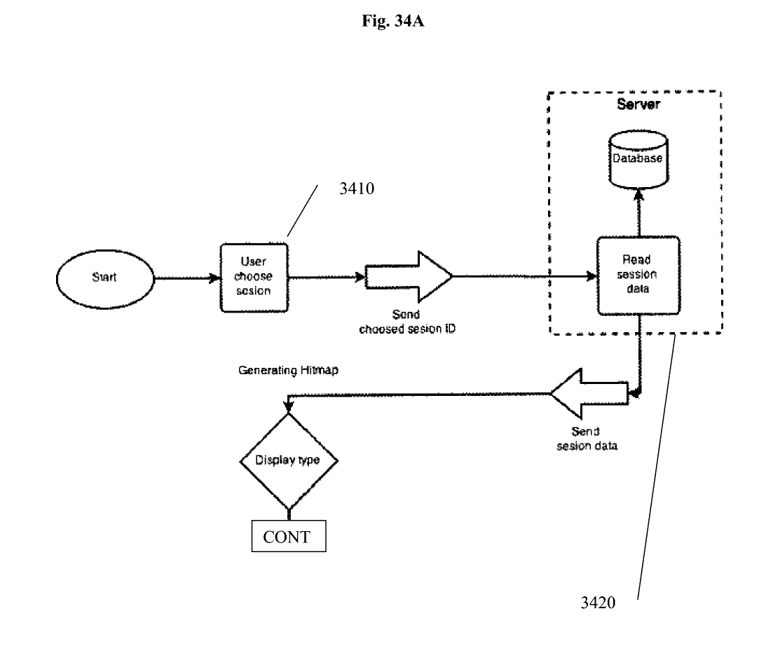

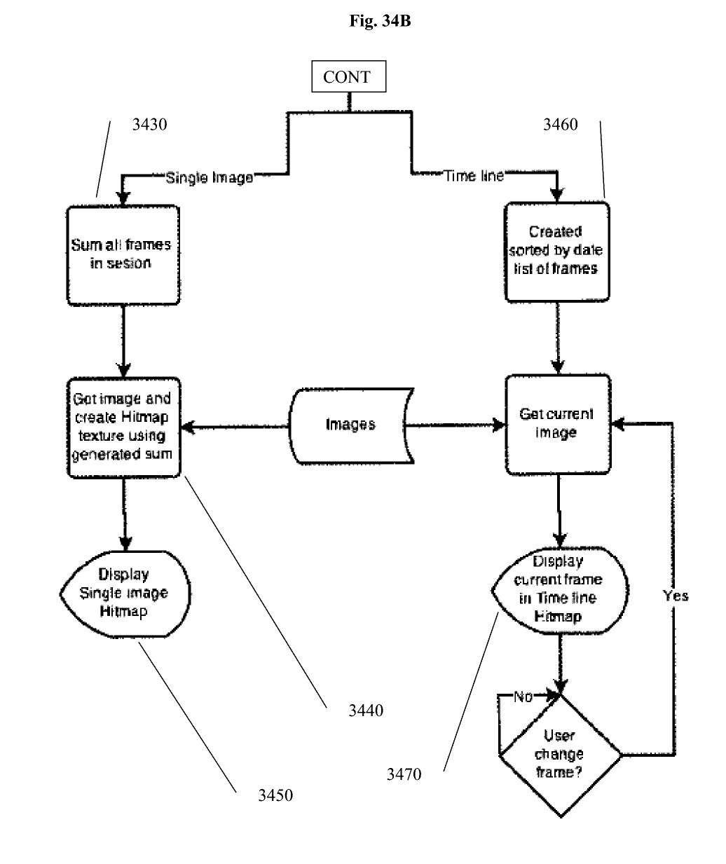

Referring to FIG. 34A and FIG. 34B, in a particular embodiment, a flow chart depiction of the systems, media, methods, and platforms of the improved virtual reality tour and associated analytics for retrieving VR session data from a server database to update the data is provided. In this embodiment, heat map data from a previous session is selected 3410 and read 3420 from a database server. The VR session data is used to generate a cumulative 3430 heat map compiled across sessions 3440 to create a unified multi-session heat map 3450 of a particular viewport frame. Alternatively, VR session data is analyzed as a timeline 3460 to generate a heat map view over time 3470 of a particular viewport frame.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux′, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft® Xbox One®, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of virtual reality information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Administration of the Content Management System

A real estate developer wants to create a virtual tour for his development. He logs onto the Content Management System (CMS) website, where he uploads and manages multimedia content. The CMS allows him to input content, create virtual tours, create guidelines for virtual tours, manage content, manage user account, manage multiple user accounts, order extra services, and contact providers, amongst other features. After uploading some 2D floor plan images and 3D video content, the developer selects to automatically create a VR tour. The VR tour is created, and the developer creates guidelines for the tour. He assigns multiple vantage points and hotspots to transition between rooms and angles of the tour content and links them to specific areas of a floor plan. The tour is now ready to be viewed by a potential house purchaser.

### Example 2

### Conducting a VR Real Estate Tour

Husband and wife live in Madison, Wis., and are both executives of an international oil company. The company is reassigning them to Abu Dhabi for two years in the United Arab Emirates. Husband and wife decide it is in their best interest to purchase property in Abu Dhabi, but that it is unreasonable for them to fly there before the move to look for property. The couple recruits the help of a real estate agent, who conducts VR tours of real estate. The couple selects multiple homes in Abu Dhabi that interest them. The real estate agent downloads and preloads the VR content for each house onto a pair of HMDs for the couple to use. The couple, along with the real estate agent, is able to synchronize the view sphere of the HMDs, such that the viewport is the same across all three devices. Each of the three users is capable of interacting and taking control of the VR tour by selecting vantage points and transitioning between hotspots in the tour. The real estate agent point in specific regions in the VR tour to focus the couple's attention on certain aspects of the homes. Similarly, the husband and wife point to specific VR objects in the VR tour and ask questions about the specific objects to the agent. This allows for a multi-user, remote, synchronized house buying experience engaged through streaming with low latency.

### Example 3

### Attending an Awards Show from Home

The venue for a popular annual awards show held in Los Angeles, Calif., for the best movies each year is uploaded onto the CMS and made into a VR tour. While the show is only for the crème de la crème of actors and actresses, there is growing public demand for an experience in participating in this awards show. The awards show organizers assign vantage points from the seats of specific actors and actresses, allowing for the audience to experience and participate in the awards show as part of a VR tour as though they were the stars.

### Example 4

### Conducting a Presentation Through a VR Classroom

A college natural sciences professor is interested in providing her students with a more in-depth view of prehistoric earth. She creates VR scenes from sets of computer renderings containing average wildlife and vegetation from that era to conduct a VR tour. She utilizes a HMD and videoconferences the VR tour to her students, who follow the VR tour presentation as the tour is projected onto a large video screen in the classroom. In the VR tour, the professor is able to point to specific VR objects, in this case a specific plant or animal, to quiz students on those objects. By interacting with and selecting a specific object, she is able to display attributes and statistics on the object.

### Example 5

### Low Risk Military Training Simulation

The military is looking for low-cost alternative training solutions for its soldiers to obtain practical knowledge. The military creates VR tours of popular military operation locations in desert and jungle terrains. These terrains were curated from actual mission footage as recorded by previous operators who conducted those missions. By rendering those environments, the military's VR tours are actual real-life situations in which trainees have access to explore. Using the VR tours, squads of trainees are evaluated in their decision-making abilities, including squad movement and interaction with specific VR objects, and compared against the actual operators. In addition, these VR tour “missions” are modified and paired to other tactile VR devices, allowing the military to conduct training through the equivalent of a VR video game.

### Example 6

### Advertising in a VR Showroom

A car dealership creates a VR tour of its warehouse to allow for customers to view a wider range of items that may not fit in a particular showroom. Users tour through the warehouse, circling around cars and interacting with specific VR objects associated with specific car models. In some VR tour spaces, a greyed out outline of a car exists where a normal car should be. The outline draws the attention of the user, and after the user stares at the outline for 5 seconds or glances at the outline on 5 separate occasions, a specific car or a specific car advertisement plays in that location. These interactions are as determined in the VR tour settings by the dealership, and the interactions are tracked through the eye tracking software of the VR platform.

### Example 7

### Data Analytics Through VR Interaction

A car manufacturer is interested in determining what features of a specific car model draws the most attention from a consumer, and what area of a car a consumer finds dull and boring. The manufacturer creates a VR tour containing the specific car model for analysis, setting multiple vantage points for consumers to see different views and features of the car. With the eye tracking software, the dealership gathers important consumer interaction data with the car, for example time spent viewing a specific feature and the number of times the feature was viewed. From this data, a heat map of the viewport is generated, allowing the manufacturer to see which regions of the car garnered the most attention by a consumer or a set of consumers. Alternatively, the manufacturer outsources gathering this data from car dealership, such as the one provided in Example 6.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising: a digital processing device comprising: at least one processor, an operating system configured to perform executable instructions, a memory, and a computer program including instructions executable by the digital processing device to create a virtual reality (VR) tour builder and editor application comprising:
a) a software module presenting an interface allowing a user to upload a 2D floorplan and VR content items;
b) a software module presenting an interface allowing the user to select one or more vantage points on the 2D floorplan, each vantage point having coordinates, and associate one or more VR content items with each vantage point;
c) a software module generating a VR tour based on the 2D floorplan, the vantage point coordinates, and the associated VR content, wherein the generation comprises automatically creating hotspots based on: i) relative position of vantage points in relation to the floorplan, ii) common features in two or more VR content items, or both i) and ii), wherein each hotspot comprises a point of transition between vantage points; and
d) a software module presenting an interface allowing the user to place VR objects in the VR tour.

2. The system of claim 1, wherein the application further comprises a software module automatically recognizing VR content.

3. The system of claim 1, wherein the VR content comprises one or more 3D models, one or more 360 photographs, one or more 360 videos, one or more 360 (binaural) audio files, or a combination thereof.

4. The system of claim 1, wherein the application further comprises a software module allowing the user to preview the tour in VR and in non-VR formats.

5. The system of claim 1, wherein the application further comprises a software module allowing the user to curate generated VR tours.

6. The system of claim 1, wherein the application further comprises a software module compressing the generated VR tour by: removing left eye and right eye VR texture similarities, removing non-equi-rectangular pixels, modifying the level of detail based on distance to a vantage point, applying gradient compression based on likelihood that an area will be viewed, removing data based on likelihood that content not in angle of view, or a combination thereof.

7. The system of claim 1, wherein the application further comprises a software module allowing the user to edit hotspots, wherein the editing comprises moving, ordering, adding, and removing hotspots.

8. The system of claim 1, wherein the software module allowing the user to place VR objects allows the user to configure properties of the placed VR objects and configure actions triggered by user interactions with the placed VR objects.

9. The system of claim 1, wherein the software module presenting an interface allowing the user to place VR objects in the VR tour allows placement of: one or more standard photographs, one or more standard videos, one or more standard sound files, text, one or more 3D models, one or more 360 photographs, one or more 360 videos, one or more 360 (binaural) audio files, or a combination thereof, as a VR object in the VR tour.

10. The system of claim 1, wherein the generated VR tour is optimized for delivery on a head mounted display (HMD).

11. The system of claim 1, wherein the VR tour and the VR content are for real estate sales and marketing, advertising, entertainment, education, healthcare, or a combination thereof.

12. The system of claim 1, wherein the application is implemented as software-as-a-service (SaaS), as a mobile application, or as a desktop or laptop application.

13. A computer-implemented system comprising: a digital processing device comprising: at least one processor, an operating system configured to perform executable instructions, a memory, and a computer program including instructions executable by the digital processing device to create a multi-modal virtual reality (VR) tour application comprising:
a) a software module pre-loading the same VR tour onto: i) an external device for use by an administrative user and ii) a head mounted display (HMD)-enabled device for use by an end user;
b) a software module generating a low latency multiviewer mode for viewing the VR tour, wherein the HMD view of the VR tour is displayed on the external device by transmitting positional information describing the position of the HMD in three-dimensional space and tour state information to the external device and updating external device display based on the positional information; and
c) a software module generating a low latency remote control mode for viewing the VR tour, wherein the external device view of the VR tour is displayed on the HMD by transmitting positional information describing the position of the external device in three-dimensional space and tour state information to the HMD and updating the HMD based on the positional information.

14. The system of claim 13, wherein, in the low latency multiviewer mode, only the positional information and tour state information is transmitted, without transmitting VR tour content.

15. The system of claim 13, wherein, in the low latency multiviewer mode, the positional information describes the position of the HMD in x-, y-, and z-axes.

16. The system of claim 13, wherein, in the low latency remote control mode, only the positional information and tour state information is transmitted, without transmitting VR tour content.

17. The system of claim 13, wherein, in the low latency remote control mode, the positional information describes the position of the external device in x-, y-, and z-axes.

18. The system of claim 13, wherein the same VR tour is pre-loaded onto a plurality of head mounted display (HMD)-enabled devices for use by a plurality of simultaneously connected end users and wherein, in the low latency remote control mode, the plurality of HMDs are updated based on the positional information describing the position of the external device.

19. The system of claim 18, wherein the plurality of head mounted display (HMD)-enabled devices comprises 2, 3, 4, 5, 10, 20, 30, or more simultaneously connected end user devices.

20. The system of claim 13, wherein the application further comprises a software module allowing the administrative user to place virtual markers in the VR tour, which are transmitted to the HMD and displayed on the HMD.

21. The system of claim 13, wherein the application further comprises a software module allowing synchronous voice communication between the administrative user and the end user.

22. The system of claim 13, wherein the application further comprises a software module allowing capture of still photographs based on the VR tour and the positional information.

23. The system of claim 13, wherein the application further comprises a software module tracking, in the low latency multiviewer mode, end user behavior information.

24. The system of claim 23, wherein the end user behavior information comprises navigation within the VR tour, interaction with a VR object within the VR tour, prolonged view focus on a particular portion of the VR tour or a particular VR object, repeated view focus on a particular portion of the VR tour or a particular VR object, or a combination thereof.

25. A computer-implemented system comprising: a digital processing device comprising: at least one processor, an operating system configured to perform executable instructions, a memory, and a computer program including instructions executable by the digital processing device to create a virtual reality (VR) tour analytics application comprising:
a. a software module determining a head mounted display (HMD) of an end user used to view the VR tour and determining a viewport for the HMD;
b. a software module tracking and storing timestamped tour state data during a VR tour, the tour state data comprising user vantage point;
c. a software module tracking and storing timestamped user view data during a VR tour, the user view data comprising HMD viewing angles;
d. a software module applying weighting to the user view data based on distance to the center of the viewport of the HMD; and
e. a software module tracking and storing timestamped user interaction data during a VR tour, the user interaction data comprising a VR object and a type of interaction.

26. The system of claim 25, wherein the application further comprises a software module determining changes to the tour state and the user view based on the timestamped tour state data and the timestamped user view data respectively.

27. The system of claim 25, wherein the application further comprises a software module cumulating the user view data over a time interval to create a heat map of user view focus, which is displayed as an overlay on the content of the VR tour.

28. The system of claim 25, wherein the application further comprises a software module correlating the user view data with VR objects in the VR tour.

29. The system of claim 25, wherein the application further comprises a software module activating user focus-based interactions when a length of focus exceeds a pre-determined threshold or a focus repeats a number of times in excess of a pre-determined threshold.
